(19) United States
(12) Patent Application Publication
(10) Pub. No.: US 2026/0227736 A1
(43) Pub. Date: Aug. 6, 2026

(54) MEDIUM PROCESSING APPARATUS AND IMAGE FORMING SYSTEM

(71) Applicants: Kazuhiro KAWAKAMI, Kanagawa (JP); Kei SASAKI, Kanagawa (JP); Kazuki SETO, Kanagawa (JP); Sachika TAMAKI, Kanagawa (JP); Shohei SAITO, Kanagawa (JP); Kohta ABE, Kanagawa (JP); Takashi YAMAMOTO, Kanagawa (JP); Keisuke SUGIYAMA, Kanagawa (JP)

(72) Inventors: Kazuhiro KAWAKAMI, Kanagawa (JP); Kei SASAKI, Kanagawa (JP); Kazuki SETO, Kanagawa (JP); Sachika TAMAKI, Kanagawa (JP); Shohei SAITO, Kanagawa (JP); Kohta ABE, Kanagawa (JP); Takashi YAMAMOTO, Kanagawa (JP); Keisuke SUGIYAMA, Kanagawa (JP)

(73) Assignee: Ricoh Company, Ltd., Ohta-ku,Tokyo (JP)

(21) Appl. No.: 19/159,153

(22) PCT Filed: Mar. 21, 2024
(86) PCT No.: PCT/IB2024/052700

§ 371 Date: Aug. 22, 2025

(30) Foreign Application Priority Data
Mar. 22, 2023 (JP) 2023-046080
Feb. 13, 2024 (JP) 2024-019709

(51) Int. Cl. G03G 15/00; B31F 5/02; B42C 9/00

(52) U.S. Cl. CPC G03G 15/6544; B31F 5/02; B42C 9/0006; G03G 2215/00848

(57) ABSTRACT

A medium processing apparatus includes a liquid applier to apply liquid to a part of at least one medium, a post-processing device to perform processing on a bundle of media including the at least one medium to which the liquid is applied by the liquid applier, a first liquid storage to store the liquid to be applied by the liquid applier, a second liquid storage to store the liquid to be supplied to the first liquid storage, a liquid supplier to perform a liquid supply operation to supply the liquid from the second liquid storage to the first liquid storage, a control pattern holder to hold a liquid supply control pattern including a combination of different types of liquid supply operations, and a controller to control execution of the liquid supply operation based on the liquid supply control pattern and an operation status of the post-processing device.

### TECHNICAL FIELD

Embodiments of the present disclosure relate to a medium processing apparatus and an image forming system incorporating the medium processing apparatus.

### BACKGROUND ART

Various types of medium processing apparatuses are known that bind a sheet bundle of stacked sheet media. Such medium processing apparatuses employ binding processes including, for example, a “stapling process” for penetrating needle-shaped members (binding members) through a sheet bundle to bind the sheet bundle and a “crimp binding process” for applying pressure to and deform a part of a sheet bundle to bind the sheet bundle.

A technique is disclosed in which a liquid application crimping device that applies liquid to sheets as sheet-shaped media when performing crimp-binding includes a liquid reservoir for applying liquid, and a liquid supply pump for supplying liquid to the liquid reservoir (e.g., see Patent Literature (PTL) 1).

### CITATION LIST

### Patent Literature

[PTL 1]
Japanese Unexamined Patent Application Publication No. 2018-199245

### SUMMARY OF INVENTION

### Technical Problem

PTL 1 discloses a configuration including a liquid reservoir (liquid storage unit) for applying liquid to perform crimp-binding on a medium on which liquid has been applied, but does not disclose a control method for controlling the operation of supplying liquid to the liquid storage unit. In other words, in the hydraulic crimping mechanism to which the conventional technology disclosed in PTL 1 is applied, the liquid supply control for controlling an operation of supplying liquid to the liquid storage unit according to the state of the liquid storage unit cannot be performed. It is difficult to achieve a liquid supply operation that matches the needs of the user, which causes a decrease in convenience for the user.

An object of the present disclosure is to provide a medium processing apparatus that can achieve a liquid supply operation that matches the needs of the user and enhance the convenience for the user.

### Solution to Problem

In order to solve the problem described above, according to an aspect of the present disclosure, a medium processing apparatus includes a liquid applier, a post-processing device, a first liquid storage, a second liquid storage, a liquid supplier, a control pattern holder, and a controller. The liquid applier applies liquid to a part of at least one medium. The post-processing device performs processing on a bundle of media including the at least one medium to which the liquid is applied by the liquid applier. The first liquid storage stores the liquid to be applied by the liquid applier. The second liquid storage stores the liquid to be supplied to the first liquid storage. The liquid supplier performs a liquid supply operation to supply the liquid from the second liquid storage to the first liquid storage. The control pattern holder holds a liquid supply control pattern including a combination of different types of liquid supply operations. The controller controls execution of the liquid supply operation based on the liquid supply control pattern and an operation status of the post-processing device.

### Advantageous Effects of Invention

According to one aspect of the present disclosure, a liquid supply operation that matches the needs of the user can be achieved, and thus the convenience for the user can be enhanced.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating an overall configuration of an image forming system according to an embodiment of the present disclosure.

FIG. 2 is a diagram illustrating an internal configuration of a post-processing apparatus according to a first embodiment of the present disclosure.

FIG. 3 is a schematic view of an upstream side of an edge binder of the post-processing apparatus of FIG. 2 in a conveyance direction.

FIG. 4 is a schematic view of a liquid applier of the edge binder of FIG. 3 in a main scanning direction.

FIGS. 5A and 5B are schematic diagrams illustrating a configuration of a crimper of the edge binder of FIG. 3.

FIG. 6 is a schematic view of a staple binder, viewed from an upstream side in a conveyance direction.

FIG. 7 is a schematic view of an upstream side of a staple binder as a modification of the staple binder of FIG. 6 in the conveyance direction.

FIG. 8 is a block diagram illustrating a hardware configuration of the post-processing apparatus of FIG. 2 to control the post-processing apparatus.

FIG. 9 is a flowchart of a binding process performed by the edge binder.

FIGS. 10A, 10B, and 10C are diagrams illustrating positions of a liquid applier and a crimper during the binding process of FIG. 9 by the edge binder.

FIGS. 11A and 11B are diagrams each illustrating a location and configuration of a second liquid storage tank in the post-processing apparatus.

FIG. 12 is a diagram illustrating a configuration of attachment and detachment of the second liquid storage tank in the post-processing apparatus.

FIG. 13 is a flowchart of a liquid supply determination process according to the first embodiment.

FIG. 14 is a diagram illustrating a liquid supply/discharge mode according to the first embodiment.

FIGS. 15A, 15B, 15C, and 15D are diagrams illustrating replenishment of liquid to a first liquid storage tank according to the first embodiment.

FIG. 16 is a flowchart of a liquid supply determination process according to the first embodiment.

FIGS. 17A and 17B are diagrams illustrating replenishment of liquid to a first liquid storage tank according to the first embodiment.

FIG. 18 is a flowchart of a liquid supply determination process according to the first embodiment.

FIG. 19 is a flowchart of a liquid supply determination process according to the first embodiment.

FIGS. 20A and 20B are diagrams illustrating an outline of a liquid ejection operation which is one of liquid supply-and-ejection modes.

FIG. 21 is a flowchart of a liquid supply determination process according to the first embodiment.

FIG. 22 is a diagram illustrating an example of a selection input screen for a liquid supply/discharge mode according to the first embodiment.

FIG. 23 is a diagram illustrating an example of a setting screen for a liquid supply control pattern according to the first embodiment.

FIG. 24 is a flowchart of a liquid supply control pattern setting process according to the first embodiment.

FIGS. 25A and 25B are diagrams illustrating an outline of a liquid supply control pattern according to the first embodiment.

FIG. 26 is a flowchart of a liquid supply control pattern setting process according to the first embodiment.

FIG. 27 is a flowchart of the liquid supply control pattern setting process according to the first embodiment.

FIG. 28 is a flowchart of the liquid supply control pattern setting process according to the first embodiment.

FIG. 29 is a flowchart of the liquid supply control pattern setting process according to the first embodiment.

FIG. 30 is a flowchart of the liquid supply control pattern setting process according to the first embodiment.

FIG. 31 is a flowchart of the liquid supply control pattern setting process according to the first embodiment.

FIG. 32 is a flowchart of the liquid supply control pattern setting process according to the first embodiment.

FIG. 33 is a flowchart of the liquid supply control pattern setting process according to the first embodiment.

FIG. 34 is a schematic view of an edge binder according to another embodiment.

FIG. 35 is a schematic view of a configuration of a liquid applier pivot assembly.

FIG. 36 is a schematic view of a configuration of the liquid applier pivot assembly of FIG. 35.

FIGS. 37A and 37B are schematic views of a configuration of a posture changing member.

FIGS. 38A, 38B, 38C, 38D, 38E, and 38F are diagrams illustrating a series of operations of a posture changing lever by the posture changing member of FIGS. 37A and 37B.

FIGS. 39A, 39B, 39C, 39D, 39E, 39F, 39G, and 39H are diagrams illustrating an operation procedure for changing the crimper and the liquid applier to an “inclined binding posture” and an “inclined application posture” respectively.

FIGS. 40A, 40B, 40C, and 40D are diagrams illustrating an operation procedure for changing the crimper and the liquid applier to a “parallel binding posture” and a “parallel application posture” respectively.

FIGS. 41A, 41B, 41C, 41D, and 41E are diagrams illustrating an operation of parallel binding by the crimper and the liquid applier.

FIG. 42 is a diagram illustrating the internal configuration of a post-processing apparatus according to a second embodiment.

FIGS. 43A, 43B, and 43C are schematic views of an internal tray of the post-processing apparatus according to the second embodiment, viewed from a thickness direction of a sheet.

FIG. 44 is a schematic view of a crimper of the post-processing apparatus according to the second embodiment, viewed from an upstream side in a conveyance direction.

FIGS. 45A and 45B are schematic views of a liquid applier of the post-processing apparatus according to the second embodiment, viewed from the thickness direction of the sheet;

FIGS. 46A, 46B, and 46C are cross-sectional views of the liquid applier taken along a line XXV-XXV of FIG. 45A;

FIGS. 47A, 47B, and 47C are cross-sectional views of the liquid application unit taken along a line XXVI-XXVI of FIG. 45A.

FIG. 48 is a block diagram illustrating the hardware configuration of controlling the operation of the post-processing apparatus according to the second embodiment.

FIG. 49 is a flowchart of post-processing performed by the post-processing apparatus according to the second embodiment.

FIG. 50 is a diagram illustrating an overall configuration of an image forming system according to a modification of the embodiment illustrated in FIG. 1.

FIGS. 51A and 51B are schematic views of a post-processing apparatus including controllers according to a first modification of the embodiment illustrated in FIG. 1.

FIGS. 52A and 52B are schematic views of a post-processing apparatus including controllers according to a second modification of the embodiment illustrated in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise.

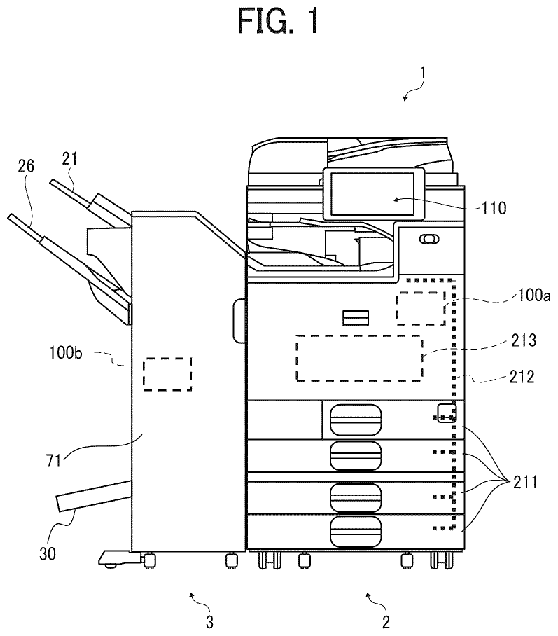

A description is given below of an image forming system 1 according to an embodiment of the present disclosure, with reference to the drawings. FIG. 1 is a schematic view of an overall configuration of the image forming system 1. The image forming system 1 has, for example, an image forming function of forming an image on a sheet P as an example of a sheet-shaped medium and a post-processing function of performing post-processing on the sheet P on which the image has been formed. As illustrated in FIG. 1, the image forming system 1 includes an image forming apparatus 2 having the image forming function and a post-processing apparatus 3 serving as a medium processing apparatus having the post-processing function according to an embodiment of the present disclosure. In the image forming system 1, the image forming apparatus 2 and the post-processing apparatus 3 operate in conjunction with each other.

In the present embodiment, the sheet-shaped medium or sheet-shaped medium to be processed in the image forming system 1 is described on the assumption that the medium is a sheet of “paper”. However, the object to be processed according to the present embodiment is not limited to a sheet of paper. For example, any type of medium may be used as long as an image can be formed on the medium according to an image forming process. Examples of the medium include a medium that can be an object of a folding process or a binding process, and the material and specification of the medium are not limited to any particular material and specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image forming device 213 may be an inkjet system that forms an image using an inkjet system or an electrophotographic system that forms an image with toner. The image forming apparatus 2 also includes a controller 100a that controls various operations of the conveyor 212 and the image forming device 213. Since the image forming apparatus 2 has a typical configuration, a detailed description of the configuration and functions of the image forming apparatus 2 are omitted.

Sheets of paper are widely known as an example of sheet-shaped media. In the following description, a sheet-shaped medium as a medium to be processed is referred to as a “sheet P.” Further, in the following description, a bundle of sheets of paper as a plurality of media is an example of a “sheet bundle Pb.”

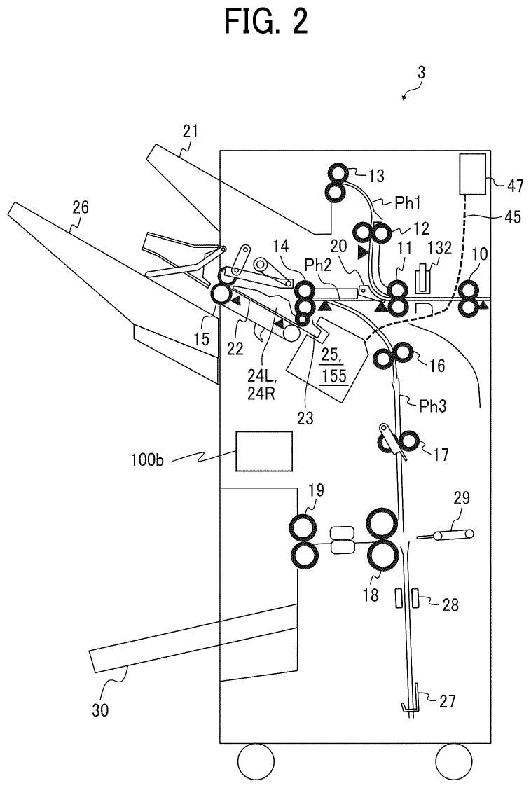

A description is given below of the post-processing apparatus 3 according to a first embodiment of the present disclosure. FIG. 2 is a diagram illustrating an internal configuration of the post-processing apparatus 3 according to the first embodiment of the present disclosure. The post-processing apparatus 3 has a function that performs post-processing on the sheet P on which an image has been formed by the image forming apparatus 2. An example of the post-processing according to the present embodiment is a binding process as a “crimp binding process” that binds, without staples, a plurality of sheets P on each of which an image is formed as a bundle of sheets, which may be referred to as a sheet bundle. Another example of the post-processing according to the present embodiment is a binding process as a “stapling process” that binds, with staples, a plurality of the sheets P on each of which an image is formed as a bundle of sheets P (i.e., sheet bundle). In the following description, the bundle of sheets may be referred to as a “sheet bundle Pb” as a bundle of media.

In the present embodiment, a description is given of liquid application in a crimp binding process. However, liquid application performed in a stapling process is similar to the liquid application in the crimp binding process. In the following description, the term “binding process” indicates both the “crimp binding process” and the “stapling process”, and is not limited to a binding method (whether a binding needle is used or a pressing and deforming process is performed).

More specifically, the “crimp binding process” according to the present embodiment is a process called “crimp binding” to apply pressure to the binding position corresponding to a part of the sheet bundle Pb to deform (pressure-deform) the binding position and bind the sheet bundle Pb. The binding that can be executed by the post-processing apparatus 3 includes edge binding and saddle binding. The edge binding is a process to bind an end (including an edge) of the sheet bundle Pb. The saddle binding is a process to bind the center of the sheet bundle Pb.

The post-processing apparatus 3 includes conveyance roller pairs 10 to 19 (an example of conveyors), a switching member 20, and a controller 100b (an example of a control device). The controller 100b controls the operations of, for example, the conveyance roller pairs 10 to 19 (an example of conveyors), and the switching member 20. Details of the controller 100b will be described below. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on the sheet P conveyed by the conveyance roller pairs 10 and 11.

The first conveyance passage Ph1 is a passage extending to an ejection tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to an ejection tray 26 via an internal tray 22. The third conveyance passage Ph3 is a passage branching from the first conveyance passage Ph1 between the conveyance roller pairs 11 and 14 in the conveyance direction and extending to an ejection tray 30.

The switching member 20 serving as a switcher is disposed at a branching position of the first conveyance passage Ph1 and the second conveyance passage Ph2. The switching member 20 can be switched between a first position and a second position. The switching member 20 in the first position guides the sheet P to be ejected to the ejection tray 21 through the first conveyance passage Ph1. The switching member 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the multiple sensors is indicated by a black triangle in FIG. 2.

The post-processing apparatus 3 further includes the ejection tray 21. The sheet P that is output through the first conveyance passage Ph1 is placed on the ejection tray 21. Among the sheets P supplied from the image forming apparatus 2, a sheet P not subjected to the binding process is ejected to the ejection tray 21.

The post-processing apparatus 3 further includes the internal tray 22 serving as a placement tray, an end fence 23, side fences 24L and 24R, an edge binder 25, a staple binder 155, and an ejection tray 26. The internal tray 22, the end fence 23, the side fences 24L and 24R, the edge binder 25, and the staple binder 155 perform the edge binding on the sheet bundle Pb of a plurality of sheets P conveyed through the second conveyance passage Ph2. Among the sheets P supplied from the image forming apparatus 2, the sheet bundle Pb subjected to the edge binding is ejected to the ejection tray 26.

Examples of the “edge binding process” include, but not limited to, “parallel binding process,” “oblique binding process,” and “vertical binding process.” The “parallel binding process” is a process of binding the sheet bundle Pb along one side of the sheet bundle Pb parallel to the main scanning direction. The “oblique binding process” is a process of binding a corner of the sheet bundle Pb. The “vertical binding process” is a process of binding the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction.” In other words, the “conveyance direction” herein corresponds to a direction in which the sheet P that has been output from the image forming apparatus 2 is moved toward the ejection tray 26 by, for example, the conveyance roller pair 10, is changed to move toward the end fence 23 by the conveyance roller pair 15 in a direction different from the above-described direction. The direction that is orthogonal to both the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22 serving as a placement tray. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the end fence 23 and the side fences 24L and 24R. The conveyance roller pair 15 ejects the sheet bundle Pb subjected to the edge binding to the ejection tray 26.

The post-processing apparatus 3 further includes an end fence 27, a saddle binder 28, a sheet folding blade 29, and the ejection tray 30. The end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the ejection tray 30.

The end fence 27 aligns the positions of the sheets P that are sequentially conveyed through the third conveyance passage Ph3, in a conveyance direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 eject the sheet bundle Pb subjected to the saddle binding to the ejection tray 30.

In addition, the post-processing apparatus 3 includes a liquid application member 501 (a part of the liquid applier), a liquid supply member 50 (a part of the liquid applier), and a first liquid storage tank 44 (a first liquid storage) in the edge binder 25. The first liquid storage tank 44 and the liquid supply member 50 are omitted in FIG. 2. The post-processing apparatus 3 further includes the liquid supply passage 45 as a part of a liquid supplier, a liquid supply pump 46 as a part of the liquid supplier, a second liquid storage tank 47 as a part of a second liquid storage, and a second liquid storage tank fixer 61 as a part of the second liquid storage, to replenish the first liquid storage tank 44 with liquid. The liquid that is stored in the second liquid storage tank 47 is supplied to the first liquid storage tank 44 via the second liquid storage tank fixer 61, the liquid supply pump 46, and the liquid supply passage 45.

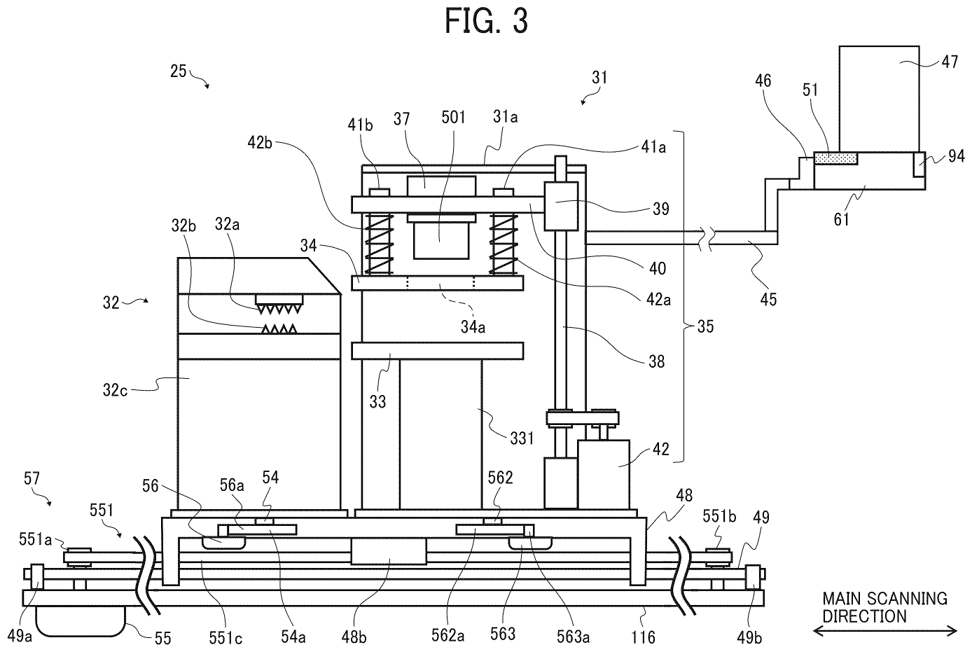

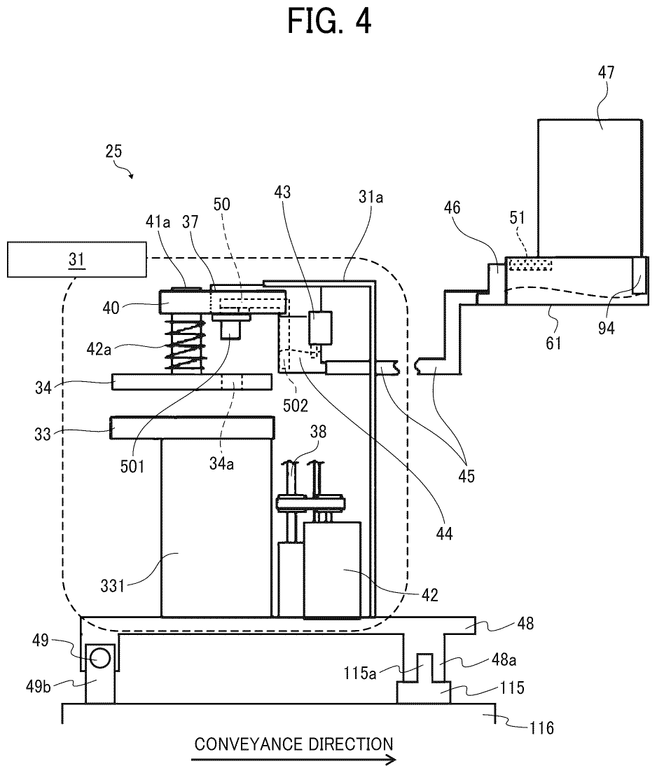

A description is given of the edge binder 25. FIG. 3 is a schematic diagram illustrating an upstream side of the edge binder 25 in the conveyance direction. The edge binder 25 performs liquid application and crimp binding illustrated in FIG. 2. FIG. 4 is a schematic view of a liquid applier 31 of the edge binder 25 when viewed from the main scanning direction. As illustrated in FIG. 3, the edge binder 25 includes the liquid applier 31 that applies liquid to the sheets P, and a crimper 32 that is an example of a post-processing device and serves as a crimp binder. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process”.

More specifically, the liquid that is stored in the first liquid storage tank 44 for the liquid application includes, as a main component, the liquid state of a compound of hydrogen and oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 44 may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

As illustrated in FIGS. 3 and 4, the liquid applier 31 is movable in the main scanning direction together with the crimper 32 by a driving force transmitted from an edge binder movement motor 55. The liquid applier 31 includes a lower pressure plate 33 serving as a receptacle for the sheet P or the sheet bundle Pb, an upper pressure plate 34, and a liquid applier movement assembly 35. The components of the liquid applier 31 such as the lower pressure plate 33, the upper pressure plate 34, and the liquid applier movement assembly 35 are held by the liquid application frame 31a and a base 48.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 is provided with a through hole 34a passing through the upper pressure plate 34 in the thickness direction at a position opposite to the liquid application member 501 held via the holder 37 attached to the base plate 40. The liquid application member 501 is one end portion of a liquid supply member 50 (liquid absorber) described below and corresponds to a tip portion of the liquid supply member 50.

The liquid applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid applier movement assembly 35 according to the present embodiment moves the upper pressure plate 34, the base plate 40, the holder 37, the liquid application member 501, the liquid supply member 50, and the first liquid storage tank 44 in conjunction with each other with a single liquid applier movement motor 42. The liquid applier movement assembly 35 includes, for example, a liquid applier movement motor 42, a trapezoidal screw 38, a nut 39, the base plate 40, columns 41 a and 41 b, and coil springs 42 a and 42 b.

The liquid applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 42 via, for example, a pulley and a belt. The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

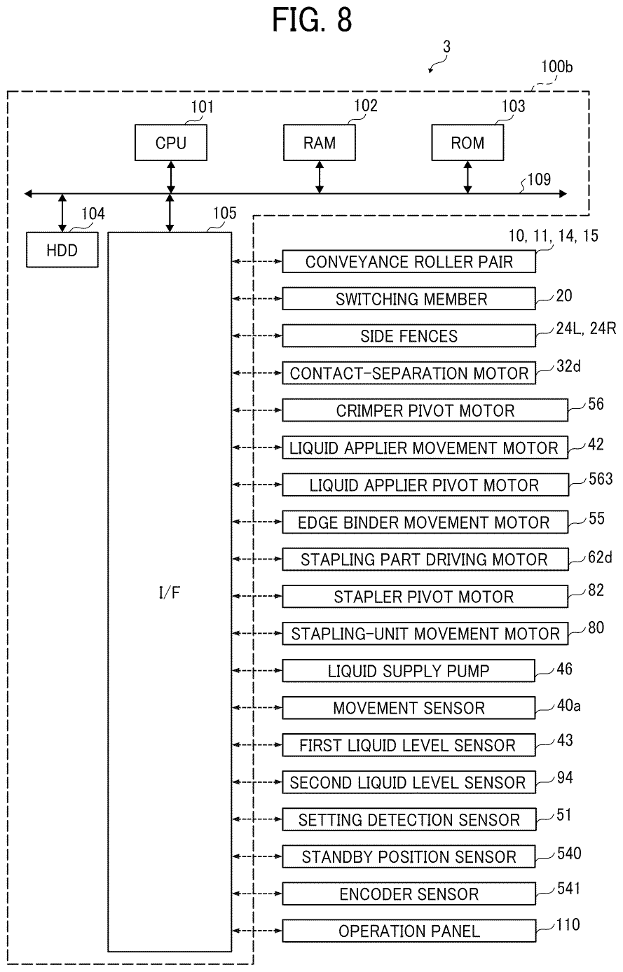

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the vertical direction is detected by a movement sensor 40a (see FIG. 8).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. Specifically, the liquid applier 31 brings the liquid application member 501 into contact with the sheet P or the sheet bundle Pb to apply the liquid to at least one sheet P of the sheet bundle Pb.

The liquid applier 31 includes the first liquid level sensor 43 (serving as a liquid detector), the first liquid storage tank 44, the liquid application member 501, the liquid supply member 50, and the holder 37. The first liquid storage tank 44 stores the liquid to be applied to the sheet P or the sheet bundle Pb. The amount of liquid that is stored in the first liquid storage tank 44 is detected by the first liquid level sensor 43. The first liquid storage tank 44 is coupled to the base plate 40 via the holder 37.

The liquid application member 501, the liquid supply member 50 (liquid absorber) disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion 502 that draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular kind as long as the at least one of the liquid application member 501 or the liquid supply member 50 is made of a material having a property of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the other end portion (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from a liquid immersion portion 502 of the liquid supply member 50, and the sucked liquid is supplied to the liquid application member 501 that is coupled to the tip portion via the liquid supply member 50. Then, the liquid stored in the first liquid storage tank 44 is drawn up to the liquid application member 501 in close contact with one end portion of the liquid supply member 50, and thus the liquid level (stored liquid amount) of the liquid stored in the first liquid storage tank 44 detected by the first liquid level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. By so doing, the amount of liquid (liquid level) in the first liquid storage tank 44 temporarily decreases to the level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is mainly performed at the time of activation of the post-processing apparatus 3 or at the time of start of execution of the binding process involving liquid application in the post-processing apparatus 3, and corresponds to the liquid supply operations for bringing the liquid application using the liquid application member 501 to be executable. In the following description, the liquid supply operation is referred to as a “filling supply operation.” Details of the filling supply operation will be described later.

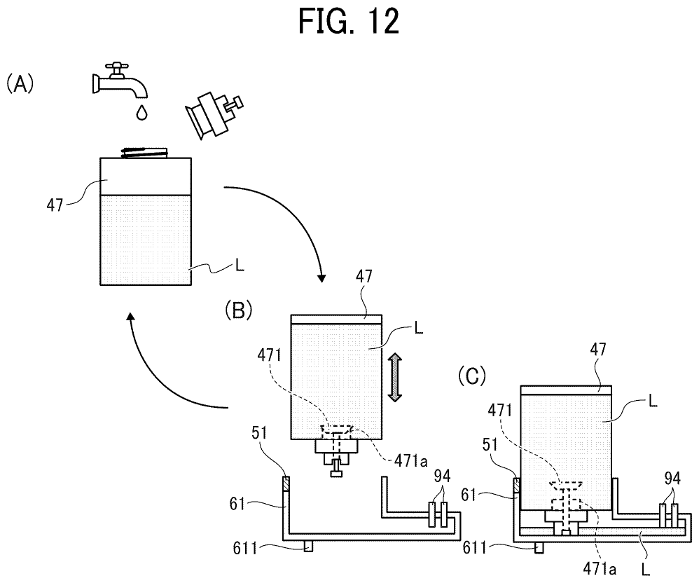

The edge binder 25 is coupled to the second liquid storage tank 47. The second liquid storage tank 47 is detachably attached to the edge binder 25 or the post-processing apparatus 3 (see FIG. 12). The second liquid storage tank 47 is fixed (set) to the second liquid storage tank fixer 61 (a part of the second liquid storage unit) at a given position. Thus, the liquid already stored in the second liquid storage tank 47 can be supplied to the first liquid storage tank 44.

The operation of supplying liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by liquid application by the liquid applier 31. In other words, the operation of supplying liquid from the second liquid storage tank 47 to the first liquid storage tank 44 corresponds to the liquid supply operation in accordance with the execution of the process including liquid application by the liquid applier 31.

This liquid supply operation corresponds to an operation of supplying liquid to the first liquid storage tank 44 so as to replenish liquid each time the stored liquid amount (liquid level) of the first liquid storage tank 44 falls below a reference liquid level, which is described below. In the following description, the liquid supplying operation is referred to as a “additional supply operation.” Details of the additional supply operation will be described later.

When the second liquid storage tank 47 is set in the second liquid storage tank fixer 61, the second liquid storage tank fixer 61 is filled with a certain amount of the liquid in the second liquid storage tank 47. The second liquid storage tank fixer 61 includes a setting detection sensor 51 (serving as a set detector) (see FIG. 12). When the setting detection sensor 51 detects the set state of the second liquid storage tank 47 to the second liquid storage tank fixer 61 (see part (C) of FIG. 12), a signal indicating the set state is transmitted to the controller 100b, which is described below. Thus, the controller 100b to be described below detects whether the second liquid storage tank 47 is mounted on the second liquid storage tank fixer 61. Details of the second liquid storage tank 47 will be described below.

The first liquid storage tank 44 and the second liquid storage tank 47 are coupled to each other by the liquid supply passage 45. The liquid supply pump 46 is disposed near the second liquid storage tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second liquid storage tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid applier movement assembly 35, liquid can be supplied from the second liquid storage tank 47 to the first liquid storage tank 44.

The supply of liquid from the second liquid storage tank 47 to the first liquid storage tank 44 can be controlled in accordance with the detection result of the first liquid level sensor 43. In other words, the controller 100b, which is described below, determines whether the stored liquid amount (liquid level) in the first liquid storage tank 44 based on the detection result of the first liquid level sensor 43. In accordance with the determined stored liquid amount (liquid level) of the first liquid storage tank 44, the controller 100b controls the operation speed and time of the liquid supply pump 46. By so doing, the controller 100b can adjust the amount of liquid to be replenished to the first liquid storage tank 44 to maintain the stored liquid amount (liquid level) in the first liquid storage tank 44 at a constant level of liquid.

A description is given below of the configuration of the crimper 32. The crimper 32 serving as a post-processing device presses and deforms a portion of the sheet bundle Pb by serrated upper crimping teeth 32a and lower crimping teeth 32b, and crimps the sheets P of the portion to bind the sheet bundle Pb. In other words, the crimper 32 can bind the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding.” In other words, the crimper 32 crimps and binds the sheet bundle Pb or performs the crimp binding on the sheet bundle Pb. The crimping and binding operation of the crimper 32 that involves control processing is referred to as “crimp binding process”.

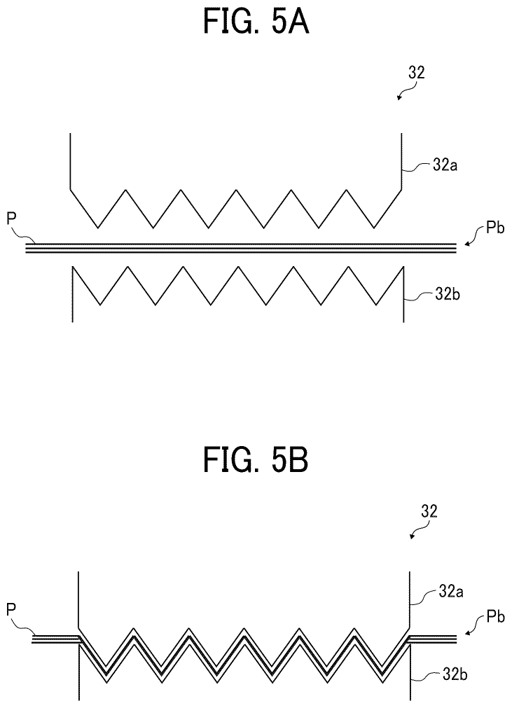

FIGS. 5A and 5B are schematic diagrams illustrating the configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 8.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb held in the internal tray 22 is crimped and bound. The sheet bundle Pb thus crimped and bound is ejected to the ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57. The edge binder movement assembly 57 moves the edge binder 25 (in other words, the liquid applier 31 and the crimper 32) in the main scanning direction along the downstream end of the sheet P, which is placed on the internal tray 22, in the conveyance direction. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 8).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a and 49b disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction of the sheet P. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge binder movement motor 55 according to the present embodiment is, for example, a servo motor that can stop the edge binder 25 at a target position (for example, the first binding position B1 and a second binding position B2 described below) without returning the edge binder 25 to an origin position (for example, a standby position HP described below) each time the edge binder 25 is moved.

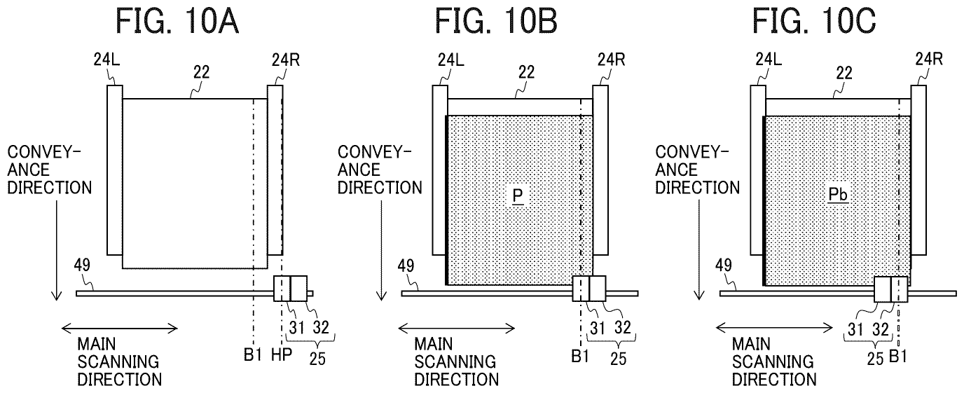

The post-processing apparatus 3 further includes a standby position sensor 540 and an encoder sensor 541. The standby position sensor 540 is, for example, a light-shielding optical sensor (see FIG. 8) to detect that the edge binder 25 has reached a standby position HP (see FIG. 10A). The encoder sensor 541 (see FIG. 8) is attached to an output shaft of the edge binder movement motor 55. The controller 100b, which will be described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

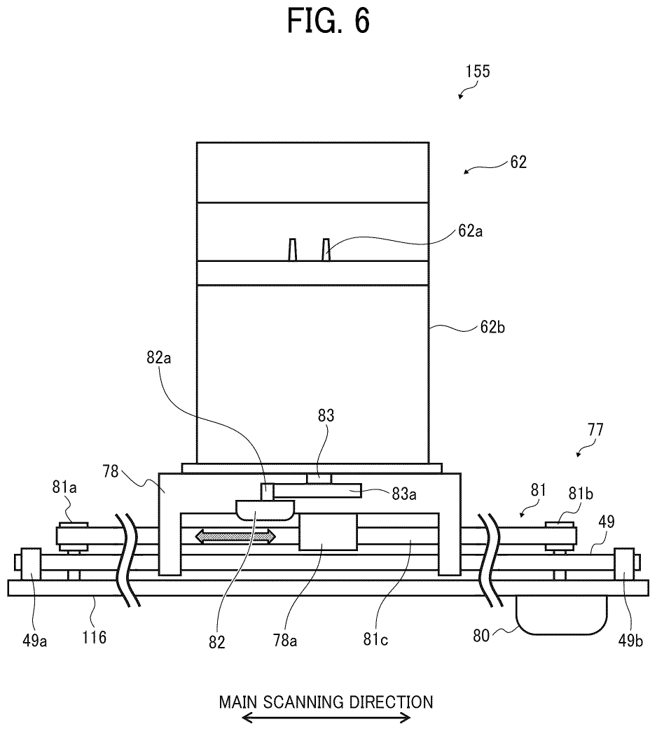

A description is given of a staple binder 155. Specifically, a detailed description is now given of the staple binder 155 having a function of executing a stapling process. FIG. 6 is a schematic diagram illustrating the staple binder 155, viewed from the upstream side of the staple binder 155 in the conveyance direction. The staple binder 155 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 serving as a post-processing device has a configuration of performing so-called “stapling” (i.e., stapling process) to bind a sheet bundle Pb with a staple or staples. More specifically, the stapler 62 includes a stapling-part drive motor 62d illustrated in FIG. 8. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description of the stapler 62 will be omitted unless otherwise required.

As illustrated in FIG. 6, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a is engaged with an output gear 82a of the stapler pivot motor 82. The stapler 62 can be rotated in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can independently move the edge binder 25 and the staple binder 155.

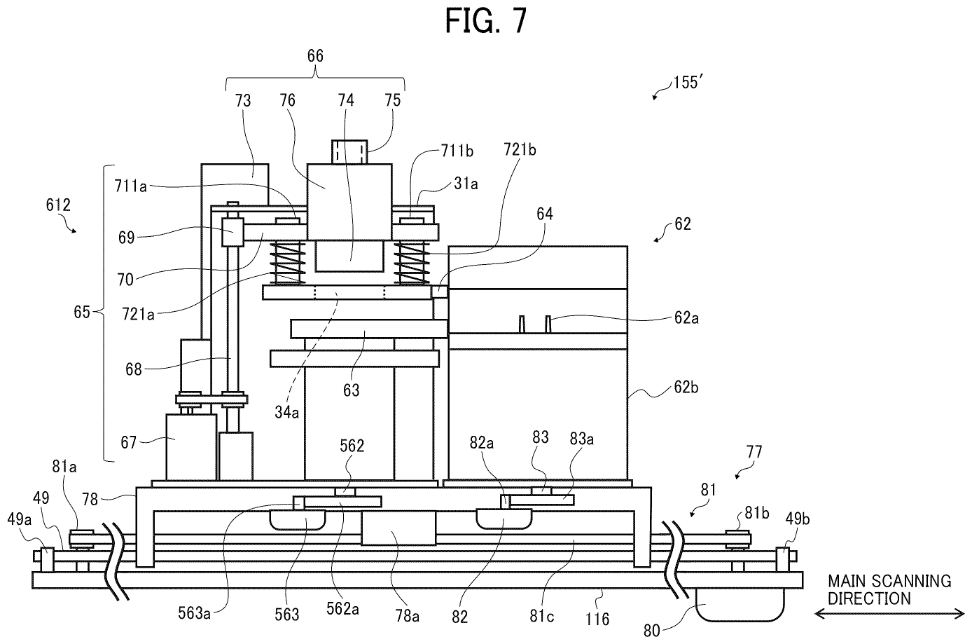

FIG. 7 illustrates a staple binder 155′ as a modification of the staple binder 155. More specifically, FIG. 7 is a schematic diagram illustrating of the staple binder 155′ as viewed from the upstream side in the conveyance direction. The staple binder 155′ is different from the staple binder 155 in that the staple binder 155′ includes a second liquid applier 612 in addition to the stapler 62. As illustrated in FIG. 7, the staple binder 155′ includes, for example, the second liquid applier 612 and the stapler 62. The second liquid applier 612 and the stapler 62 are disposed downstream from the internal tray 22 in the conveyance direction and adjacent to each other in the main scanning direction.

The second liquid applier 612 executes liquid application of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second columns 711 a and 711b, and second coil springs 721a and 721b.

The second liquid application assembly 66 includes the third liquid storage tank 73, a second liquid supply portion 75, a second liquid application member 74, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required. Since the configuration of the stapler 62 illustrated in FIG. 6 is like the configuration of the stapler 62 illustrated in FIG. 7, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes a liquid applier pivot motor 563, an output gear 563a, drive transmission gear 562a, and a liquid applier shaft 562.

In the binding process, the staple binder 155′ that is illustrated in FIG. 7 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without applying the liquid.

A description is given below of a control block of the post-processing apparatus 3. A description is given below of a control block of the post-processing apparatus 3, with reference to FIG. 8. FIG. 8 is a block diagram illustrating a hardware configuration for executing control processing in the post-processing apparatus 3. As illustrated in FIG. 8, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b serving as a control device that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid supply pump 46, the movement sensor 40a, the first liquid level sensor 43, the second liquid level sensor 94, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, and the liquid supply pump 46. The controller 100b acquires detection results from the movement sensor 40a, the first liquid level sensor 43, the second liquid level sensor 94, the setting detection sensor 51, the standby position sensor 540, and the encoder sensor 541. Although FIG. 8 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation device that receives instructions input by an operator and a display serving as a notifier that notifies the operator of information. The operation device includes, for example, physical input buttons and a touch screen overlaid on a display. The operation panel 110 acquires information from the user through the operation device and provides information to the user through the display. A specific example of the notification unit is not limited to the display and may be a light emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

In some embodiments, the liquid application performed by the post-processing apparatus 3 may be performed in a form in which the staple binder 155 is provided with only the stapler 62 and the liquid application is performed using the liquid applier 31 of the edge binder 25.

Conversely, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

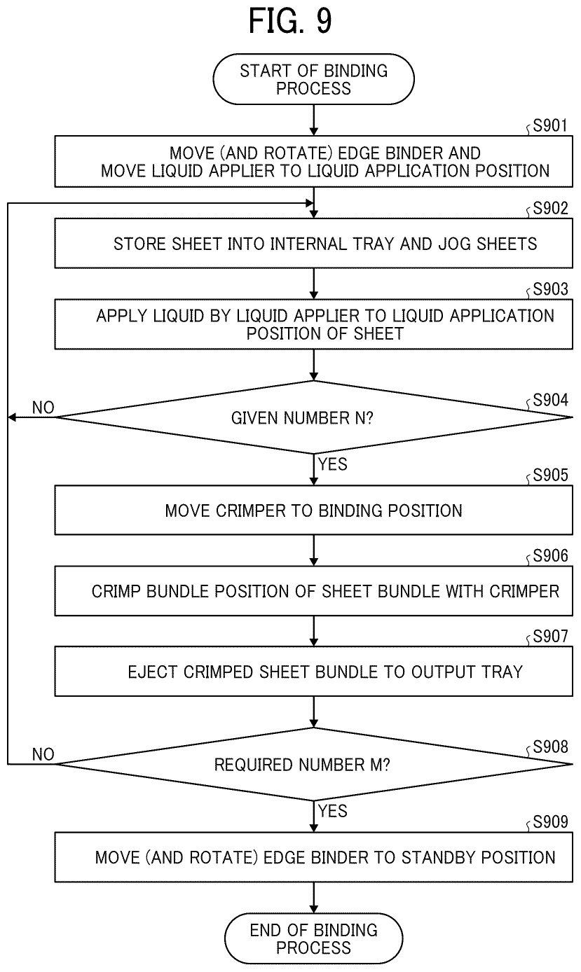

A description is given below of the binding process. Specifically, a description is given below of the binding process executed by the edge binder 25 included in the post-processing apparatus 3. FIG. 9 is a flowchart of a process of one-point binding performed by the edge binder 25. FIGS. 10A, 10B, and 10C are diagrams illustrating the positions of the edge binder 25 (the liquid applier 31 and the crimper 32) during the one-point binding. FIGS. 10A, 10B, and 10C do not illustrate changes in the postures of the liquid applier 31 and the crimper 32. The liquid application position to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding process illustrated in FIG. 9 when the controller 100b acquires an instruction to execute the binding process from the image forming apparatus 2. In the following description, the instruction to execute the binding process may be referred to as a “binding command.”

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.” The liquid applier 31 and the crimper 32 are assumed to be in a parallel binding posture and located at a standby position HP (FIG. 10A) that is a position shifted in the width direction from the sheets P placed on the internal tray 22 at the start of the binding process.

When the posture that is instructed by the binding command is the “inclined binding posture,” the controller 100b drives the liquid applier pivot motor 563 and the crimper pivot motor 56 to pivot the liquid applier 31 and the crimper 32 of the edge binder 25 into the inclined binding posture (step S901). Alternatively, when the posture that is instructed by the binding command is the “inclined binding posture,” the crimper 32 alone may be pivot to the inclined binding posture while the liquid applier 31 may not be pivoted. As a result, the driving assembly may be simplified as compared with a case where both the liquid applier 31 and the crimper 32 are pivoted in the forward and reverse directions, and thus effects of cost reduction, downsizing of the apparatus, and reduction of failure of the device are exhibited.

On the other hand, when the posture that is instructed by the binding command is the “parallel binding posture,” the controller 100b skips the aforementioned operation of pivoting the liquid applier 31 and the crimper 32 of the edge binder 25 to the inclined binding posture.

The controller 100b drives the edge binder movement motor 55 to move the edge binder 25 in the main scanning direction so that the liquid applier 31 faces the first liquid application position B1 instructed by the binding command (step S901). The controller 100b executes the operation of step S901 before a first sheet P is conveyed to the internal tray 22 by the conveyance roller pairs 10, 11, 14, and 15.

In step S902, the controller 100b rotates the conveyance roller pairs 10, 11, 14, and 15 to store the sheet P, on which the image has been formed by the image forming apparatus 2, onto the internal tray 22. The controller 100b moves the side fences 24L and 24R to align the position of the sheet P or the sheet bundle Pb placed on the internal tray 22 in the main scanning direction (step S902). In short, the controller 100b performs so-called jogging.

The controller 100b causes the liquid applier 31 facing the first liquid application position B1 to apply liquid to the first liquid application position B1 of the sheet P placed on the internal tray 22 in the immediately preceding step S902, based on the liquid application control data adjusted in advance (step S903). In other words, the controller 100b drives the liquid applier movement motor 42 to bring the liquid application member 501 into contact with the liquid application position B1 on the sheet P placed on the internal tray 22 (see FIG. 10B). In the liquid application process in step S903, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid applier movement motor 42 based on the adjusted control data, and adjusts the amount of movement of the liquid application member 501 with respect to the first liquid application position B1 of the sheet P placed on the internal tray 22 (see FIG. 10B).

The controller 100b determines whether the number of sheets P placed on the internal tray 22 has reached the given number of sheets N instructed by the binding command (step S904). When the controller 100b determines that the number of sheets P placed on the internal tray 22 has not reached the given number of sheets N (NO in step S904), the controller 100b executes the operations of steps S902 to S904 again until the number of sheets P placed on the internal tray 22 reaches the given number of sheets N (YES in step S904). In other words, the controller 100b executes the processing of steps S902 to S904 each time the sheet P is conveyed to the internal tray 22 by the conveyance roller pairs 10, 11, 14, and 15. The liquid application by the liquid applier 31 may be performed on each of the sheets P of the sheet bundle Pb.

When the controller 100b determines that the number of sheets P placed on the internal tray 22 has reached the given number of sheets N (YES in step S904), in step S905, the controller 100b drives the edge binder movement motor 55 to move the edge binder 25 in the main scanning direction such that the crimper 32 faces the first binding position B1 as illustrated in FIG. 10C.

In step S906, the controller 100b causes the crimper 32 to crimp the sheet bundle Pb placed on the internal tray 22. The controller 100b causes the conveyance roller pair 15 to eject the sheet bundle Pb thus crimped and bound by the crimper 32 to the ejection tray 26 (step S907). Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b. Thus, the crimper 32 crimps the sheet bundle Pb. Then, the controller 100b rotates the conveyance roller pair 15 to eject the sheet bundle Pb thus crimped and bound to the ejection tray 26.

The sheet bundle Pb that is placed on the internal tray 22 has a crimping area (corresponding to the binding position B1) sandwiched between the upper crimping teeth 32a and the lower crimping teeth 32b in step S906. The crimping area overlaps a liquid application area (corresponding to the liquid application position B1) contacted by the end of the liquid application member 501 in step S903. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlaps the liquid application area contacted by the distal end (tip portion) of the liquid application member 501, to obtain a sufficient binding strength.

The controller 100b determines whether the number of sheet bundles Pb thus ejected to the ejection tray 26 has reached the requested number of copies M indicated by the binding command (step S908). When the controller 100b determines that the number of sheet bundles Pb thus ejected has not reached the requested number of copies M (NO in step S908), the controller 100b executes the operations of step S902 and the following steps again. In other words, when the controller 100b determines that the number of sheet bundles Pb thus ejected has not reached the requested number of copies M (NO in step S908), the controller 100b repeats the operations of steps S902 to S908 until the number of sheet bundles Pb ejected to the ejection tray 26 reaches the requested number of copies M.

On the other hand, when the controller 100b determines that the number of sheet bundles Pb output to the ejection tray 26 has reached the requested number of copies M (YES in step S908), the controller 100b drives the edge binder movement motor 55 to move the edge binder 25 (the liquid applier 31 and the crimper 32) to the standby position HP as illustrated in FIG. 10A (step S909) When the posture that is instructed by the binding command is the “oblique binding posture,” the controller 100b drives the liquid applier pivot motor 563 and the crimper pivot motor 56 to rotate the liquid applier 31 and the crimper 32 into the parallel binding posture (step S909). On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 10A. In steps S901 and S909, the execution order of the movement in the main scanning direction and the rotation in the forward and reverse directions of the liquid applier 31 and the crimper 32 is not limited to the aforementioned order and may be reversed.

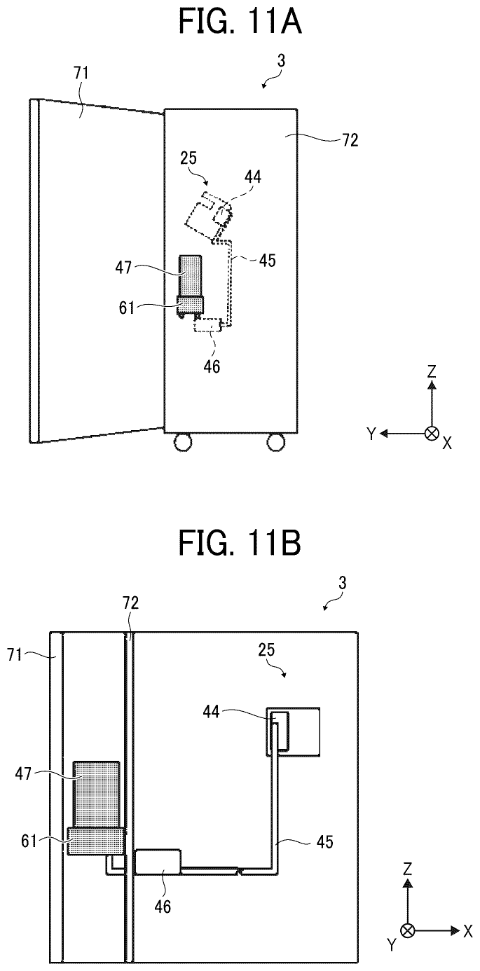

A detailed description is given below of a second liquid storage tank 47 according to an embodiment of the present disclosure. Referring now to FIGS. 11A, 11B, and 12, a description is given of the arrangement and configuration of the second liquid storage tank 47 in the post-processing apparatus 3. FIGS. 11A and 11B illustrate example location and configuration of the second liquid storage tank 47 as the main tank. FIG. 11A illustrates the post-processing apparatus 3 with a cover 71 opened. FIG. 11B is a cross-sectional side view of the post-processing apparatus 3, illustrating the post-processing apparatus 3 with the cover 71 closed. As illustrated in FIGS. 11A and 11B, the second liquid storage tank 47 is located so as to be accessible when the cover 71 of the post-processing apparatus 3 is opened. As illustrated in FIG. 11B, the second liquid storage tank 47 and the second liquid storage tank fixer 61 are disposed on the near side in a depth direction (X direction) of the post-processing apparatus 3. The first liquid storage tank 44 is disposed on the far side in the depth direction (X direction) of the post-processing apparatus 3. A housing side plate 72 of the post-processing apparatus 3 is disposed between the arrangement position of the second liquid storage tank 47 and the second liquid storage tank fixer 61 and the arrangement position of the first liquid storage tank 44. The second liquid storage tank fixer 61 is attached to the housing side plate 72 of the post-processing apparatus 3.

FIG. 12 illustrates the second liquid storage tank 47 attachable to and detachable from the second liquid storage tank fixer 61 and replenished with liquid. As illustrated in part (A) of FIG. 12, the second liquid storage tank 47 is detachably attached to the first liquid storage tank 44 so that the second liquid storage tank 47 can replenish the liquid to the first liquid storage tank 44. As illustrated in part (B) of FIG. 12, the second liquid storage tank fixer 61 is provided with the setting detection sensor 51 serving as a setting detector that detects that the second liquid storage tank 47 is set on the second liquid storage tank fixer 61. When the setting detection sensor 51 detects the set state of the second liquid storage tank 47 to the second liquid storage tank fixer 61 (see part (C) of FIG. 12), a signal indicating the set state is transmitted to the controller 100b. Thus, the controller 100b detects whether the second liquid storage tank 47 is mounted in the second liquid-storage-tank fixing portion 921.

The second liquid level sensor 94 (serving as second liquid detector) that detects the amount of liquid L to be stored in the second liquid storage tank 47 is disposed in the second liquid storage tank fixer 61. The output value (voltage) of the second liquid level sensor 94 is notified to the controller 100b. The controller 100b determines the output value (voltage) of the second liquid level sensor 94 to determine whether the amount of liquid stored in the second liquid storage tank fixer 61 is a required amount of liquid. When the controller 100b determines that the second liquid storage tank 47 is set on the second liquid storage tank fixer 61 (i.e., is in a set state) based on the output signal of the setting detection sensor 51, the controller 100b turns on the second liquid level sensor 94 such that the remaining amount of liquid (the amount of the liquid stored) in the second liquid storage tank fixer 61 can be detected.

When the second liquid storage tank 47 is not set on the second liquid storage tank fixer 61 (i.e., is in a non-set state), an outlet of the second liquid storage tank 47 is closed by a liquid supply valve 471 so that the liquid does not leak. As illustrated in part (C) of FIG. 12, when the second liquid storage tank 47 is set to the second liquid storage tank fixer 61, the liquid supply valve 471 is pushed up to open a liquid discharge port 471a of the second liquid storage tank 47. By so doing, the liquid is flow out from the second liquid storage tank 47 to the second liquid storage tank fixer 61. As a result, the liquid stored in the second liquid storage tank 47 flows out to the second liquid storage tank fixer 61. The liquid flown from the second liquid storage tank 47 is temporarily stored in the second liquid storage tank fixer 61.

As a measurement to prevent the liquid from being frozen during maintenance of the post-processing apparatus 3, a liquid draining process may be performed to drain the liquid in the post-processing apparatus 3. In the liquid draining process, the liquid remaining in the first liquid storage tank 44 and the liquid supply passage 45 is supplied by the liquid supply pump 46 to the second liquid storage tank fixer 61 via the liquid supply passage 45 in the reverse direction. In order to deal with such a situation, the second liquid storage tank fixer 61 is set to the amount to sufficiently store liquid in the first liquid storage tank 44 and the liquid supply passage 45. The second liquid storage tank fixer 61 has a liquid drain plug 611. After the liquid remaining in the first liquid storage tank 44 and the liquid supply passage 45 is reversely fed by the liquid supply pump 46 to the second liquid storage tank fixer 61, the liquid drain plug 611 is opened to discharge the liquid stored in the second liquid storage tank fixer 61 from the inside of the post-processing apparatus 3.

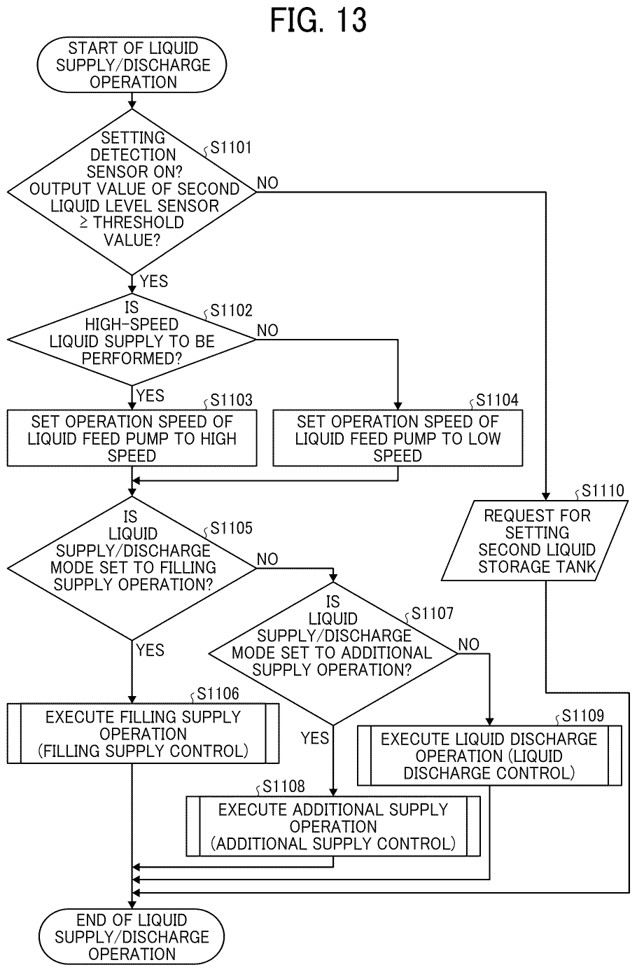

A description is given below of a liquid supply/discharge operation in the liquid applier 31. FIG. 13 is a flowchart illustrating the control process of the liquid supply/discharge operation (hereinafter referred to as the “liquid supply/discharge operation process”) in the liquid applier 31 of the edge binder 25, which is executed in the controller 100b. In the following description, the term “liquid supply/discharge operation” means that liquid used for liquid application is transferred between the second liquid storage tank 47 and the first liquid storage tank 44 by the liquid supply pump 46. In other words, the term “liquid supply/discharge operation” includes both an operation of supplying (replenishing) liquid from the second liquid storage tank 47 to the first liquid storage tank 44 by the liquid supply pump 46 and an operation of feeding (discharging) the second liquid storage tank 47 from the first liquid storage tank 44 by the liquid supply pump 46.

First, when the liquid supply/discharge operation process is started, as illustrated in FIG. 12, the controller 100b determines whether the detachable second liquid storage tank 47 is set on the second liquid storage tank fixer 61 (i.e., the setting detection sensor 51 is in ON state) and whether the liquid L is sufficiently stored in the second liquid storage tank fixer 61 (the output value of the second liquid level sensor 94 is equal to or greater than the threshold value) (step S1101). When the controller 100b determines that the second liquid storage tank 47 is not properly set (the setting detection sensor 51 is in OFF state) and the second liquid storage tank fixer 61 does not store sufficient liquid L (the output value of the second liquid level sensor 94 is less than the threshold value) (NO in step S1101), in step S1110, the controller 100b outputs a request for setting the second liquid storage tank 47 via the operation panel 110 and ends the liquid supply/discharge operation process, since there is a possibility that liquid supply from the second liquid storage tank 47 to the first liquid storage tank 44 by the liquid supply pump 46 may not be normally performed due to lack of liquid in the second liquid storage tank fixer 61.

On the other hand, when the second liquid storage tank 47 is set (the setting detection sensor 51 is in an ON state) and the liquid L is sufficiently stored in the second liquid storage tank fixer 61 (the output value of the second liquid level sensor 94 is equal to or greater than the threshold value) (YES in step S1101), the controller 100b subsequently sets the operation mode of the liquid supply pump 46.

The liquid supply pump 46 is capable of changing a liquid supply speed (a liquid supply mode). The liquid supply speed is changed by selecting and setting one of a plurality of operation settings. The plurality of liquid supply modes of the liquid supply pump 46 are, for example, a “high-speed liquid supply mode” and a “low-speed liquid supply mode”.

In step S1102, the controller 100b determines whether the high-speed liquid supply is performed by the liquid supply pump 46, that is, whether the high-speed liquid supply mode is set. When the controller 100b determines in step S1102 that high-speed liquid supply is to be performed (YES in step S1102), the controller 100b sets the operation speed of the liquid supply pump 46 to high speed (step S1103). The high-speed liquid supply mode is set, for example, in a case where liquid is supplied from the second liquid storage tank 47 to the first liquid storage tank 44 by the liquid supply pump 46 when the liquid stored in the first liquid storage tank 44 is empty. In such a case, it takes time to complete the supply of the liquid into the first liquid storage tank 44, and therefore the controller 100b sets the liquid supply speed of the liquid supply pump 46 (the liquid-supply-pump operation speed) to high speed in order to shorten the time for supplying the liquid into the first liquid storage tank 44.

On the other hand, when the controller 100b determines in step S1102 that the high-speed liquid supply is not to be performed, that is, the low-speed liquid supply mode is set (NO in step S1102), the controller 100b sets the operation speed of the liquid supply pump 46 to low speed (step S1104). For example, in a case where an amount of liquid stored in the first liquid storage tank 44 has been consumed by the liquid applying operation of the liquid applier 31, liquid is supplied from the second liquid storage tank 47 to the first liquid storage tank 44 by the liquid supply pump 46 by an amount corresponding to the consumed amount of liquid, which is an example of the case when the low-speed liquid supply mode is set. In such a case, a small amount of liquid is to be supplied, and therefore, if the liquid is supplied at a high speed, there is a possibility that the liquid overflows from the first liquid storage tank 44 due to excessive supply. Since such side effects are conceivable, there are cases where it is desirable to set the liquid supply speed of the liquid supply pump 46 (the liquid-supply-pump operation speed) to low speed.

As a premise of the processing of determination in step S1102, a user may be allowed to select a setting of the liquid supply speed of the liquid supply pump 46 via the operation panel 110. In addition, the liquid supply speeds of the liquid supply pump 46 corresponding to liquid supply/discharge modes such as a “filling supply operation” and a “additional supply operation”, which will be described later, may be set such that the liquid supply speed of the liquid supply pump 46 corresponding to each liquid supply/discharge mode may be automatically selected according to the selection of each liquid supply/discharge mode in the controller 100b.

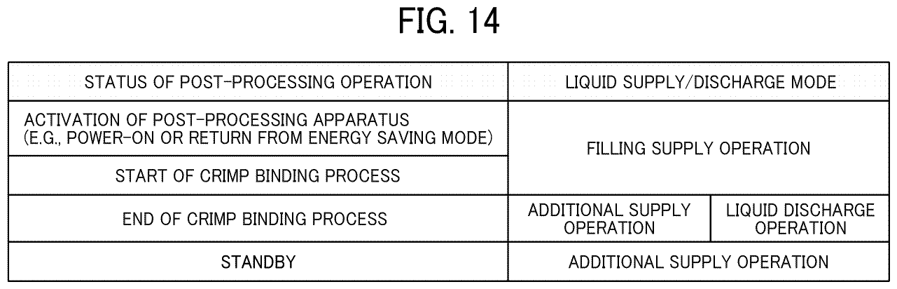

Subsequently, the controller 100b determines the liquid supply/discharge mode (step S1105). The determination of the liquid supply/discharge mode is performed based on, for example, the operation status of the post-processing apparatus 3 (“post-processing operation status”) illustrated in FIG. 14 described later and/or the result of user's input to the selection input screen of the liquid supply/discharge mode illustrated in FIG. 22.

First, in step S1105, the controller 100b determines whether the liquid supply/discharge mode is the “filling supply operation.” When the liquid supply/discharge mode is the “filling supply operation” according to the determination of step S1105 (YES in step S1105), the controller 100b causes the liquid supply pump 46 to execute the “filling supply operation” described later (step S1106) and ends the liquid supply/discharge operation process. On the other hand, when the determination result of step S1105 indicates that the liquid supply/discharge mode is not the “filling supply operation” (NO in step S1105), the controller 100b determines whether the liquid supply/discharge mode is the “additional supplying operation” (step S1107).

When the liquid supply/discharge mode is the “additional supply operation” according to the determination of step S1107 (YES in step S1107), the controller 100b causes the liquid supply pump 46 to execute the “additional supply operation” which will be described later (in step S1108), and ends the liquid supply/discharge operation process. On the other hand, when the determination result of the step S1107 indicates that the liquid supply/discharge mode is not the “additional supply operation” (NO in step S1107), the controller 100b determines that the liquid supply/discharge mode is the “liquid discharge operation”, and causes the liquid supply pump 46 to execute a “liquid discharge operation” to be described later (step S1109), and ends the liquid supply/discharge operation flow.

Details of “filling supply control,” “additional supply control,” and “liquid discharge control” as controls corresponding to the liquid supply/discharge modes (the liquid supply/discharge operations described above) selected based on the determination results of step S1105 and step S1107 will be described later.

A description is given below of a control method for selecting, in a case where an operation executable by the post-processing apparatus 3, for example, the crimp binding process accompanied by liquid application is performed by the crimper 32, a liquid supply/discharge mode optimum for each step of the crimp binding process accompanied by liquid application from a plurality of liquid supply/discharge modes set corresponding to a plurality of steps of the crimp binding process accompanied by liquid application.

FIG. 14 illustrates correspondence between the operation status of the post-processing apparatus 3 (hereinafter, referred to as a “post-processing operation status”) and the liquid supply/discharge mode selected correspondingly when the post-processing apparatus 3 performs the liquid supply/discharge operation.

For example, the “post-processing operation status” is distinguished from “activation of post-processing apparatus” (such as when the post-processing apparatus 3 is turned on or returns from an energy saving mode) that corresponds to the time of activation of the post-processing apparatus 3, “start of crimp binding process”, “end of crimp binding process”, and “standby”.

The term “crimp binding process” in the above-described “start of crimp binding process” and “end of crimp binding process” is a crimp binding process involving application of liquid.

The “filling supply operation” is selected as the liquid supply/discharge mode at a timing when the crimp binding process is started in the post-processing apparatus 3, such as “activation of the post-processing apparatus” or “start of the crimp binding process.” For example, when the number of times of execution of crimp binding process accompanied by liquid application is large and it is desired to shorten a wait time until a state in which liquid application is executable is achieved, the filling supply operation is also executed at the time of activation of the post-processing apparatus 3. Furthermore, in a case where the frequency of execution of the crimp binding process accompanied by liquid application is low and it is desired to prevent, for example, evaporation of the liquid while the edge binder 25 is not operating, the filling supply operation is executed each time the crimp binding process accompanied by liquid application is started.

The “additional supply operation” is selected as the liquid supply/discharge mode, for example, at the time of “end of crimp binding process” or “standby.” For example, at the end of the crimp binding process accompanied by liquid application, the additional supply operation is executed for the liquid application in the next crimp binding process accompanied by liquid application. The additional supply operation is an operation executed for the purpose of supplying (replenishing), into the first liquid storage tank 44, an amount of liquid equivalent to the amount consumed by the liquid application in the ended crimp binding process accompanied by liquid application. The additional supply operation is also executed in a case where a wait time until a start of liquid application in the next crimp binding process accompanied by liquid application is shortened. Furthermore, in a case where the liquid in the first liquid storage tank 44 evaporates due to the post-processing apparatus 3 continuing the standby state for a predetermined time, the additional supply operation is also executed in order to supply (replenish) the first liquid storage tank 44 with an amount of liquid decreased by the evaporation.

In addition to the above-described method, a user may select the liquid supply/discharge mode via the operation panel 110 of at least one of the image forming apparatus 2 and the post-processing apparatus 3 so that the above-described filling supply operation and additional supply operation can be manually selected for execution.

### Filling Supply Operation

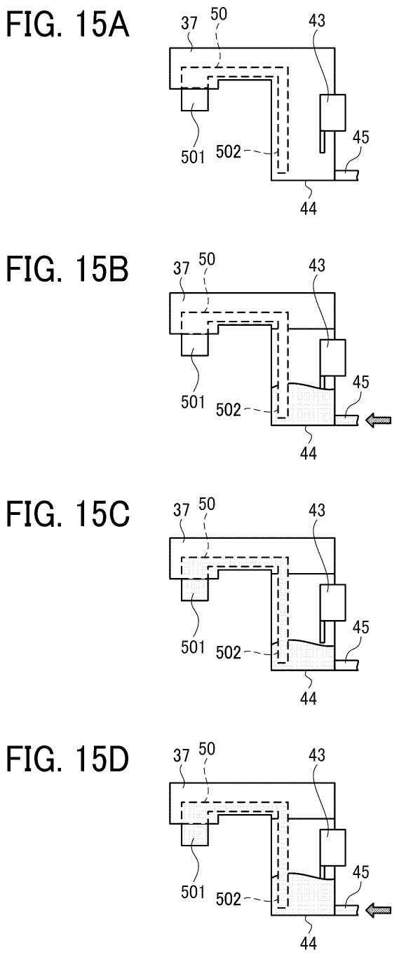

A description is given below of an outline of a filling supply operation that is one of the liquid supply/discharge modes with reference to FIGS. 15A, 15B, and 15C. FIG. 15A illustrates an example of an empty state of liquid in the first liquid storage tank 44. From this state, liquid is supplied from the second liquid storage tank 47 to the first liquid storage tank 44 by the liquid supply pump 46 until a state as illustrated in FIG. 15B. At this time, liquid is supplied from the second liquid storage tank 47 to the first liquid storage tank 44 by the liquid supply pump 46 until the first liquid level sensor 43 detects liquid in the first liquid storage tank 44. A liquid level (an amount of liquid stored in the first liquid storage tank 44) when the first liquid level sensor 43 detects the liquid in the first liquid storage tank 44 is set as a “reference liquid level”.

Then, the liquid stored in the first liquid storage tank 44 is sucked up by the effect of capillary action of the liquid supply member 50. As a result, the level of the liquid stored in the first liquid storage tank 44 decreases to a level lower than the reference liquid level (see FIG. 15C). When the liquid level of the liquid stored in the first liquid storage tank 44 decreases, in order to return the liquid level of the liquid stored in the first liquid storage tank 44 to the reference liquid level, an operation of supplying liquid from the second liquid storage tank 47 to the first liquid storage tank 44 is performed again by the liquid supply pump 46 as necessary (see FIG. 15D).

In the present embodiment, an electrode sensor has been described as an example of the first liquid level sensor 43, but the first liquid level sensor 43 is not limited thereto, and other methods may be employed. For example, a float sensor or a capacitance sensor may be used to detect the presence of the liquid. Furthermore, the first liquid level sensor 43 need only be able to detect the presence of liquid (stored liquid amount) in the first liquid storage tank 44, and is not limited to a sensor that detects the liquid level (surface level) of liquid in the first liquid storage tank 44.

In a case where an electrode sensor is used as the first liquid level sensor 43, there is a concern that the metal used for the electrodes might be corroded due to electrolytic corrosion if the pair of electrodes is energized (applied with electricity) constantly. Further, since the voltage is always applied to the liquid stored in the first liquid storage tank 44, there is a concern that the liquid might be electrolyzed or that the electrodes might be dissolved due to adhesion of foreign matter to the surface of the electrodes by electrolysis, which might induce deterioration of the electrodes. For this reason, the controller 100b controls the timing of energization of the first liquid level sensor 43 such that the first liquid level sensor 43 is not energized all the time but is energized (energized ON) only when the first liquid level sensor 43 detects whether there is liquid stored at the position of the stored liquid amount (liquid level) of the first liquid storage tank 44.

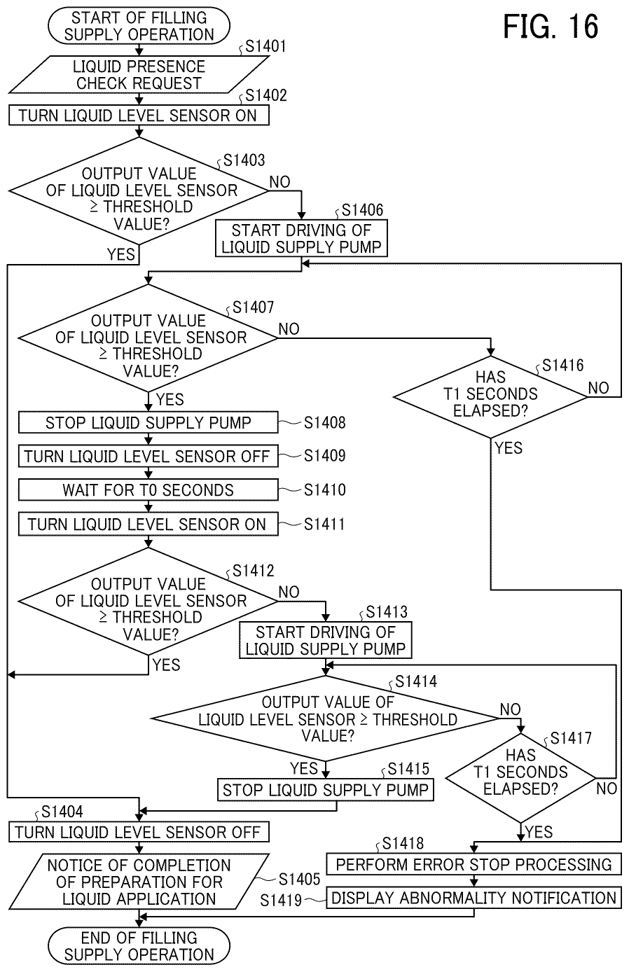

A description is given of a control process of the filling supply operation. FIG. 16 is a flowchart of an example of a control process of a filling supply operation (hereinafter, referred to as a “filling supply control process”) which is an example of a liquid supply operation executed in the controller 100b. As illustrated in FIG. 14, the filling supply operation is executed at an activation of the post-processing apparatus 3 or a start of a crimp binding process accompanied by liquid application.

When the post-processing apparatus 3 is activated, the filling supply control process is started. When the filling supply control process is started, a liquid presence check request is instructed from the image forming apparatus 2 to the controller 100b (step S1401). The liquid presence check request may be instructed based on information input by the user from the operation panel 110 of one or both of the image forming apparatus 2 and the post-processing apparatus 3. In response to receipt of the liquid presence check request instructed from the image forming apparatus 2, the controller 100b applies a voltage to the first liquid level sensor 43 (turns on energization) (step S1402).

Subsequently, the controller 100b acquires an output value (voltage) that is output when the first liquid level sensor 43 detects liquid in the first liquid storage tank 44, and determines the presence (the stored liquid amount) of liquid in the first liquid storage tank 44 (step S1403). The determination of the presence of liquid (the stored liquid amount) in the first liquid storage tank 44 is performed based on whether the output value (voltage) from the first liquid level sensor 43 exceeds a “liquid detection threshold value” (threshold value) set in advance. For example, when the output value (voltage) from the first liquid level sensor 43 is equal to or greater than the liquid detection threshold value (e.g., output voltage V1), the controller 100b determines that the amount of liquid stored in the first liquid storage tank 44 is a sufficient amount (YES in step S1403). In this case, the controller 100b stops the application of the voltage to the first liquid level sensor 43 (turns the energization of the first liquid level sensor 43 off) in step S1404, displays a completion notice of the preparation for liquid application on, for example, the operation panel 110 in step S1405, and ends the filling supply control process.

Alternatively, in step S1403, when the output value (voltage) from the first liquid level sensor 43 is less than the liquid detection threshold value (e.g., the output voltage V1) (NO in step S1403), in step S1406, the controller 100B operates the liquid supply pump 46 to supply the liquid from the second liquid storage tank 47 to the first liquid storage tank 44.

Subsequently, the controller 100b determines whether the output value (voltage) from the first liquid level sensor 43 is equal to or greater than the “liquid detection threshold value” (threshold value) set in advance (step S1407). When the output value (voltage) from the first liquid level sensor 43 is equal to or greater than the liquid detection threshold value (e.g., the output voltage V1), the controller 100b determines that a sufficient amount of liquid has been supplied from the second liquid storage tank 47 into the first liquid storage tank 44 by the liquid supply pump 46 (YES in step S1407). On the other hand, when the output value from the first liquid level sensor 43 is less than the liquid detection threshold (e.g., the output voltage V1) (NO in step S1407), in step S1416, the controller 100b determines whether an elapsed time from the start of the operation of the liquid supply pump 46 (step S1406) has reached an abnormality determination time (T1 [seconds (sec)]). When the elapsed time has not reached the abnormality determination time T1 (NO in step S1416), the controller 100b continues the supply of the liquid from the second liquid storage tank 47 to the first liquid storage tank 44 by the liquid supply pump 46 until the output value (voltage) from the first liquid level sensor 43 becomes equal to or greater than the liquid detection threshold value (e.g., output voltage V1) (YES in step S1407).

On the other hand, when the elapsed time has reached the abnormality determination time T1 (YES in step S1416), the controller 100b determines that some abnormality (such as a failure of the liquid supply pump 46 and/or the first liquid level sensor 43) has occurred in a device, and executes an error stop process of stopping the liquid supply pump 46 and/or turning off the energization of the first liquid level sensor 43 (step S1418). In step S1419, the controller 100b causes the operation panel 110 to display an abnormality notice, and ends the filling supply control process.

In step S1407, when the output value (voltage) from the first liquid level sensor 43 becomes equal to or greater than the liquid detection threshold value (e.g., output voltage V1) (YES in step S1407), the controller 100b stops the liquid supply pump 46 and stops the supply of liquid from the second liquid storage tank 47 to the first liquid storage tank 44 (step S1408). In step S1409, the controller 100b stops the application of voltage to the first liquid level sensor 43 (turns off the energization).

Thereafter, the filling supply control flow is temporarily stopped (TO) until a standby time (first predetermined time S1410 [sec]), which is preset as a time until the liquid in the first liquid storage tank 44 is sucked up by a capillary phenomenon or the like of the liquid supply member 50 and the liquid application member 501 can apply liquid (a state where liquid is sufficiently stored in the liquid application member 501 and/or the liquid supply member 50), elapses.

After the first predetermined time TO has elapsed, the controller 100b turns on the energization of the first liquid level sensor 43 again (step S1411), acquires an output value (voltage) that is output when the first liquid level sensor 43 detects the liquid in the first liquid storage tank 44, and determines the presence (the stored liquid amount) of liquid in the first liquid storage tank 44 (step S1412). At this stage, the liquid level (stored liquid amount) of liquid in the first liquid storage tank 44 decreases due to the sucking-up of the liquid supply member 50. However, when the output value (voltage) from the first liquid level sensor 43 is equal to or greater than the liquid detection threshold value (e.g., the output voltage V1) (YES in step S1412), the controller 100b stops the application of the voltage to the first liquid level sensor 43 (turns off the energization) (step S1404). In step S1405, the controller 100b displays a completion notice of the preparation for liquid application on, for example, the operation panel 110, and ends the filling supply control process.

Alternatively, in step S1412, when the output value (voltage) from the first liquid level sensor 43 is less than the liquid detection threshold value (e.g., the output voltage V1) (NO in step S1412), in step S1413, the controller 100B operates the liquid supply pump 46 to supply the liquid from the second liquid storage tank 47 to the first liquid storage tank 44.

Subsequently, the controller 100b acquires an output value (voltage) that is output when the first liquid level sensor 43 detects liquid in the first liquid storage tank 44, and determines the presence (the stored liquid amount) of liquid in the first liquid storage tank 44 (step S1414). Subsequently, when the output value (voltage) from the first liquid level sensor 43 is equal to or greater than the liquid detection threshold value (e.g., the output voltage V1) (YES in step S1414), the controller 100b determines that a sufficient amount of liquid has been supplied into the first liquid storage tank 44. In this case, the controller 100b stops the liquid supply pump 46 to stop the supply of liquid from the second liquid storage tank 47 to the first liquid storage tank 44 (step S1415). Then, the controller 100 b stops the application of the voltage to the first liquid level sensor 43 (turns the energization of the first liquid level sensor 43 off) in step S1404, displays a completion notice of the preparation for liquid application on, for example, the operation panel 110 in step S1405, and ends the filling supply control process.

On the other hand, when the output value (voltage) from the first liquid level sensor 43 is less than the liquid detection threshold value (e.g., the output voltage V1) (S1414: No), the controller 100b determines whether an elapsed time from the start (S1413) of the operation of the liquid supply pump 46 has exceeded the abnormality determination time (T1 [sec]) (S1417). When the elapsed time has not reached the abnormality determination time T1 (NO in step S1416), the controller 100b continues the supply of the liquid from the second liquid storage tank 47 to the first liquid storage tank 44 by the liquid supply pump 46 until the output value (voltage) from the first liquid level sensor 43 becomes equal to or greater than the liquid detection threshold value (e.g., output voltage V1) (YES in step S1407).

On the other hand, when the elapsed time has reached the abnormality determination time T1 (YES in step S1416), the controller 100b determines that some kind of abnormality has occurred in the apparatus, and executes error stopping processing of stopping the liquid supply pump 46 and/or turning off the energization of the first liquid level sensor 43 (step S1418). In step S1419, the controller 100b causes the operation panel 110 to display an abnormality notice, and ends the filling supply control process. The “abnormality notice” may be, for example, a display of a warning on the operation panel 110 to prompt a check because there is a possibility that one or both of the liquid supply pump 46 and the first liquid level sensor 43 are out of order.

The above-described execution of the filling supply control process allows a constant amount of liquid that enables the liquid application by the liquid application member 501 to be stably ensured for the liquid supply member 50 and/or the liquid application member 501. As a result, the frequency of the liquid supply operation from the second liquid storage tank 47 to the first liquid storage tank 44 by the liquid supply pump 46 can be reduced, and the efficiency of the liquid application process can be enhanced.

A description is given below of a relation between the filling supply control process described with reference to FIG. 16 and a filling supply operation that is an example of the liquid supply operation described with reference to FIG. 15. First, in the state illustrated in FIG. 15A (“activation of the post-processing apparatus” in FIG. 14), the controller 100b turns on the energization of the first liquid level sensor 43 (step S1402), acquires an output value (voltage) that the first liquid level sensor 43 outputs when detecting the liquid in the first liquid storage tank 44, and determines the presence of the liquid (the stored liquid amount) in the first liquid storage tank 44 (step S1403). At this stage, the first liquid storage tank 44 is empty, and thus the output value (voltage) from the first liquid level sensor 43 is less than the liquid detection threshold value (e.g., output voltage V1). For this reason, the controller 100b determines that the state of the inside of the first liquid storage tank 44 is the state of “absence of liquid” (NO in step S1403), and drives the liquid supply pump 46 to execute supply of liquid from the second liquid storage tank 47 to the first liquid storage tank 44 (step S1406). When the amount (liquid level) of the liquid stored in the first liquid storage tank 44 reaches the state of FIG. 15B, the output value (voltage) from the first liquid level sensor 43 becomes equal to or greater than the liquid detection threshold value (e.g., the output voltage V1) (YES in step S1407). In step S1408, the controller 100b stops the liquid supply pump 46 and then turns off the energization of the first liquid level sensor 43 (step S1409).

Subsequently, when the first predetermined time TO, which is set in advance as the time taken until the liquid supply member 50 sucks up liquid as illustrated in FIG. 15C and turns to an executable state for liquid application, has elapsed, the controller 100b turns on the energization of the first liquid level sensor 43 again (step S1411). At this stage, a predetermined amount of liquid is sucked up by the liquid supply member 50 from the first liquid storage tank 44 to the liquid supply member 50. As a result, the amount of the liquid stored in the first liquid storage tank 44 decreases and the liquid level of the liquid in the first liquid storage tank 44 becomes lower than the reference liquid level. As a result, the output value (voltage) from the first liquid level sensor 43 becomes less than the liquid detection threshold value (e.g., output voltage V1) (NO in step S1412).

Then, the controller 100b causes the liquid supply pump 46 to operate again (step S1413) and executes supply of the liquid from the second liquid storage tank 47 to the first liquid storage tank 44 until the output value (voltage) from the first liquid level sensor 43 becomes equal to or greater than the liquid detection threshold value (e.g., output voltage V1) (YES in step S1414). When the output value (voltage) from the first liquid level sensor 43 becomes equal to or greater than a liquid detection threshold value (e.g., output voltage V1), the controller 100 b stops the liquid supply pump 46 (step S1415) and then turns off the energization of the first liquid level sensor 43 (step S1404). As a result, as illustrated in FIG. 15D, the liquid in the first liquid storage tank 44 is sufficiently stored in the entirety of the liquid supply member 50 and/or the liquid application member 501, and the controller 100b causes the operation panel 110 to display the completion notice of the preparation for liquid application (step S1405).

As described above, the “filling supply operation” is a liquid supply/discharge mode to be executed when the liquid application is executed by the liquid applier 31. That is, in order to stably apply a constant amount of liquid to a sheet P, preferably, the liquid supply member 50 and/or the liquid application member 501 always store a constant amount of liquid.

However, in a case where the first liquid level sensor 43 cannot detect liquid in a state where the first liquid storage tank 44 is empty as in the case of activation of the post-processing apparatus 3 (see FIG. 15A), preferably, the supply of liquid from the second liquid storage tank 47 to the first liquid storage tank 44 by the liquid supply pump 46 is executed such that the liquid level (stored liquid amount) of liquid in the first liquid storage tank 44 becomes equal to or greater than the reference liquid level. Furthermore, the same applies to a case where the amount of liquid stored in the first liquid storage tank 44 decreases and the liquid level of the liquid in the first liquid storage tank 44 becomes lower than the reference liquid level (see FIG. 15C) due to the operation of the liquid applier 31 (the liquid application member 501) to apply liquid to the sheet P. In other words, the supply of the liquid from the second liquid storage tank 47 to the first liquid storage tank 44 by the liquid supply pump 46 is preferably executed such that the liquid level (stored liquid amount) of the liquid in the first liquid storage tank 44 is equal to or higher than the reference liquid level. The liquid supply/discharge mode in which the liquid supply pump 46 supplies liquid from the second liquid storage tank 47 to the first liquid storage tank 44 is the “filling supply operation”.

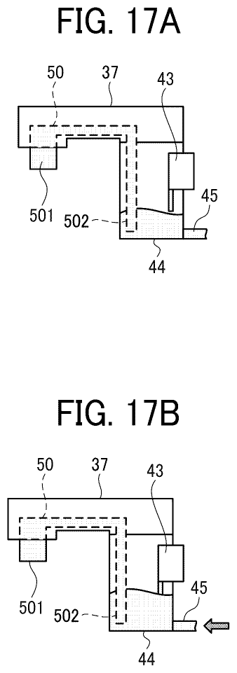

A description is given below of an additional supply operation that is one of the liquid supply/discharge modes. FIGS. 17A and 17B illustrate an outline of the additional supply operation.

The additional supply operation is a liquid supply/discharge mode in which when the liquid stored in the first liquid storage tank 44 is consumed by application of liquid to the sheet P by the liquid applier 31 and the liquid level (stored liquid amount) of the liquid in the first liquid storage tank 44 decreases to a level lower than a reference liquid level, the supply of liquid from the second liquid storage tank 47 to the first liquid storage tank 44 is executed. In this case, when the liquid level in the first liquid storage tank 44 has decreased to a level at which the first liquid level sensor 43 does not detect the liquid in the first liquid storage tank 44, the controller 100b operates the liquid supply pump 46 to execute the supply of the liquid from the second liquid storage tank 47 to the first liquid storage tank 44 until a state where the first liquid level sensor 43 detects the liquid in the first liquid storage tank 44 (the liquid level of the liquid in the first liquid storage tank 44 reaches a reference liquid level) is achieved.

The filling supply operation described above is a liquid supply operation performed when the liquid is supplied to the liquid supply member 50 in a state where the stored liquid amount (liquid level) in the first liquid storage tank 44 has decreased and it is necessary to supply the liquid to the liquid supply member 50 (a state where the liquid used for the liquid application is insufficient). On the other hand, the additional supply operation is a liquid supply operation in which liquid is supplied to the first liquid storage tank 44 in a state where liquid is held by the liquid supply member 50 (a state where liquid used for liquid application is not insufficient). In other words, it is assumed that the liquid level (stored liquid amount) of the liquid in the first liquid storage tank 44 has dropped to a level lower than the reference liquid level (see FIG. 17A) as a result of consumption of the liquid by liquid application from a state (see FIG. 15D) in which the liquid level (stored liquid amount) of the liquid in the first liquid storage tank 44 has been filled to above the reference liquid level. In this case, the liquid supply pump 46 is operated to supply additional liquid from the second liquid storage tank 47 into the first liquid storage tank 44 such that the liquid level (stored liquid amount) of the liquid in the first liquid storage tank 44 turns to be equal to or greater than the reference liquid level again as illustrated in FIG. 17B. In other words, the additional supply operation is a liquid supply/discharge mode in which liquid is supplied from the second liquid storage tank 47 to the first liquid storage tank 44 by the liquid supply pump 46 as the liquid in the first liquid storage tank 44 is consumed by liquid application.

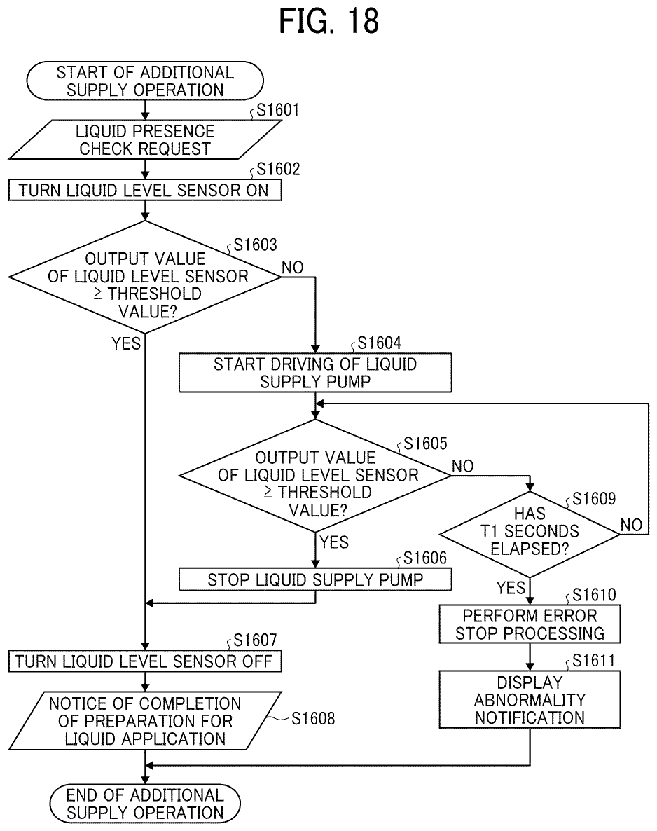

A description is given below of a control process of the additional supply operation. FIG. 18 is a flowchart of an example of a control process of an additional supply operation (hereinafter, referred to as a “additional supply control process”) which is an example of a liquid supply operation executed in the controller 100b. As illustrated in FIG. 14, the additional supply operation is executed at an end of the crimp binding process by the crimper 32 accompanied by the liquid application or during standby of the post-processing apparatus 3 (such as when the edge binder 25 is not operating).

For example, when the crimp binding process by the crimper 32 accompanied by the liquid application ends, the additional supply control process is started. When the additional supply control process is started, a liquid presence check request is instructed from the image forming apparatus 2 to the controller 100b (step S1601). The liquid presence check request may be instructed based on information input by the user from the operation panel 110 of one or both of the image forming apparatus 2 and the post-processing apparatus 3. In response to receipt of the liquid presence check request instructed from the image forming apparatus 2, the controller 100b applies a voltage to the first liquid level sensor 43 (turns on energization) (step S1602).

Subsequently, the controller 100b acquires an output value that is output when the first liquid level sensor 43 detects the liquid in the first liquid storage tank 44, and determines the presence of the liquid (the stored liquid amount) in the first liquid storage tank 44 (step S1603). The determination of the presence of liquid (the stored liquid amount) in the first liquid storage tank 44 is performed based on whether the output value (voltage) from the first liquid level sensor 43 exceeds a “liquid detection threshold value” (threshold value) set in advance. For example, when the output value (voltage) from the first liquid level sensor 43 is equal to or greater than the liquid detection threshold value (e.g., output voltage V1), the controller 100b determines that the amount of liquid stored in the first liquid storage tank 44 is a sufficient amount (YES in step S1603). In this case, the controller 100b stops the application of the voltage to the first liquid level sensor 43 (turns the energization of the first liquid level sensor 43 off) in step S1607, displays a completion notice of the preparation for liquid application on, for example, the operation panel 110 in step S1608, and ends the additional supply control process.

On the other hand, in step S1603, when the output value (voltage) from the first liquid level sensor 43 is less than the liquid detection threshold value (e.g., the output voltage V1) (NO in step S1603), the controller 100b operates the liquid supply pump 46 to execute the supply of the liquid from the second liquid storage tank 47 to the first liquid storage tank 44 (step S1604).

Subsequently, the controller 100b determines whether the output value (voltage) from the first liquid level sensor 43 is equal to or greater than the “liquid detection threshold value” (threshold value) set in advance (step S1605). When the output value (voltage) from the first liquid level sensor 43 is equal to or greater than the liquid detection threshold value (e.g., the output voltage V1), the controller 100b determines that a sufficient amount of liquid has been supplied from the second liquid storage tank 47 into the first liquid storage tank 44 by the liquid supply pump 46 (YES in step S1605). In this case, the controller 100b stops the liquid supply pump 46 to stop the supply of liquid from the second liquid storage tank 47 to the first liquid storage tank 44 (step S1606). In this case, the controller 100 b stops the application of the voltage to the first liquid level sensor 43 (turns the energization of the first liquid level sensor 43 off) in step S1607, displays a completion notice of the preparation for liquid application on, for example, the operation panel 110 in step S1608, and ends the additional supply control process.

On the other hand, when the output value from the first liquid level sensor 43 is less than the liquid detection threshold (e.g., the output voltage V1) (NO in step S1605), in step S1609, the controller 100b determines whether an elapsed time from the start of the operation of the liquid supply pump 46 (step S1604) has reached an abnormality determination time (T1 [seconds (sec)]). When the elapsed time has not reached the abnormality determination time T1 (NO in step S1609), the controller 100b continues the supply of the liquid from the second liquid storage tank 47 to the first liquid storage tank 44 by the liquid supply pump 46 until the output value (voltage) from the first liquid level sensor 43 becomes equal to or greater than the liquid detection threshold value (e.g., output voltage V1) (YES in step S1605).

On the other hand, when the elapsed time has reached the abnormality determination time T1 (YES in step S1609), the controller 100b determines that some kind of abnormality has occurred in the apparatus, and executes error stopping processing of stopping the liquid supply pump 46 and/or turning off the energization of the first liquid level sensor 43 (step S1610). In step S1611, the controller 100b causes the operation panel 110 to display an abnormality notice, and ends the additional supply control process. The “abnormality notice” is similar to that described above, and hence description thereof is omitted.

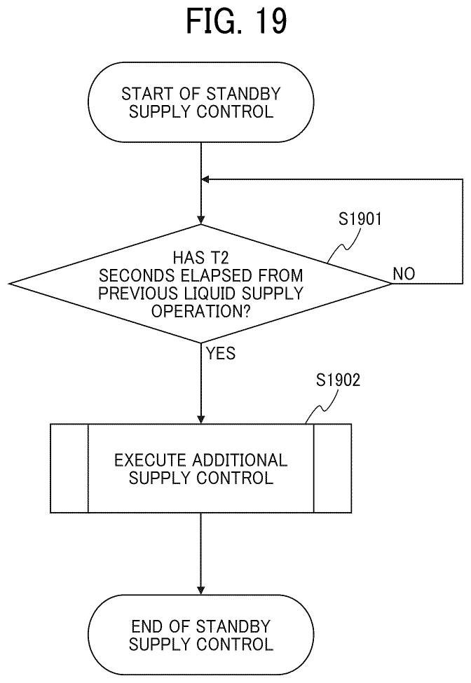

A description is given below of a control process of the standby time supply operation. A description is given below of a control process of the standby supply operation (hereinafter, referred to as a “standby supply control process”) with reference to FIG. 19. When the above-described liquid application and liquid supply operations are periodically performed in the post-processing apparatus 3, the amount of liquid stored in the first liquid storage tank 44 is maintained at an appropriate level. However, in a case where the liquid application and/or the liquid supply operation is not performed for a long period of time, there is a risk that the liquid evaporates and the amount of the liquid stored in the first liquid storage tank 44 decreases or the first liquid storage tank 44 becomes empty.

As already described, the liquid supply member 50 and/or the liquid application member 501 is/are made of a liquid absorber such as a sponge, and hence the liquid absorber may dry out if the liquid storage device is left for a long time in a state where there is no liquid in the first liquid storage tank 44. Once the liquid supply member 50 and/or the liquid application member 501 (liquid absorber) is in a dry state, even if liquid supply to the first liquid storage tank 44 is performed again, it will take a considerable time for the liquid application member 501 and/or the liquid application member 501 to complete sucking up of liquid. As a result, a user's wait time increases and user convenience decreases. In addition, if a binding process (crimp binding process and/or staple binding process) accompanied by liquid application is performed before suction of liquid by the liquid application member 501 and/or the liquid application member 501 is completed, there is a risk that liquid application to the sheet P becomes insufficient, binding failure occurs, and binding quality decreases.

For this reason, when the liquid supply operation has not been performed for a certain period of time (during standby), the liquid supply operation is periodically performed in preparation for the next crimp binding process accompanied by liquid application, thereby preventing the liquid application member 501 and/or the liquid application member 501 from drying. Accordingly, the time required until the start of the liquid application process by the liquid applier 31 in the next crimp binding process accompanied by liquid application can be shortened. Thus, user convenience can be enhanced by shortening the user's wait time. In addition, since it is possible to reduce a binding failure which occurs due to insufficient liquid application to the sheet P since a binding operation (crimp binding process and/or staple binding process) accompanied by the liquid application process is performed before the completion of the suction of the liquid by the liquid application member 501 and/or the liquid application member 501, the binding quality can be enhanced.

FIG. 19 is a flowchart illustrating a standby supply control process. When the standby supply control process is started, the controller 100b counts, with a timer, an elapsed time (hereinafter, referred to as an elapsed time after the liquid supply operation) from a point in time when the liquid supply operation such as the filling supply operation and the additional supply operation ends, and monitor whether the elapsed time after the liquid supply operation has reached the second predetermined time (T2 [sec]) as the elapsed determination time (step S1901). The controller 100b continues the monitoring until the elapsed time from the liquid supply operation reaches the second predetermined time T2 (NO in step S1901).

When the elapsed time after the liquid supply operation has reached the second predetermined time T2 (YES in step S1901), in step S1902, the controller 100b executes the additional supply control process that is control of the additional supply operation described above, and then ends the standby supply control process. During the timer count, the timer is reset when any liquid supply operation is performed. The second predetermined time T2 is set to a time taken until the first liquid storage tank 44 becomes empty when left without performing the liquid supply operation, in consideration of properties of the liquid stored in the first liquid storage tank 44 and other factors.

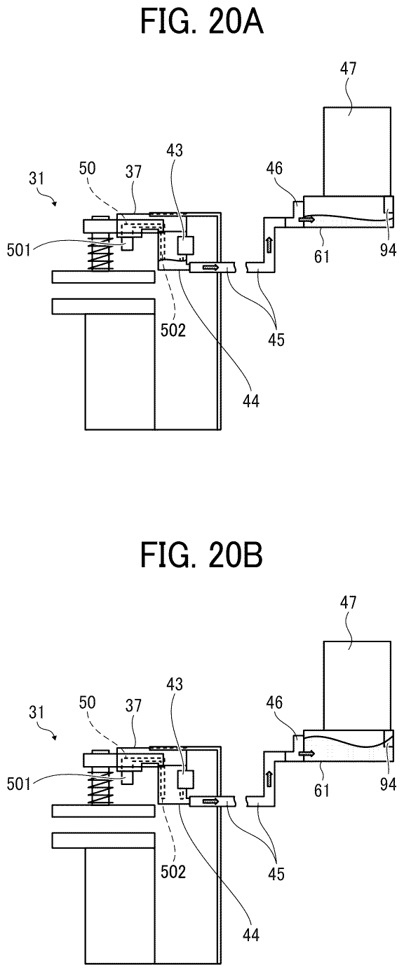

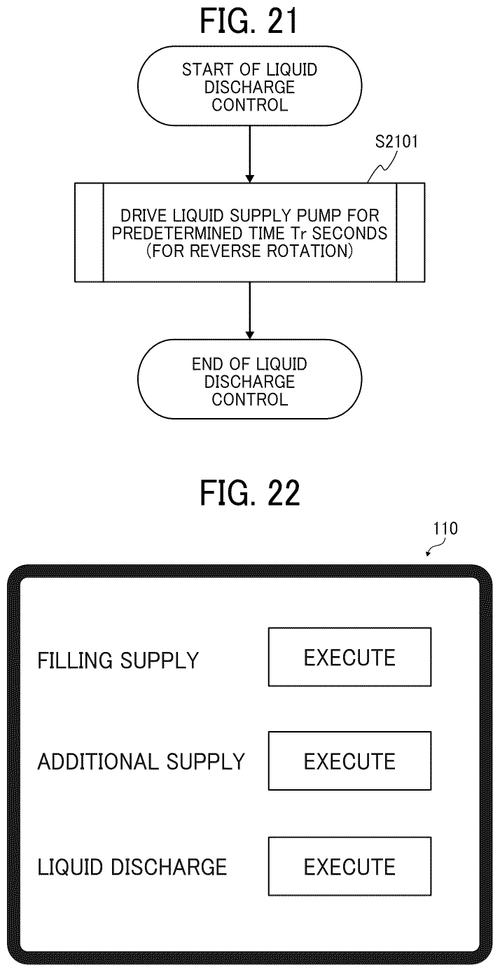

A description is given below of a liquid discharge operation and a control process of the liquid discharge operation. Specifically, a description is given below of liquid discharge control for controlling a liquid discharge operation executable in the post-processing apparatus 3. FIGS. 20A and 20B are diagrams an outline of a liquid discharge operation which is one of liquid supply/discharge modes. FIG. 21 is a flowchart illustrating a control process of the liquid discharge operation (“liquid discharge control process”). Here, the term “liquid discharge operation” refers to feeding of the liquid stored in the first liquid storage tank 44 to the second liquid storage tank 47 by the liquid supply pump 46. In other words, the liquid is fed in a direction opposite to the liquid supply direction in the above-described liquid supply operation.

During use of the post-processing apparatus 3, the first liquid storage tank 44, the liquid supply member 50, and/or the liquid application member 501 are filled with liquid. However, it may be necessary to perform an operation of emptying the first liquid storage tank 44 (the above-described “liquid draining process”) in order to prevent liquid leakage from the first liquid storage tank 44 when an operation is performed with the liquid supply member 50 and/or the liquid application member 501 removed for maintenance or in order to prevent contamination by liquid when the post-processing apparatus 3 is not used for a long time. For example, in such a case, the liquid discharge operation is executed.

When the “liquid discharge operation” is selected as the liquid supply/discharge mode, the liquid discharge control process is started. When the liquid discharge control process starts, the controller 100 b drives (rotates in reverse) the liquid supply pump 46 (step S2101) for a predetermined time (Tr [sec]) to suck up liquid from the first liquid storage tank 44 (see FIG. 20A). As a result, liquid in the first liquid storage tank 44 is sent to the second liquid storage tank fixer 61 and is discharged from the first liquid storage tank 44, thus leaving the first liquid storage tank 44 empty (see FIG. 20B). The predetermined time Tr, which is the operation time of the liquid supply pump 46, is set to, for example, a time during which the liquid in the first liquid storage tank 44 and the liquid supply member 50 and/or the liquid application member 501 is sufficiently discharged. The controller 100b drives (rotates in reverse) the liquid supply pump 46 for the predetermined time Tr, and ends the liquid discharge control process.

The “liquid discharge operation” as the liquid supply/discharge mode may be executed by a user's selection of a desired mode on an operation screen of the operation panel 110 as illustrated in FIG. 22. Further, a user can also provide an instruction to execute the “filling supply operation” or the “additional supply operation” as the liquid supply/discharge mode via the operation panel 110.

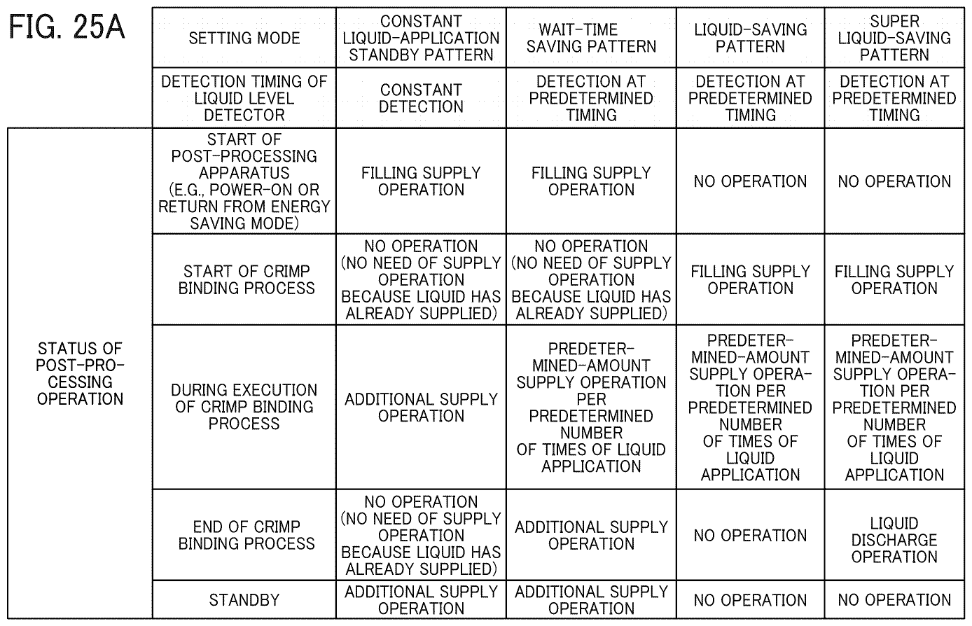

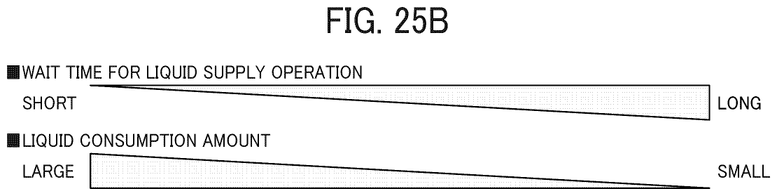

A description is given below of the control pattern setting of a liquid supply operation. The above-described post-processing apparatus 3, which is a medium processing apparatus according to an embodiment of the present disclosure, applies liquid to a point (liquid application position) corresponding to a binding position in advance when performing a crimp binding process accompanied by liquid application. Thus, the binding strength can be enhanced, and liquid to be applied can be appropriately supplied (replenished). Further, the post-processing apparatus 3 according to the present embodiment includes a plurality of liquid supply control patterns for switching the plurality of liquid supply/discharge operations (the operations of the “liquid supply/discharge modes” illustrated in FIG. 14) described above to execute a liquid supply/discharge operation according to the operation status of the post-processing apparatus 3. Settings of the liquid supply/discharge operation corresponding to the operation status of the post-processing apparatus 3 are different for each one of the plurality of liquid supply control patterns (see FIG. 25A). The post-processing apparatus 3 is configured to allow the user to select any desired liquid supply control pattern from among the plurality of liquid supply control patterns.

Typically, the frequency of execution and the execution or non-execution of the crimp binding process accompanied by liquid application vary with the use environment (including the usage pattern of the user) of the post-processing apparatus 3. Furthermore, items to be prioritized, such as “priority on saving of liquid” and “priority on shortening of a wait time in a crimp binding process accompanied by liquid application,” vary depending on the usage pattern of the user included in the usage environment. In other words, the post-processing apparatus 3 is used in various environments. For this reason, the convenience for the user can be enhanced by enabling the user to select any liquid supply control pattern according to the user's needs which vary according to the usage environment of the post-processing apparatus 3.

According to an embodiment of the present disclosure described below, liquid supply control can be appropriately switched in accordance with the use environment of the post-processing apparatus 3. Thus, the liquid supply operation that matches the needs of the user can be achieved, and the convenience for the user can be enhanced.

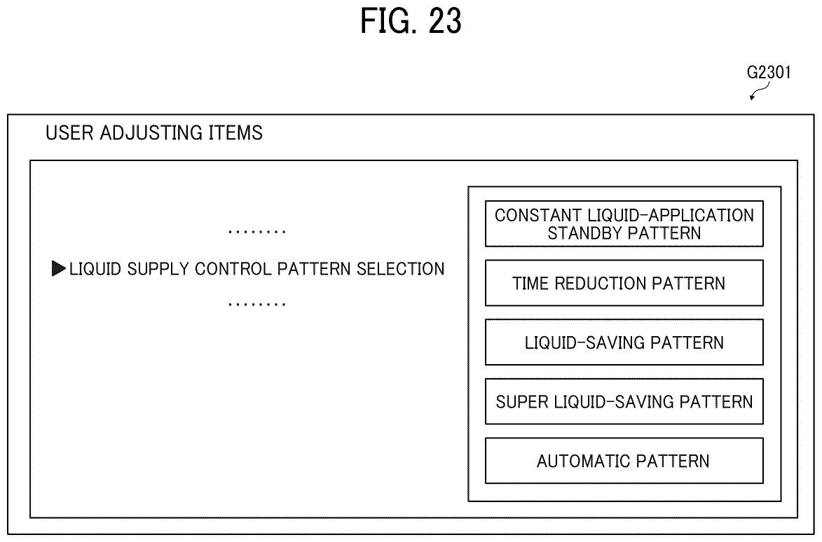

A description is given below of the control pattern setting of the liquid supply operation. FIG. 23 illustrates an example of a user interface for enabling the user to select and set any desired liquid supply control pattern from among a plurality of liquid supply control patterns in the post-processing apparatus 3. When the user sets a liquid supply control pattern using a liquid supply control pattern setting screen G2301 illustrated in FIG. 23 as a control pattern selector, the liquid supply/discharge operation in the liquid supply/discharge mode corresponding to the operation status of the post-processing apparatus 3 can be executed based on the set liquid supply control pattern. The liquid supply control pattern setting screen G2301 is a screen to be displayed on the operation panel 110.

As illustrated in the liquid supply control pattern setting screen G2301, a plurality of liquid supply control patterns executable in the post-processing apparatus 3 include, for example, a “constant liquid-application standby pattern” (constant liquid-application-preparation completion pattern), a “wait-time saving pattern”, a “liquid-saving pattern”, a “super liquid-saving pattern”, and an “automatic pattern” for automatically selecting a liquid supply control pattern.

In the “automatic pattern,” an appropriate liquid supply control pattern is automatically selected and set from among the other four patterns on the basis of the expected amount of liquid to be used calculated through accumulation and analysis of information on the crimp binding process accompanied by liquid application.

The plurality of liquid supply control patterns is stored (held) in the HDD 104 (a control pattern holder) of the controller 100b illustrated in FIG. 8.

### Automatic Pattern

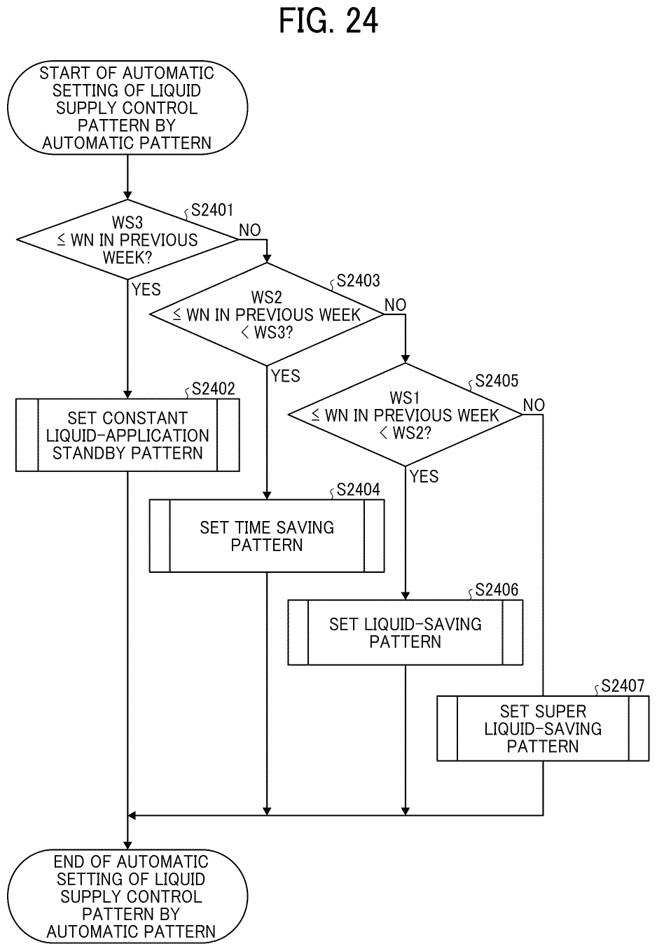

A description is given below of an example of a process of selecting and setting a liquid supply control pattern with reference to a flowchart of FIG. 24. FIG. 24 illustrates an example of an automatic setting process of a liquid supply control pattern in a case where the automatic pattern is selected.

The post-processing apparatus 3 records an operation history in the RAM 102 included in the controller 100b (see FIG. 8). Examples of the operation history recorded here include, but not limited to, information such as the number of times of execution of the crimp binding process accompanied by liquid application in units of weeks and the number of times of driving of the liquid supply pump 46. A weekly liquid use amount WN is calculated based on the operation history accumulated in the RAM 102 and is also stored in the RAM 102.

The post-processing apparatus 3 also stores, as processing information, the content of the binding process accompanied by liquid application notified from the image forming apparatus 2 in the RAM 102, which is an example of an information storage device.

In a liquid-supply-control-pattern selection program to be executed in a controller 100b of the post-processing apparatus 3, a given use level of liquid application in the post-processing apparatus 3 is determined with reference to the calculated liquid use amount WN by comparing the liquid use amount WN with, for example, later-described determination thresholds for three preset use levels.

When the automatic pattern is set, the controller 100b determines the liquid supply control pattern for the present week based on, for example, the history information on the previous week. Thus, the above-described use level determination process is executed at an appropriate timing on a weekly basis. This will be described in detail below.

First, the controller 100b reads the liquid use amount WN in the previous week from the RAM 102, and determines the use level (step S2401). The determination threshold values used for the determination of the use level are, for example, a first determination threshold value WS1, a second determination threshold value WS2, and a third determination threshold value WS3. Here, the determination threshold values are set such that the relation of “first determination threshold WS1<second determination threshold WS2<third determination threshold WS3” is satisfied.

When the liquid use amount WN in the previous week read from the RAM 102 is equal to or greater than the third determination threshold value WS3, that is, when the relation of “third determination threshold value WS3≤liquid use amount WN” is satisfied (YES in step S2401), the controller 100b determines that the use level is A, and sets the “constant liquid-application standby pattern” (step S2402).

When the liquid use amount WN in the previous week is equal to or greater than the second determination threshold value WS2 and is less than the third determination threshold value WS3, that is, when the relation of “second determination threshold value WS2≤liquid use amount WN in the previous week<third determination threshold value WS3” is satisfied (NO in step S2401 and YES in step S2403), the controller 100b determines that the use level is B, and sets the “wait-time saving pattern” (step S2404).

When the liquid use amount WN in the previous week is equal to or greater than the first determination threshold value WS1 and is less than the second determination threshold value WS2, that is, when the relation of “first determination threshold value WS1≤liquid use amount WN in the previous week<second determination threshold value WS2” is satisfied (NO in step S2403 and YES in S2405), the controller 100b determines that the use level is C, and sets the “liquid-saving pattern” (step S2406).

On the other hand, when the liquid use amount WN in the previous week is equal to or greater than zero and is less than the first determination threshold value WS1, that is, when the relation of “0≤liquid use amount WN in the previous week<first determination threshold value WS1” is satisfied (NO in step S2405), the controller 100b determines that the use level is D, and sets the “super liquid-saving pattern” (step S2407). Next, when one of the liquid supply control patterns is set, the automatic setting process ends.

The “weekly liquid use amount WN” in the above description can also be calculated using a learning model generated by machine learning. The learning model generated by the machine learning is implemented in the control program written in the CPU 101 of the controller 100b. For example, the learning model is generated by analyzing teacher data created from data obtained by evaluation in designing, using an external PC or a cloud service capable of generating a learning model. Examples of the teacher data to be analyzed by machine learning includes, but not limited to, sheet information such as a sheet size, a sheet thickness, and a sheet type, in addition to processing information such as the number of times of execution of the crimp binding process accompanied by liquid application in units of weeks as described above, the number of times of driving of the liquid supply pump 46, and the content of the binding process with liquid application notified from the image forming apparatus 2. The processing information on the content of the binding process with liquid application includes information settable by the post-processing apparatus 3, such as the type of binding such as edge binding and saddle binding, the number of sheets to be bound, and the number of bindings.

A description is given below of the liquid supply/discharge operation in each liquid supply control pattern. A description will be provided on a liquid supply/discharge mode (liquid supply/discharge operation) executed when each liquid supply control pattern is set. FIG. 25A is a table illustrating an example of the correlation between liquid supply control patterns selectable in the post-processing apparatus 3 and liquid supply/discharge modes executed according to the operation status of the post-processing apparatus 3 in liquid supply control patterns. FIG. 25B is a diagram illustrating a relation between the liquid supply control patterns, the wait time for a liquid supply operation, and the liquid consumption amount.

As illustrated in FIG. 25A, the “liquid consumption amount” and the “wait time for a liquid supply operation (wait time until the start of a crimp binding process accompanied by liquid application)” are different according to the “constant liquid-application standby pattern”, the “wait-time saving pattern”, the “liquid-saving pattern”, and the “super liquid-saving pattern.”

In each liquid supply control pattern, the relation of constant liquid-application standby pattern>wait-time saving pattern>liquid-saving pattern>super liquid-saving pattern is established for the liquid consumption amount.

On the other hand, in each liquid supply control pattern, when focusing on the wait time for a liquid supply operation (wait time until the start of a crimp binding process accompanied by liquid application), the following relation is established: super liquid-saving pattern>liquid saving pattern>wait-time saving pattern>constant liquid-application standby pattern.

A description is given below of the constant liquid-application standby pattern. A characteristic of the “constant liquid-application standby pattern” is that a wait time until liquid application becomes executable is shortest. Further, whereas in the other control patterns, the liquid level detection of the liquid in the first liquid storage tank 44 with the first liquid level sensor 43 is performed at a predetermined timing, in the present control pattern, the liquid level detection of the liquid in the first liquid storage tank 44 is performed constantly (referred to as “constant liquid level detection”). The constant liquid level detection is susceptible to liquid surface chattering.

On the other hand, even in a case where the stored liquid amount (liquid level) in the first liquid storage tank 44 decreases due to evaporation of the liquid in the first liquid storage tank 44 while the liquid application process is not executed (during standby), the liquid supply pump 46 instantaneously supplies the liquid from the second liquid storage tank 47 to the first liquid storage tank 44. Accordingly, the “constant liquid-application standby pattern” is a control pattern in which the liquid consumption amount is greatest.

When the “constant liquid-application standby pattern” is set, the controller 100b executes the filling supply operation according to the filling supply control (see FIG. 16), which has already been described above, at the activation of the post-processing apparatus 3.

At the start of the crimp binding process accompanied by liquid application, the controller 100b does not particularly perform the liquid supply operation. This is because the liquid is sufficiently stored in the first liquid storage tank 44. Specifically, the liquid level detection of the liquid in the first liquid storage tank 44 is constantly performed during activation or standby of the post-processing apparatus 3. Based on the result of the liquid level detection, the liquid supply pump 46 supplies the liquid from the second liquid storage tank 47 to the first liquid storage tank 44 (the filling supply operation and the additional supply operation).

During the crimp binding process accompanied by liquid application, the controller 100b executes the additional supply operation under the additional supply control (see FIG. 18). That is, the controller 100b performs all-time detection of the liquid level in the first liquid storage tank 44 by the first liquid level sensor 43, immediately detects a decrease in the amount of liquid stored (liquid level) in the first liquid storage tank 44, and executes supply of the liquid from the second liquid storage tank 47 into the first liquid storage tank 44 by the liquid supply pump 46.

At the end of the crimp binding process accompanied by liquid application, the controller 100b does not particularly perform the liquid supply operation. This is because, during operation of the post-processing apparatus 3, the additional supply operation is always executable, and hence the liquid supply operation is not required at the end of the crimp binding process accompanied by liquid application. Even if the next crimp binding process accompanied by liquid application is executed without interruption, it is not necessary to newly execute the selection process of the liquid supply control pattern, and the crimp binding process accompanied by the continuous liquid application can be more smoothly executed.

In addition, during standby of the post-processing apparatus 3 or during standby for binding process, which hereinafter may be simply referred to as “standby”, the controller 100b executes the additional supply operation. That is, the controller 100b performs all-time detection of the liquid level in the first liquid storage tank 44 by the first liquid level sensor 43, immediately detects a decrease in the amount of liquid stored (liquid level) in the first liquid storage tank 44 by the liquid level detection, and executes supply of the liquid from the second liquid storage tank 47 into the first liquid storage tank 44 by the liquid supply pump 46.

A description is given below of the wait-time saving pattern.

A characteristic of the “wait-time saving pattern” is that the wait time is the next shortest to the “constant liquid-application standby pattern”. Since the first liquid level sensor 43 does not constantly detect the liquid level in the first liquid storage tank 44 but detects the liquid level at a predetermined timing, the effect of liquid surface chattering is small although a slight time lag occurs. As compared with the “constant liquid-application standby pattern,” the amount of consumption of liquid can be saved in wait-time saving pattern.

At the start of the post-processing apparatus 3, the controller 100b executes the filling supply operation according to the filling supply control (see FIG. 16) already described.

At the start of the crimp binding process accompanied by liquid application, the controller 100b does not particularly perform the liquid supply control. This is because the liquid is sufficiently stored in the first liquid storage tank 44. Specifically, the liquid level detection of the liquid in the first liquid storage tank 44 is performed during activation or standby of the post-processing apparatus 3. Based on the result of the liquid level detection, the liquid supply pump 46 supplies the liquid from the second liquid storage tank 47 to the first liquid storage tank 44 (the filling supply operation and the additional supply operation).

When liquid application has been performed a predetermined number of times during execution of the crimp binding process accompanied by liquid application, the controller 100b causes the liquid supply pump 46 to supply a predetermined amount of liquid from the second liquid storage tank 47 to the first liquid storage tank 44, that is, perform a predetermined-amount supply operation. Here, the “predetermined-amount supply operation” means that a predetermined amount of liquid is supplied (replenished) from the second liquid storage tank 47 to the first liquid storage tank 44 by the liquid supply pump 46 at a stage where liquid application has been executed a predetermined number of times without stopping the post-processing apparatus 3. Thus, a predetermined amount of liquid is supplied from the second liquid storage tank 47 to the first liquid storage tank 44 by the liquid supply pump 46 without performing liquid level detection by the first liquid level sensor 43. For example, after 100 times of liquid application, 10 milliliters of liquid is supplied from the second liquid storage tank 47 to the first liquid storage tank 44 by the liquid supply pump 46 as the “predetermined-amount supply operation.”

Further, at the end of the crimp binding process accompanied by liquid application, the controller 100b executes the additional supply operation under the additional supply control (see FIG. 18). This is to additionally supply (replenish) liquid in an amount by reduced the execution of the previous crimp binding process accompanied by liquid application to the first liquid storage tank 44, in preparation for the execution of the next crimp binding process accompanied by liquid application.

During the standby, the controller 100b executes the additional supply operation by the additional supply control (see FIG. 18) after a predetermined time has elapsed. In a case where the post-processing apparatus 3 is left alone for a long time without execution of the binding process accompanied by liquid application, drying of the liquid supply member 50 and/or the liquid application member 501 may progress. As a result, the liquid supply member 50 and/or the liquid application member 501 may suck up the liquid in the first liquid storage tank 44 by capillary action, resulting in a decrease in the liquid in the first liquid storage tank 44. In order to cope with the decrease of the liquid in the first liquid storage tank 44 in such as case, the supply of the liquid from the second liquid storage tank 47 to the first liquid storage tank 44 is executed by the liquid supply pump 46 at certain intervals. As a result, the wet state of the liquid supply member 50 and/or the liquid application member 501 can be maintained to prepare for the next crimp binding process accompanied by liquid application.

A description is given below of the “liquid-saving pattern.” As a characteristic of the “liquid-saving pattern”, since the liquid supply operation is executed only at timings (at the start of the process and during the execution of the process) when the crimp binding process accompanied by liquid application is performed, the consumption amount of the liquid can be saved as compared with the “constant liquid-application standby pattern” and the “wait-time saving pattern.” On the other hand, a wait time for the execution of the liquid supply operation tends to be longer than in the “constant liquid-application standby pattern” and the “wait-time saving pattern.”

At the start of the post-processing apparatus 3, the controller 100b does not perform the liquid supply operation.

At the start of the crimp binding process accompanied by liquid application, the controller 100b executes the filling supply operation by the filling supply control (see FIG. 16) with a process start request as a trigger, and turns to a state in which the crimp binding process can be started after the filling supply operation is completed.

When liquid application has been performed a predetermined number of times during execution of the crimp binding process accompanied by liquid application, the controller 100b causes the liquid supply pump 46 to perform a predetermined-amount supply operation of liquid from the second liquid storage tank 47 to the first liquid storage tank 44. Thus, a predetermined amount of liquid is supplied (replenished) from the second liquid storage tank 47 to the first liquid storage tank 44 by the liquid supply pump 46 without stopping the post-processing apparatus 3 and without using the first liquid level sensor 43.

At the end of the crimp binding process accompanied by liquid application, the controller 100b does not particularly perform the liquid supply operation. The controller 100b does not also perform the liquid supply operation for preparing for the next crimp binding process.

Even during standby, the controller 100b does not also particularly perform any liquid supply control. The controller 100b does not also perform the liquid supply operation for preparing for the next crimp binding process accompanied by liquid application.

A description is given below of the “super liquid-saving pattern.” As a characteristic of the “super liquid-saving pattern”, since the liquid supply operation is executed only at timings (when the start of the process and during the execution of the process) when the crimp binding process accompanied by liquid application is performed, the wait time in the execution of the liquid supply operation tends to be longer as compared with the “constant liquid-application standby pattern”, the “wait-time saving pattern”, and the “liquid-saving pattern.” In addition, in the comparison with the “liquid-saving pattern,” the already-described liquid discharge operation is executed each time the crimp binding process accompanied by liquid application ends, and hence the supply (supply) of the liquid from the second liquid storage tank 47 to the first liquid storage tank 44 by the liquid supply pump 46 is started each time from the state where the first liquid storage tank 44 as a sub tank is empty. Accordingly, it takes more wait time than the wait time for the “liquid-saving pattern” by the amount of time until the liquid in the first liquid storage tank 44 reaches the liquid storage amount at which liquid application is executable (the time from the state of FIG. 15A to the state of FIG. 15C). The liquid supply operation is executed only at necessary timing, and the liquid discharge operation is executed each time the crimp binding process accompanied by liquid application ends, so that the consumption amount of liquid is minimized among the liquid supply/discharge modes.

At the start of the post-processing apparatus 3, the controller 100b does not perform the liquid supply operation.

At the start of the crimp binding process accompanied by liquid application, the controller 100b executes the filling supply operation by the filling supply control (see FIG. 16) with a process start request including the crimp binding process as a trigger, and turns to a state in which the crimp binding process can be started after the filling supply operation is completed. Although basically similar to the liquid-saving pattern, the filling supply operation is executed from the state where the first liquid storage tank 44 as a sub tank is empty (see FIG. 15A), a time until the crimp binding process accompanied by liquid application can be started is substantially longer than in the liquid-saving pattern.

During execution of the crimp binding process accompanied by liquid application, the controller 100b executes the liquid application a predetermined number of times, stops the liquid applier 31, and executes the additional supply operation after the state of the liquid in the first liquid storage tank 44 is stable. Since the additional supply operation is performed in a state where the liquid in the first liquid storage tank 44 is stable, only the required liquid amount (the liquid amount until the liquid level reaches the reference liquid level) can be properly supplied, and the consumption amount of the liquid in the first liquid storage tank 44 can be saved.

Furthermore, at the end of the crimp binding process accompanied by liquid application, the controller 100b executes the liquid discharge operation under the liquid discharge control (see FIG. 21). Therefore, liquid is fed from the first liquid storage tank 44 to the second liquid storage tank 47 by the liquid supply pump 46. Thus, the consumption of the liquid in the first liquid storage tank 44 due to drying and evaporation can be reduced.

In addition, during standby, the controller 100b does not perform the liquid supply operation.

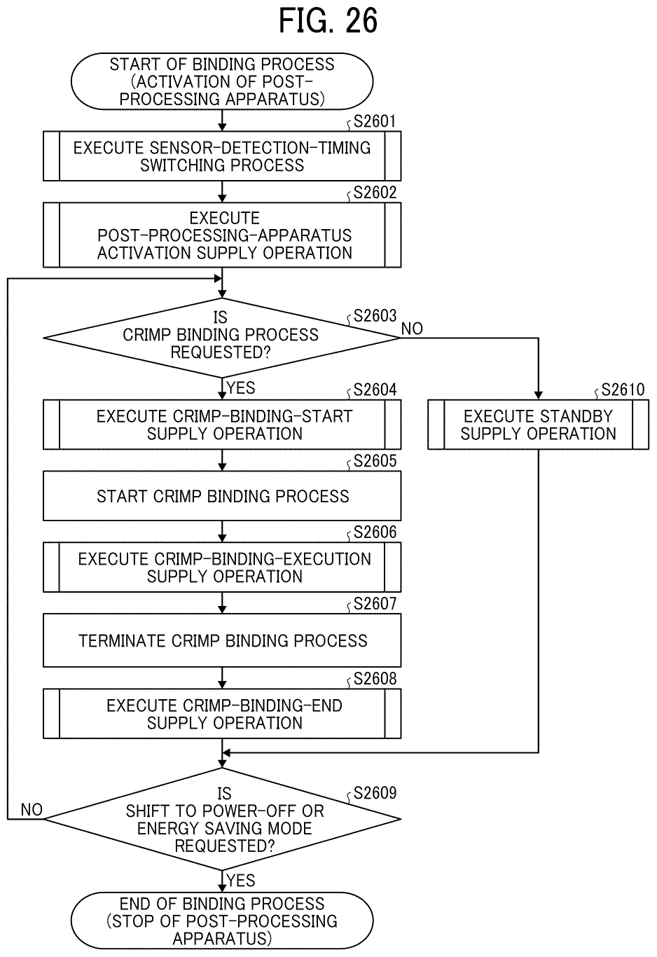

The difference in the liquid supply/discharge operation according to the setting of the liquid supply control pattern described above occurs as appropriate in relation to processing from the activation to the stop of the post-processing apparatus 3. A description is given below of an overall view of an operation process from activation to stop of the post-processing apparatus 3 with reference to the flowchart of FIG. 26. When each control processing included in the following operation process is described in detail, it will be described as appropriate that different liquid supply/discharge operations (the operations of the “liquid supply/discharge modes” described in FIG. 14) are executed based on differences in the liquid supply control pattern. The “crimp binding process” described in FIGS. 26 to 33 is a crimp binding process accompanied by liquid application.

A description is given of an outline of a binding operation process of the post-processing apparatus 3.

FIG. 26 is a flowchart of a control process of a binding operation of the post-processing apparatus 3. As illustrated in FIG. 26, first, after the post-processing apparatus 3 is activated, that is, when the control process of the binding operation of the post-processing apparatus 3 is started, the controller 100b executes a “sensor-detection-timing switching process” to switch the detection timing of the first liquid level sensor 43 (step S2601). Details of the sensor-detection-timing switching process will be described later.

After the sensor-detection-timing switching process is completed, the controller 100b causes the liquid supply pump 46 to execute a “post-processing-apparatus activation supply operation” (step S2602). Details of the “post-processing-apparatus activation supply operation” will be described later.

After the liquid supply operation at the activation (start-up) of the post-processing apparatus 3 ends, the controller 100b determines whether the processing information notified from the image forming apparatus 2 includes a crimp binding process accompanied by liquid application (step S2603). When an instruction for the crimp binding process accompanied by liquid application (a crimp binding process request) is included (YES in step S2603), the controller 100b causes the liquid supply pump 46 to execute the “crimp-binding-start supply operation” (step S2604). Details of the “crimp-binding-start supply operation” will be described later.

After the end of the crimp-binding-start supply operation by the liquid applier 31, the controller 100b causes the crimper 32 to start the crimp binding process (step S2605). During execution of the crimp binding process, the controller 100b causes the liquid supply pump 46 to perform the “crimp-binding-execution supply operation” (step S2606). Details of the “crimp-binding-execution supply operation” will be described later.

When the crimp binding process by the crimper 32 ends (step S2607), the controller 100b causes the liquid supply pump 46 to subsequently execute the “crimp-binding-end supply operation” (step S2608). Details of the “crimp-binding-end supply operation” will be described later.

After the crimp-binding-end supply operation by the liquid supply pump 46 ends, the controller 100b determines whether there is a request for shifting to power-off or the energy saving mode from the image forming apparatus 2 (step S2609). When the controller 100 b shifts to power-off or the energy saving mode, that is, when there is a request for shifting to power-off or the energy saving mode from the image forming apparatus 2 (YES in step S2609), the controller 100b stops the post-processing apparatus 3, that is, ends the control process of the binding operation of the post-processing apparatus 3. On the other hand, when the controller 100b does not shift to power-off or the energy saving mode (NO in step S2609), the controller 100b repeats the processing of steps S2603 to S2610.

In a case where an instruction for the crimp binding process accompanied by liquid application (the crimp binding process request) is not included in step S2603 (NO in step S2603), the controller 100b causes the liquid supply pump 46 to execute the “standby supply operation” (step S2610). Details of the “standby supply operation” will be described later.

After the standby supply operation by the liquid supply pump 46 ends, the controller 100b determines whether there is a request for shifting to power-off or the energy saving mode from the image forming apparatus 2 (step S2609). When the controller 100 b shifts to power-off or the energy saving mode, that is, when there is a request for shifting to power-off or the energy saving mode from the image forming apparatus 2 (YES in step S2609), the controller 100b stops the post-processing apparatus 3, that is, ends the control process of the binding operation of the post-processing apparatus 3. On the other hand, when the controller 100b does not shift to power-off or the energy saving mode (NO in step S2609), the controller 100b repeats the processing of steps S2603 to S2610.

A description is given below of the sensor-detection-timing switching process.

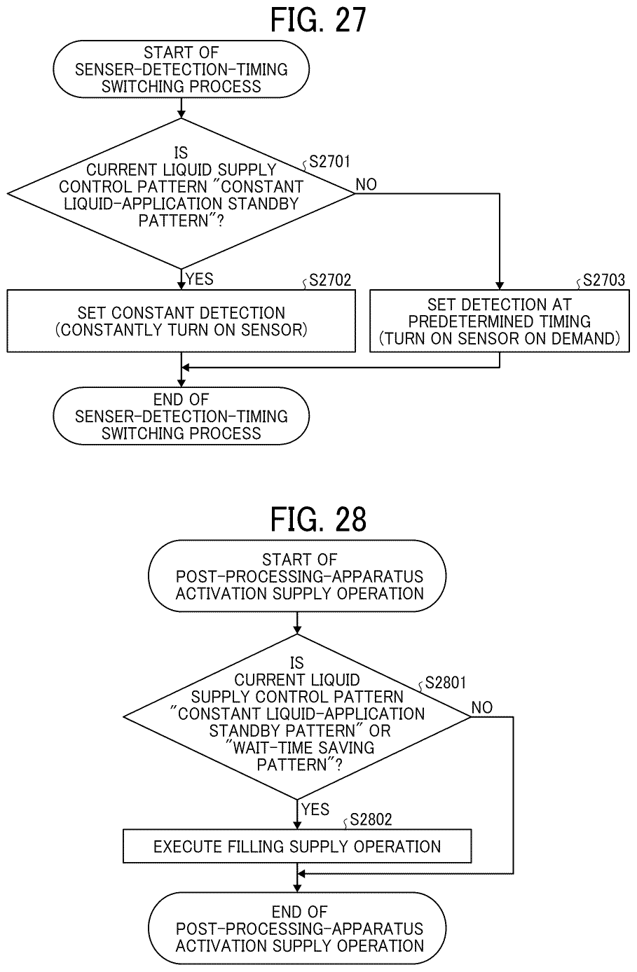

FIG. 27 is a flowchart of the sensor-detection-timing switching process. The controller 100b changes the timing of detection by the first liquid level sensor 43 according to the currently set liquid supply control pattern (step S2701). The settings of detection timing include two patterns of “constant detection” and “detection at predetermined timing.” The “constant detection” is a setting in which the first liquid level sensor 43 is constantly maintained in an ON state. The “detection at predetermined timing” is a setting in which the controller 100b turns on the first liquid level sensor 43 at predetermined timing.

The controller 100b determines whether the currently set liquid supply control pattern is the “constant liquid-application standby pattern” (step S2701). When the current liquid supply control pattern is the “constant liquid-application standby pattern” (YES in step S2701), the controller 100b sets the detection timing of the first liquid level sensor 43 to “constant detection” (step S2702).

On the other hand, when the current liquid supply control pattern is not the “constant liquid-application standby pattern”, that is, when the liquid supply control pattern currently set is one of the “wait-time saving pattern”, the “liquid-saving pattern”, and the “super liquid-saving pattern” (NO in step S2701), the controller 100b sets the detection timing of the first liquid level sensor 43 to “detection at predetermined timing” (step S2703).

A description is given below of the post-processing-apparatus activation supply operation. FIG. 28 is a control flowchart of the post-processing-apparatus activation supply operation which is a supply operation performed in the activation of the post-processing-apparatus 3. The controller 100b switches the types of liquid supply/discharge operations (the operations of the “liquid supply/discharge modes” described in FIG. 14) according to the liquid supply control pattern currently set (step S2801).

When the control process of the post-processing-apparatus activation supply operation is started, the controller 100b determines whether the currently-set liquid supply control pattern is the “constant liquid-application standby pattern” or the “wait-time saving pattern” (step S2801). When the current liquid supply control pattern is the “constant liquid-application standby pattern” or the “wait-time saving pattern” (YES in step S2801), the controller 100b causes the liquid supply pump 46 to execute the filling supply operation by the filling supply control (see FIG. 16) (step S2802), and ends the control process of the post-processing-apparatus activation supply operation.

On the other hand, when the currently-set liquid supply control pattern is not the “constant liquid-application standby pattern” or the “wait-time saving pattern”, that is, when the currently-set liquid supply control pattern is the “liquid-saving pattern” or the “super liquid-saving pattern” (NO in step S2801), the controller 100b does not perform any operation and ends the control process of the post-processing-apparatus activation supply operation.

A description is given below of the crimp-binding-start supply operation.

FIG. 29 is a control flowchart of the crimp-binding-start supply operation which is a supply operation performed at the start of a crimp binding process. The controller 100b switches the types of liquid supply/discharge operations according to the currently-set liquid supply control pattern (step S2901).

When the control process of the crimp-binding-start supply operation is started, the controller 100b determines whether the currently-set liquid supply control pattern is the “constant liquid-application standby pattern” or the “wait-time saving pattern” (step S2901). When the current liquid supply control pattern is the “liquid supply control pattern” or the “wait-time saving pattern” (YES in step S2901), the controller 100b does not perform anything and ends the control process of the crimp-binding-start supply operation. This is because the liquid supply operations (the filling supply operation and the additional supply operation) by the liquid supply pump 46 are performed at the time of activation of the post-processing apparatus 3 or during standby, and it is conceivable that a sufficient amount of liquid for liquid application is stored in the first liquid storage tank 44.

On the other hand, when the liquid supply control pattern currently set is not the “constant liquid-application standby pattern” or the “wait-time saving pattern”, that is, when the liquid supply control pattern currently set is the “liquid-saving pattern” or the “super liquid-saving pattern” (NO in step S2901), the controller 100b causes the liquid supply pump 46 to execute the filling supply operation by the filling supply control (see FIG. 16) (step S2902), and ends the control process of the crimp-binding-start supply operation.

A description is given below of the crimp-binding-execution supply operation.

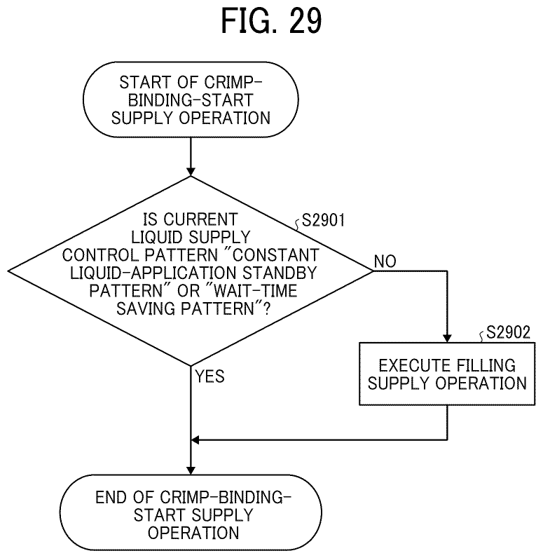

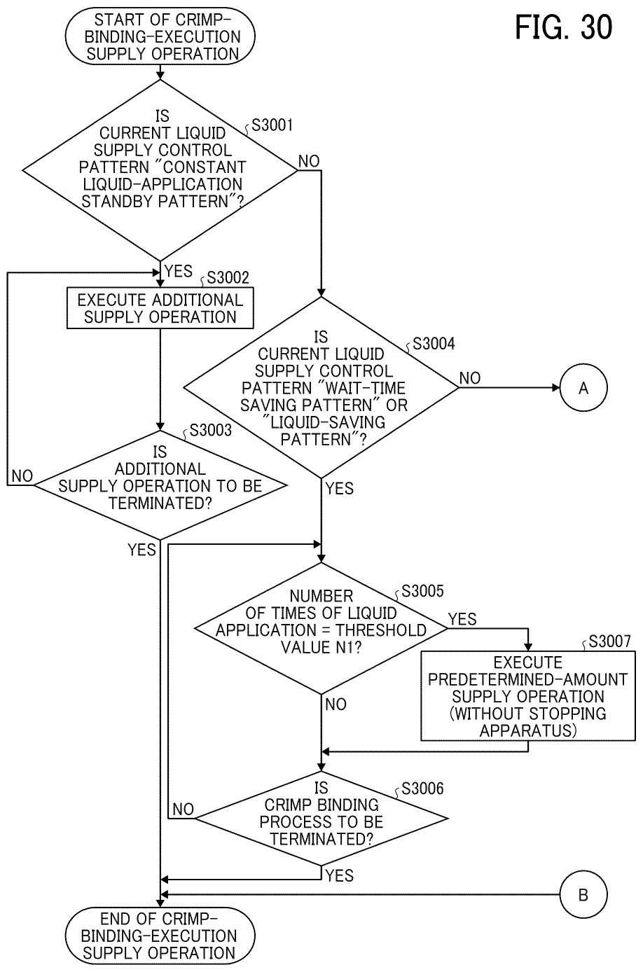

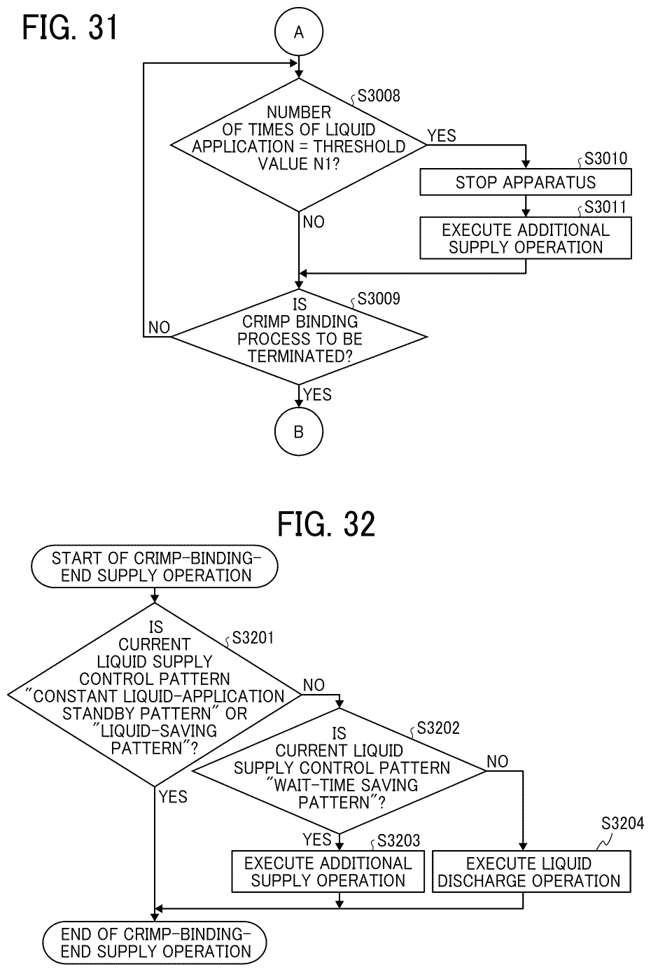

FIGS. 30 and 31 are flowcharts of the crimp-binding-execution supply operation which is a supply operation executed during execution of a crimp binding process. The controller 100b switches the types of liquid supply/discharge operations according to the currently-set liquid supply control pattern (step S3001).

When the control process of the crimp-binding-execution supply operation is started, the controller 100b determines whether the currently-set liquid supply control pattern is the “constant liquid-application standby pattern” (step S3001). When the current liquid supply control pattern is the “constant liquid-application standby pattern” (YES in step S3001), the controller 100b causes the liquid supply pump 46 to execute the additional supply operation by the additional supply control (see FIG. 18) (step S3002). Then, the controller 100b determines whether to end the crimp binding process by the crimper 32 (step S3003). When the crimp binding process by the crimper 32 is to be ended (YES in step S3003), the controller 100b ends the control process of the crimp-binding-execution supply operation. On the other hand, when the crimp binding process by the crimper 32 is not to be ended (NO in step S3003), the controller 100b repeats the processing of steps S3003 to S3003 until the crimp binding process by the crimper 32 ends (YES in step S3002). When the crimp binding process by the crimper 32 is to be ended (YES in step S3003), the controller 100b ends the control process of the crimp-binding-execution supply operation.

On the other hand, when the currently-set liquid supply control pattern is not the “constant liquid-application standby pattern” (NO in step S3001), the controller 100b determines whether the currently-set liquid supply control pattern is the “wait-time saving pattern” or the “liquid-saving pattern” (step S3004). When the current liquid supply control pattern is the “wait-time saving pattern” or the “liquid-saving pattern” (YES in step S3004), the controller 100b determines whether the number of times of liquid application by the liquid applier 31 executed during the crimp binding process by the crimper 32 has reached a predetermined number of times (threshold value N1) (step S3005). When the number of times of liquid application by the liquid applier 31 has not reached the predetermined number of times (threshold value N1) (NO in step S3005), the controller 100b determines whether to end the crimp binding process by the crimper 32 (step S3006). On the other hand, when the number of times of liquid application by the liquid applier 31 has reached the predetermined number of times (threshold value N1) (YES in step S3005), the controller 100b does not stop the operation of the post-processing apparatus 3 (does not stop the machine) and performs the predetermined-amount supply operation by the liquid supply pump 46 (step S3007), and then determines whether to end the crimp binding process by the crimper 32 (step S3006).

When the crimp binding process by the crimper 32 is to be ended (YES in step S3006), the controller 100b ends the control process of the crimp-binding-execution supply operation. On the other hand, when the crimp binding process by the crimper 32 is not to be ended (NO in step S3006), the controller 100b repeats the processing of steps S3006 to S3007 until the crimp binding process by the crimper 32 ends (YES in step S3005).

On the other hand, when the current liquid supply control pattern is not the “wait-time saving pattern” or the “liquid-saving pattern” (NO in step S3004), the controller 100b determines that the current liquid supply control pattern is the “super liquid-saving pattern.” In this case, as illustrated in FIG. 31, the controller 100b determines whether the number of times of liquid application by the liquid applier 31 (the number of times of liquid application), which has been executed during the crimp binding process by the crimper 32, has reached a predetermined number of times (threshold value N1) (step S3008). When the number of times of liquid application by the liquid applier 31 has not reached the predetermined number of times (threshold value N1) (NO in step S3008), the controller 100b determines whether to end the crimp binding process by the crimper 32 (step S3009). On the other hand, when the number of times of liquid application has reached the predetermined number of times (threshold value N1) (YES in step S3008), the controller 100b stops the operation of the post-processing apparatus 3 (stops the machine) (step S3010) and causes the liquid supply pump 46 to execute the additional supply operation by the additional supply control (see FIG. 18) (step S3011). Then, the controller 100b determines whether to end the crimp binding process by the crimper 32 (step S3009).

When the crimp binding process by the crimper 32 is to be ended (YES in step S3009), the controller 100b ends the control process of the supply operation during the crimp binding process. On the other hand, when the crimp binding process by the crimper 32 is not completed (NO in step S3009), the controller 100b repeats the processing of steps S3009 to S3011 until the crimp binding process by the crimper 32 is ended (YES in step S3009).

A description is given below of the crimp-binding-end supply operation. FIG. 32 is a flowchart of a control process of the crimp-binding-end supply operation which is a supply operation performed at the end of a crimp binding process. The controller 100b switches the types of the liquid supply/discharge operations according to the currently-set liquid supply control pattern (step S3201).

When the control process of the crimp-binding-end supply operation is started, the controller 100b determines whether the currently-set liquid supply control pattern is the “constant liquid-application standby pattern” or the “liquid-saving pattern” (step S3201). When the current liquid supply control pattern is the “constant liquid-application standby pattern” or the “liquid-saving pattern” (YES in step S3201), the controller 100b ends the control process of the crimp-binding-end supply operation without performing the liquid supply operation by the liquid supply pump 46 in particular.

On the other hand, when the currently-set liquid supply control pattern is not the “constant liquid-application standby pattern” or the “liquid-saving pattern” (NO in step S3201), the controller 100b determines whether the currently-set liquid supply control pattern is the “wait-time saving pattern” (step S3202). When the current liquid supply control pattern is the “wait-time saving pattern” (YES in step S3202), the controller 100b causes the liquid supply pump 46 to execute the additional supply operation by the additional supply control (step S3203). After the additional supply operation by the liquid applier 31 ends, the controller 100b terminates the control process of the crimp-binding-end supply operation.

On the other hand, when the currently-set liquid supply control pattern is not the “wait-time saving pattern” (NO in step S3202), the controller 100b determines that the current liquid supply control pattern is the “super liquid-saving mode”. In this case, the controller 100b causes the liquid supply pump 46 to execute a liquid discharge operation according to the liquid discharge control (see FIG. 21) (step S3204). After the liquid discharge operation by the liquid supply pump 46 ends, the controller 100b ends the control process of the crimp-binding-end supply operation.

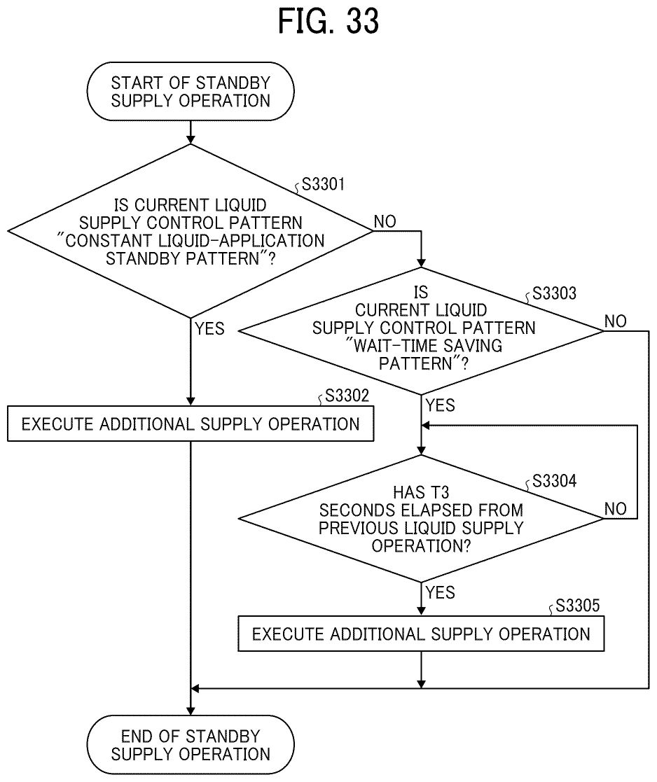

A description is given below of the standby supply operation. FIG. 33 is a flowchart of a control process of the standby-time supply operation which is a supply operation performed during standby. The controller 100b switches the types of the liquid supply/discharge operations according to the currently-set liquid supply control pattern (step S3301).

When the control process of the standby supply operation is started, the controller 100b determines whether the currently-set liquid supply control pattern is the “constant liquid-application standby pattern” (step S3301). When the current liquid supply control pattern is the “constant liquid-application standby pattern” (YES in step S3301), the controller 100b execute the additional supply operation by the additional supply control (step S3302), and ends the standby supply operation.

On the other hand, when the currently-set liquid supply control pattern is not the “constant liquid-application standby pattern” (NO in step S3301), the controller 100b determines whether the currently-set liquid supply control pattern is the “wait-time saving pattern” (step S3303). When the current liquid supply control pattern is the “wait-time saving pattern” (YES in step S3303), the controller 100b determines whether an elapsed time from a time point when the previous liquid supply operation for the liquid applier 31 ends has reached a third predetermined time (T3 [sec]) as an elapsed determination time (step S3304). When the elapsed time has not reached the third predetermined time T3 (NO in step S3304), the controller 100b repeats the processing of step S3304 until the elapsed time reaches the third predetermined time T3 (NO in step S3304). On the other hand, when the elapsed time has reached the third predetermined time T3 (YES in step S3304), the controller 100b causes the liquid supply pump 46 to execute the additional supply operation by the additional supply control (step S3305), and ends the control process of the standby supply operation.

That is, when the “wait-time saving pattern” is selected, the interval of execution of the liquid supply/discharge operation according to the liquid supply/discharge mode is controlled to be a predetermined time interval.

On the other hand, when the current liquid supply control pattern is not the “wait-time saving pattern”, that is, when the currently-set liquid supply control pattern is the “liquid-saving pattern” or the “super liquid-saving pattern” (NO in step S3303), the controller 100b does not perform any operation and ends the control process of the standby supply operation.

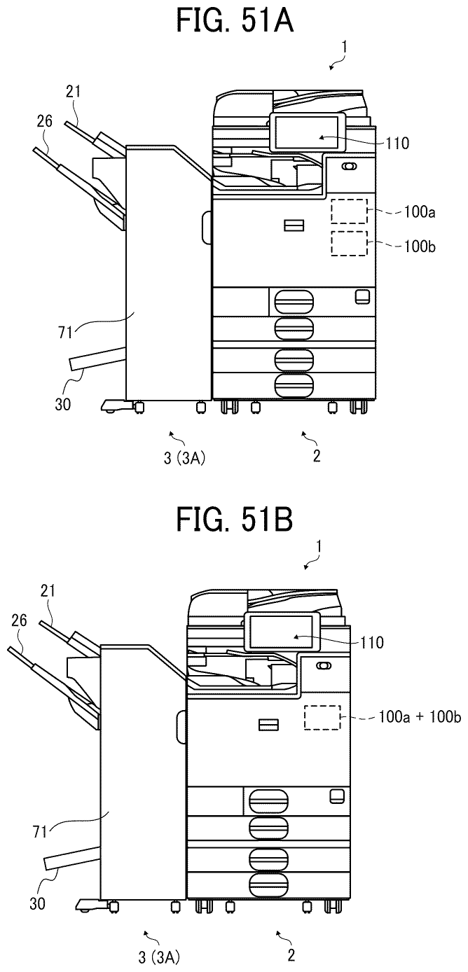

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 51A, the controller 100b of the post-processing apparatus 3 may be disposed in the image forming apparatus 2. Further, as illustrated in FIG. 51B, the controller 100b of the post-processing apparatus 3 may be integrated with the controller 100a of the image forming apparatus 2.

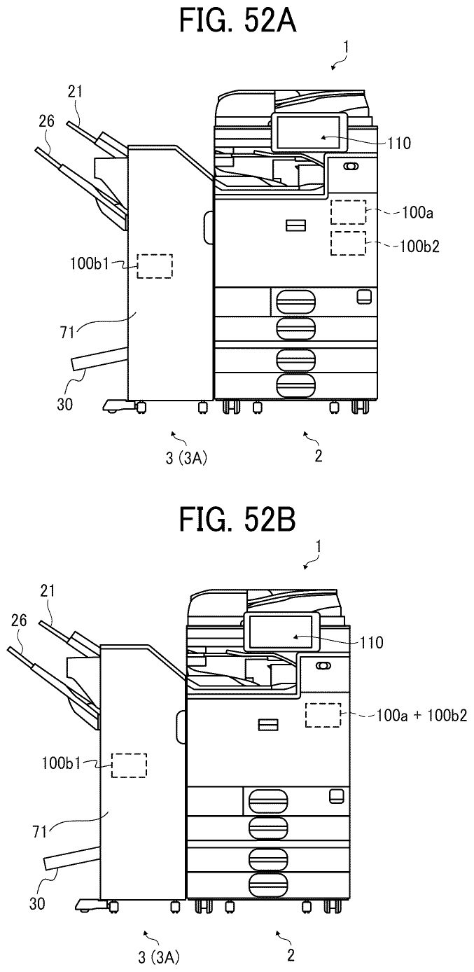

As illustrated in FIG. 52A, the controller 100b of the post-processing apparatus 3 may be divided into a controller 100b1 (e.g., a drive unit such as a motor) and a controller 100b2 (a detector such as a sensor) according to the function, and the controller 100b2 of the post-processing apparatus 3 may be disposed in the image forming apparatus 2. Further, as illustrated in FIG. 52B, the controller 100b2 of the post-processing apparatus 3 disposed in the image forming apparatus 2 may be integrated with the controller 100a of the image forming apparatus 2.

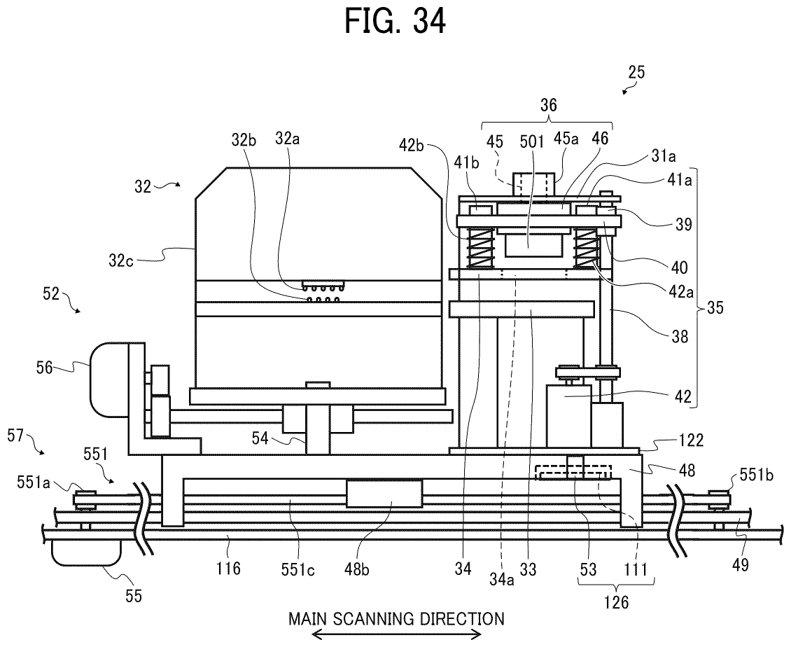

A description is given below of another embodiment of the edge binder 25. FIG. 34 is an overall view of another embodiment of the edge binder 25 illustrated in FIG. 3. As illustrated in FIG. 34, the crimper 32 includes a crimper pivot assembly 52. The crimper pivot assembly 52 rotates the crimper 32, which includes upper crimping teeth 32a and lower crimping teeth 32b, in the forward and reverse directions about the crimper shaft 54 extending in the thickness direction of the sheet P or sheet bundle Pb placed on the internal tray 22. The crimper pivot assembly 52 includes the crimper shaft 54 and the crimper pivot motor 56. Further, the liquid applier 31 is made rotatable in the forward and reverse directions about a liquid applier shaft 53 extending in the thickness direction of the sheet P or the sheet bundle Pb placed on the internal tray 22. A posture changing lever 111, which is a component of a liquid applier pivot assembly 126 to be described below, is integrally attached to the liquid applier shaft 53.

In other words, the liquid applier shaft 53 and the crimper shaft 54 extend parallel to each other at positions apart from each other in the main scanning direction. The liquid applier shaft 53 rotatably supports the liquid application frame 31a and the liquid application base 122 in forward and reverse directions with respect to the base 48. The crimper shaft 54 rotatably supports the crimping frame 32c in forward and reverse directions with respect to the base 48.

The crimper pivot motor 56 generates a driving force to rotate the crimper 32 in the forward and reverse directions. The driving force of the crimper pivot motor 56 is transmitted to the crimper shaft 54 via a pulley and a timing belt. As a result, the crimping frame 32c is pivoted about the crimper shaft 54 in the forward and reverse directions together with the upper crimping teeth 32a and the lower crimping teeth 32b.

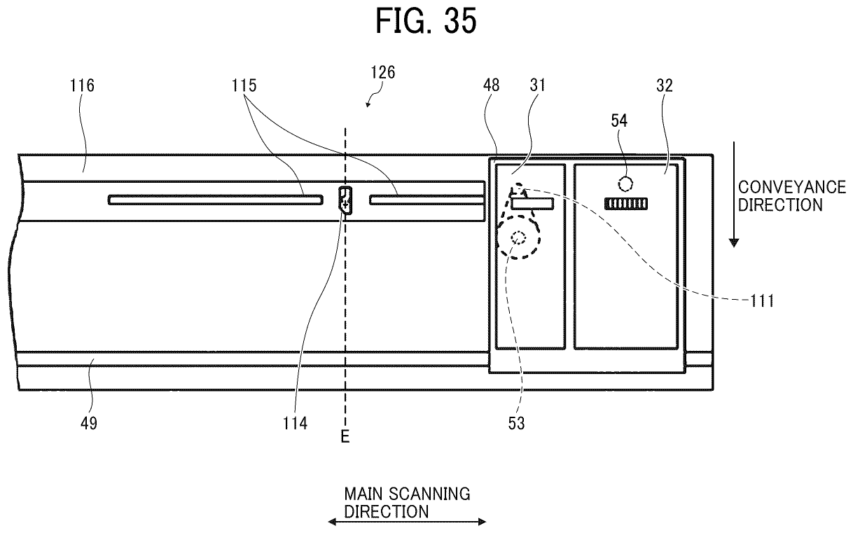

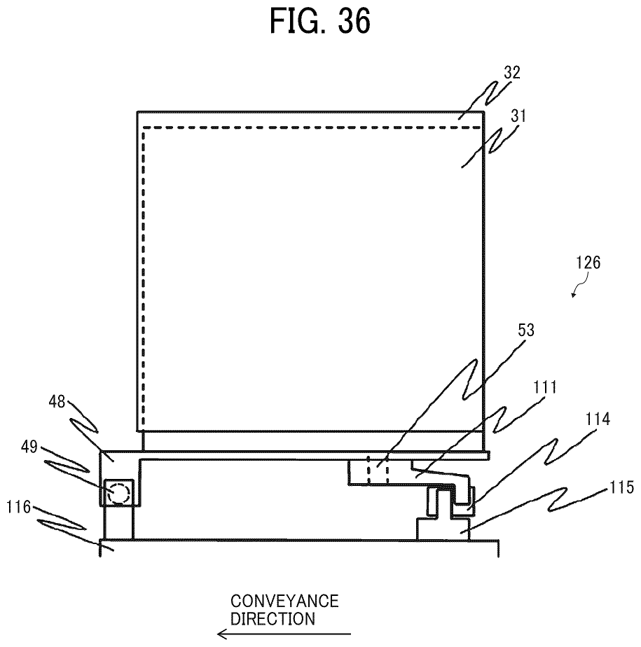

FIGS. 35 and 36 are diagrams illustrating a liquid applier pivot assembly 126 that rotates the above-described liquid applier 31 in the forward and reverse directions. The liquid applier pivot assembly 126 includes, for example, the liquid applier shaft 53 and a posture changing lever 111 that is rotatable with the liquid applier shaft 53 as a single unit. The crimper 32 and the liquid applier 31 are supported by the base 48. This base 48 is driven by the edge binder movement motor 55 to move in the main scanning direction on the binding assembly base 116 along the guide shaft 49. The binding assembly base 116 includes a posture changing member 114 and a guide rail 115. The posture changing member 114 is rotatably attached to the binding assembly base 116 at an application posture changing position E in the main scanning direction. As the liquid applier 31 is driven by the edge binder movement motor 55 and moves in the main scanning direction via the base 48, the posture changing lever 111 is rotated.

The posture changing lever 111, the posture changing member 114, and the guide rail 115 are included in a liquid applier pivot assembly 126 that changes the posture of the liquid applier 31 along with the movement of the liquid applier 31 in the main scanning direction. The posture changing lever 111 is an example of a posture changing member that rotates with the liquid applier 31 as a single unit. The posture changing member 114 and the guide rail 115 are an example of a posture changing member that contacts the posture changing lever 111 and changes the posture of the posture changing lever 111 when the liquid applier 31 moves in the main scanning direction.

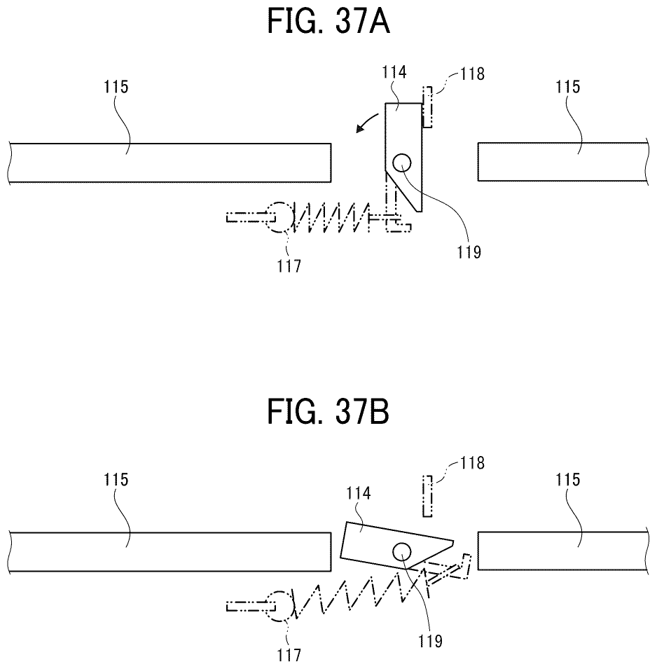

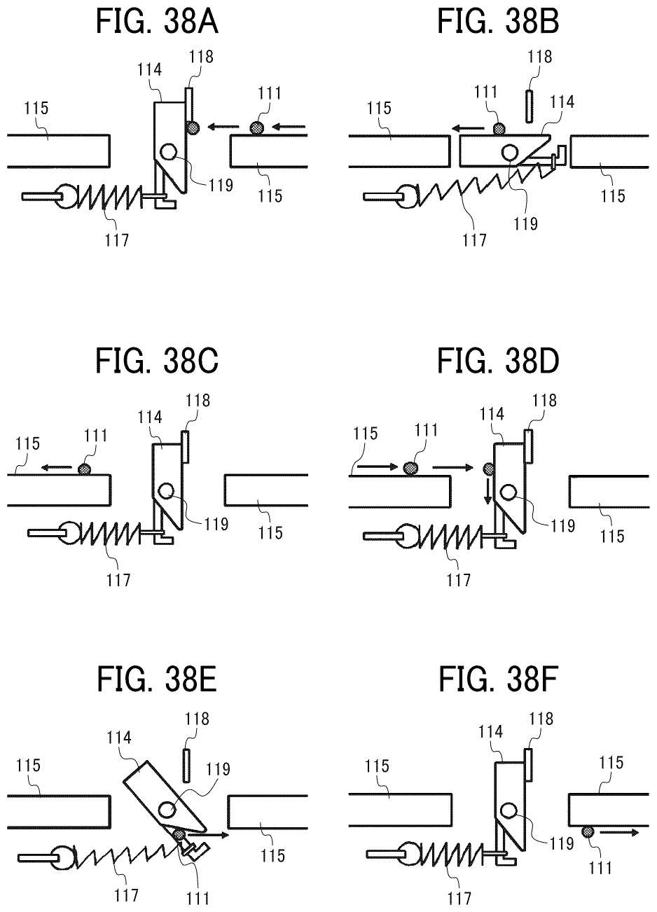

FIGS. 37A and 37B are diagrams each illustrating the configuration of the posture changing member 114 disposed on the binding assembly base 116. FIGS. 38A, 38B, 38C, 38D, 38E, and 38F are diagrams illustrating a series of operations of the posture changing lever 111 by the posture changing member 114.

The posture changing member 114 is rotatably held by a posture changing member shaft 119 disposed on the binding assembly base 116. On the other hand, the posture changing member 114 has one end that is attached to the binding assembly base 116 and the other hand that is biased in one direction (the clockwise direction of the posture changing member shaft 119 in FIGS. 37A and 37B) by a biasing spring 117 that is attached to the posture changing member 114. A posture changing member stopper 118 is disposed on the binding assembly base 116. As illustrated in FIG. 37A, the posture changing member 114 is restricted to rotate in the clockwise direction and is allowed to rotate in the counterclockwise direction (i.e., a direction indicated by arrow A in FIG. 37A).

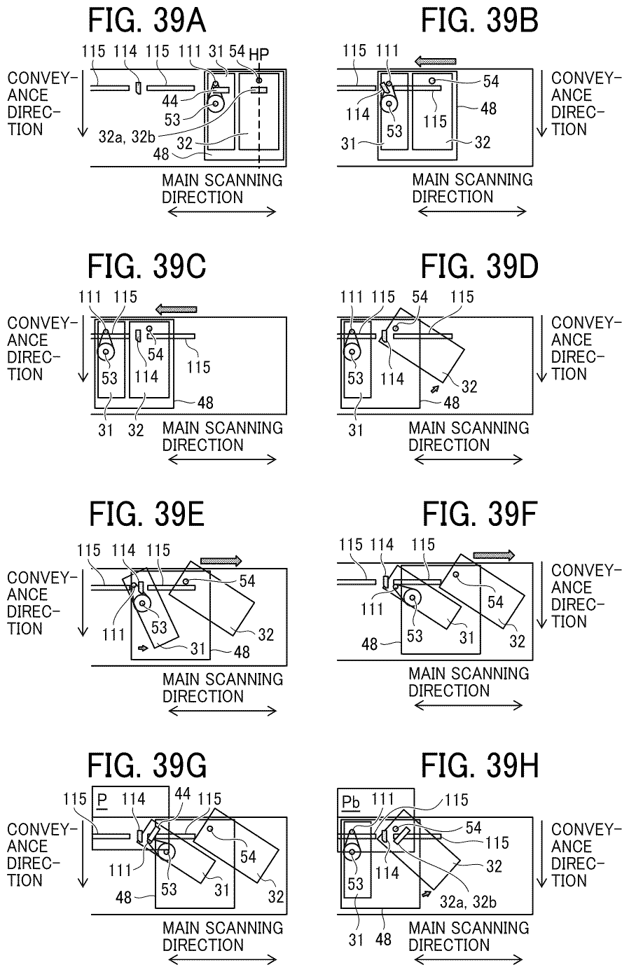

The liquid applier 31 can be changed or pivoted by the liquid applier pivot assembly 126 between a “parallel application posture” illustrated in FIGS. 39A, 39B, 39C, 39D, and 39H and an “inclined application posture” illustrated in FIGS. 39E, 39F, and 39G. The “parallel application posture” is a posture of the liquid applier 31 when the lateral direction of the liquid applier 31 (the longitudinal direction of the liquid application member 501) is in the main scanning direction. The “inclined application posture” is a posture of the liquid applier 31 when the lateral direction of the liquid applier 31 is inclined to the main scanning direction.

The crimper 32 can be changed or pivoted by the crimper pivot assembly 52 between a “parallel binding posture” illustrated in FIGS. 39A, 39B, and 39C and an “inclined binding posture” illustrated in FIGS. 39D, 39E, 39F, 39G, and 39H. The “parallel binding posture” is a posture of the crimper 32 when the lateral direction of the crimper 32 (the longitudinal direction of the upper crimping teeth 32a and the lower crimping teeth 32b) is in the main scanning direction. The “inclined binding posture” is a posture of the crimper 32 when the lateral direction of the crimper 32 is inclined to the main scanning direction.

The liquid application position of the liquid applier 31 in the parallel application posture and the binding position of the crimper 32 in the parallel binding posture have the longitudinal directions facing the same direction. Similarly, the liquid application position of the liquid applier 31 in the inclined application posture and the binding position of the crimper 32 in the inclined binding posture have the longitudinal directions facing the same direction. In other words, the liquid applier 31 and the crimper 32 rotate between the two postures by the same angle of rotation. The liquid application position of the liquid applier 31 in the parallel application posture and the binding position of the crimper 32 in the parallel binding posture are overlaid on one after another. Similarly, the liquid application position of the liquid applier 31 in the inclined application posture and the binding position of the crimper 32 in the inclined binding posture are overlaid on one after another.

FIGS. 39A, 39B, 39C, 39D, 39E, 39F, 39G, and 39H are diagrams illustrating the operation procedure for changing the crimper 32 and the liquid applier 31 to the “inclined binding posture” and “inclined application posture,” respectively.

As illustrated in FIG. 39A, the crimper 32 and the liquid applier 31 are located at the standby position HP outside the sheet width area. The posture changing lever 111 is disposed above the guide rail 115. Then, as illustrated in FIG. 39B, the crimper 32 and the liquid applier 31 are moved in the left side direction (the direction in the arrow illustrated in FIG. 39B) while pushing and opening the posture changing member 114.

When the liquid applier 31 is changed to the inclined application posture, the edge binder movement motor 55 is driven to move the base 48 holding the crimper 32 and the liquid applier 31 to the left side direction. Since the rotation of the posture changing member 114 in the counterclockwise direction is not restricted, the posture changing lever 111 is pushed to climb over the posture changing member 114 (see FIGS. 38A and 38B).

Then, as illustrated in FIG. 39C, after the posture changing lever 111 has passed over the posture changing member 114, the driving of the edge binder movement motor 55 is stopped to temporarily stop the movement of the base 48 to the left side in the main scanning direction. At this time, the posture changing member 114 is biased by the biasing spring 117 and returns to the rotation restricting posture (see FIG. 38C).

Then, as illustrated in FIG. 39D, the crimper pivot motor 56 generates a driving force to rotate the crimper 32 in the forward and reverse directions. The driving force of the crimper pivot motor 56 is transmitted to the crimper shaft 54 via a pulley and a timing belt. As a result, the crimping frame 32c is pivoted about the crimper shaft 54 in the forward and reverse directions together with the upper crimping teeth 32a and the lower crimping teeth 32b. As a result, the crimper 32 changes the posture to the inclined binding posture.

Then, as illustrated in FIG. 39E, the base 48 holding the crimper 32 and the liquid applier 31 is moved to the right side (the direction indicated by arrow in FIG. 39E) in the main scanning direction. Even if the posture changing lever 111 contacts the posture changing member 114, the posture changing member 114 is restricted not to rotate in the clockwise direction. Due to such a configuration, even if the base 48 is moved to the right-side direction, the posture changing lever 111 is not allowed to move in the right side and starts to rotate to the inclined posture (see FIGS. 38D and 38E).

Then, as illustrated in FIG. 39F, the base 48 holding the crimper 32 and the liquid applier 31 is moved to the right side in the main scanning direction. The posture changing lever 111 is moved, while rotating, toward the lower side of the guide rail 115. The posture changing lever 111 is moved toward the lower side of the guide rail 115 (lower than the posture changing member shaft 119 of the posture changing lever 111) and is moved in the main scanning direction. As a result, the posture changing member 114 is rotated in the counterclockwise direction against the biasing force of the biasing spring 117. Further, as the base 48 is moved in the right side, the posture changing lever 111 is moved to the right side while the posture changing lever 111 climbs over the posture changing member 114 (see FIGS. 38E and 38F). As a result, the rotation of the liquid applier 31 to the inclined application posture completes.

In other words, when the posture changing lever 111 passes the posture changing member 114 from one end (on the left side) to the other end (on the right side) in the main scanning direction, the liquid applier 31 is rotated from the parallel application posture to the inclined application posture. Further, when the liquid applier 31 is rotated from the parallel application posture to the inclined application posture, the crimper 32 is rotated to the inclined binding posture in advance, and then the liquid applier 31 is rotated to the inclined application posture.

Then, as illustrated in FIG. 39G, the base 48 holding the crimper 32 and the liquid applier 31 is moved to the right side. When the liquid applier 31 in the inclined application posture is moved to the liquid application position, the liquid application member 501 is brought into contact with and separated from the sheet P to execute liquid application.

Then, as illustrated in FIG. 39H, after the placement of the sheet bundle Pb including a given number of multiple sheets P is completed, the base 48 holding the crimper 32 and the liquid applier 31 is moved to the left side. After the crimper 32 in the inclined binding posture is moved to the binding position, the upper crimping teeth 32a and the lower crimping teeth 32b are brought into contact with and separated from the sheet bundle Pb to execute the crimp binding.

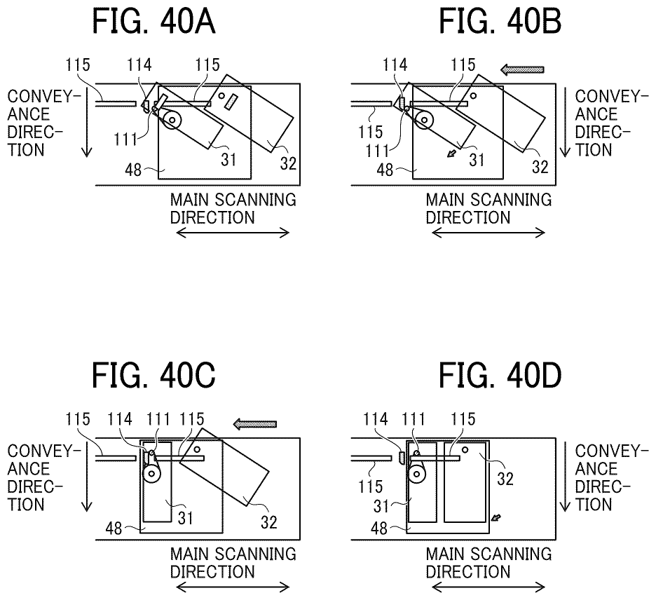

FIGS. 40A, 40B, 40C, and 40D are diagrams illustrating the operation procedure for changing the crimper 32 and the liquid applier 31 to the “parallel binding posture” and the “parallel application posture” (also the postures at the standby position HP). As illustrated in FIG. 40A, first, the crimper 32 and the liquid applier 31 are in the inclined binding position and the inclined application posture.

Then, as illustrated in FIG. 40B, the base 48 holding the crimper 32 and the liquid applier 31 is moved to the left side (the direction indicated by the arrow in FIG. 40B). Even if the posture changing lever 111 contacts the posture changing member 114, the posture changing member 114 is restricted not to rotate in the clockwise direction. Due to such a configuration, even if the base 48 is moved to the left side direction, the posture changing lever 111 is not allowed to move in the left side and starts to rotate in the clockwise direction in FIG. 40B.

Then, as illustrated in FIG. 40C, the base 48 is further moved to the left side. The posture changing lever 111 is moved, while rotating, toward the upper side of the guide rail 115. When the posture changing lever 111 is moved to the upper side of the guide rail 115, the base 48 is moved to the right side at a timing at which the posture changing lever 111 does not climb over the posture changing member 114, to complete the rotation of the liquid applier 31 to the parallel application posture.

In other words, when the posture changing lever 111 passes the posture changing member 114 from the other end (the right side) to the one end (the left side) in the main scanning direction, the liquid applier 31 is rotated from the inclined application posture to the parallel application posture. Further, when the liquid applier 31 is rotated from the inclined application posture to the parallel application posture, the liquid applier 31 is rotated to the parallel application posture in advance, and then the crimper 32 is rotated to the parallel binding posture.

With the configuration of described above, the rotation to the parallel binding posture (parallel application posture) and the inclined binding posture (inclined application posture) can be achieved with the posture changing lever 111 and the posture changing member 114. Further, shifting the rotation timings of the liquid applier 31 and the crimper 32 from each other can achieve simpler control than in a case where the liquid applier 31 and the crimper 32 are rotated together. Furthermore, when the crimper 32 and the liquid applier 31 are rotated to the inclined binding posture and the inclined application posture, the liquid applier 31 is rotated after the crimper 32. When the crimper 32 and the liquid applier 31 are rotated to the parallel binding posture and the parallel application posture, the crimper 32 is rotated after the liquid applier 31. Thus, interference between the liquid applier 31 and the crimper 32 can be avoided.

Then, as illustrated in FIG. 40D, the crimper 32 is rotated clockwise in FIG. 40D by driving the crimper pivot motor 56, and the movement of the crimper 32 to the parallel binding posture is completed.

The liquid applier shaft 53 has a configuration of rotating together with the posture changing lever 111 in the above-described embodiment. However, the liquid applier shaft 53 may have a configuration of rotating in conjunction with the posture changing lever 111 at a place separated from the posture changing lever 111 via a gear train or a timing belt.

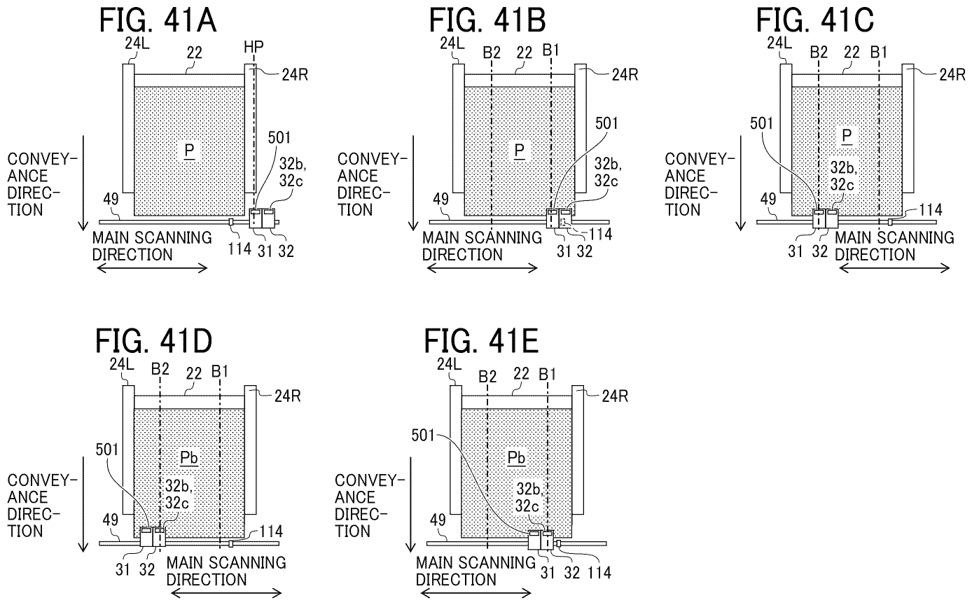

FIGS. 41A, 41B, 41C, 41D, and 41E illustrate a case of performing parallel binding on a plurality of positions of a sheet bundle Pb in the width direction of the sheet bundle Pb in a “parallel binding posture” (first binding posture) in which a longitudinal direction (i.e., the long side) of a front edge of each of the upper crimp teeth 32a, the lower crimp teeth 32b, and the liquid application member 501 is aligned with the main scanning direction.

First, before a sheet P is conveyed to the internal tray 22, the edge binder 25 is moved from the standby position HP illustrated in FIG. 41A to the first liquid application position B1 illustrated in FIG. 41B such that the liquid applier 31 is located at the first liquid application position B1.

Then, when the alignment of the sheet P supported by the internal tray 22 in the main scanning direction and the conveyance direction ends, the liquid applier 31 located at the first liquid application position B1 executes the liquid application to the sheet P. When the liquid application at the first liquid application position B1 ends, the liquid applier 31 moves to the second liquid application position B2 as illustrated in FIG. 41C. When the movement ends, the liquid applier 31 executes the liquid application on the sheet P at the second liquid application position B2.

The above-described liquid application process illustrated in FIGS. 41B and 41C is repeatedly executed until the number of sheets P placed on the internal tray 22 reaches a predetermined number (the number of sheets constituting the sheet bundle Pb).

When the number of sheets P placed on the internal tray 22 reaches the predetermined number, as illustrated in FIG. 41D, the edge binder 25 is moved in the main scanning direction such that the crimper 32 is located at the second binding position B2. When the movement ends, the crimper 32 executes crimp binding on the sheet bundle Pb at the second binding position B2. When the crimp binding at the second binding position B2 ends, as illustrated in FIG. 41E, the edge binder 25 is moved in the main scanning direction such that the crimper 32 is positioned at the first binding position B1. When the movement ends, the crimper 32 performs crimp binding on the sheet bundle Pb at the first binding position B1.

When the crimp binding process at the first binding position B1 ends, the edge binder 25 is moved to the standby position HP in FIG. 41A and the binding process ends.

Although the example with one liquid applier 31 and one crimper 32 has been described in the above-described embodiment, the number of the liquid applier 31 and the crimper 32 are not limited to the above-described example. In another example, two liquid appliers 31L and 31R and two crimpers 32 L and 32R may be provided.

A description is given below of a post-processing apparatus 3 according to a second embodiment of the present disclosure.

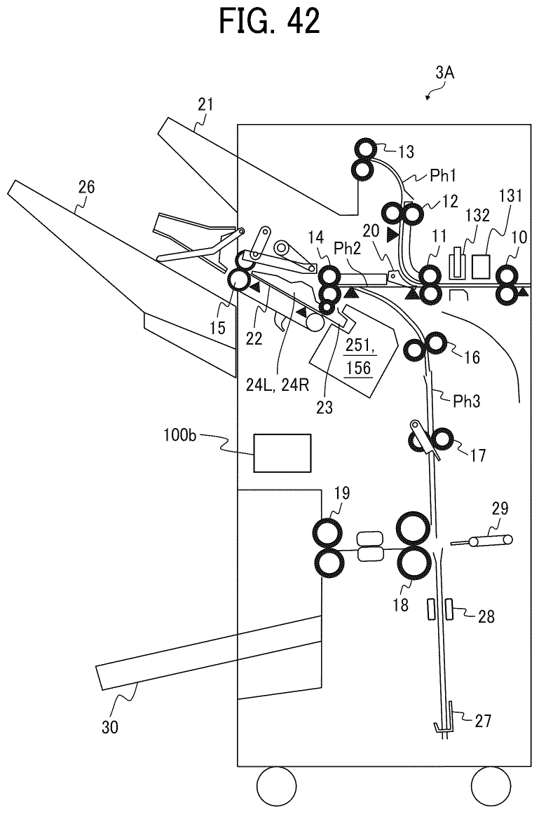

A post-processing apparatus 3A according to a second embodiment is described with reference to FIGS. 42 to 50. In the following description, components like those of the post-processing apparatus 3 according to the first embodiment are denoted by like reference numerals, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that only a crimper 32′ is included in the edge binder 251 and a liquid applier 131 is disposed upstream from the edge binder 251 in a direction in which a sheet P is conveyed. Such a configuration allows a given number of sheets P to be stacked after the liquid application process and conveyed to the crimper 32′ of the edge binder 251 disposed at a downstream position of the conveyance passage in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P.” The liquid application position to which liquid is applied on a sheet P or a sheet bundle Pb by the liquid applier 131 corresponds to the binding position on the sheet bundle Pb to be crimped by the crimper 32′. For this reason, in the following description, the liquid application position and the binding position are denoted by the same reference sign (B1).

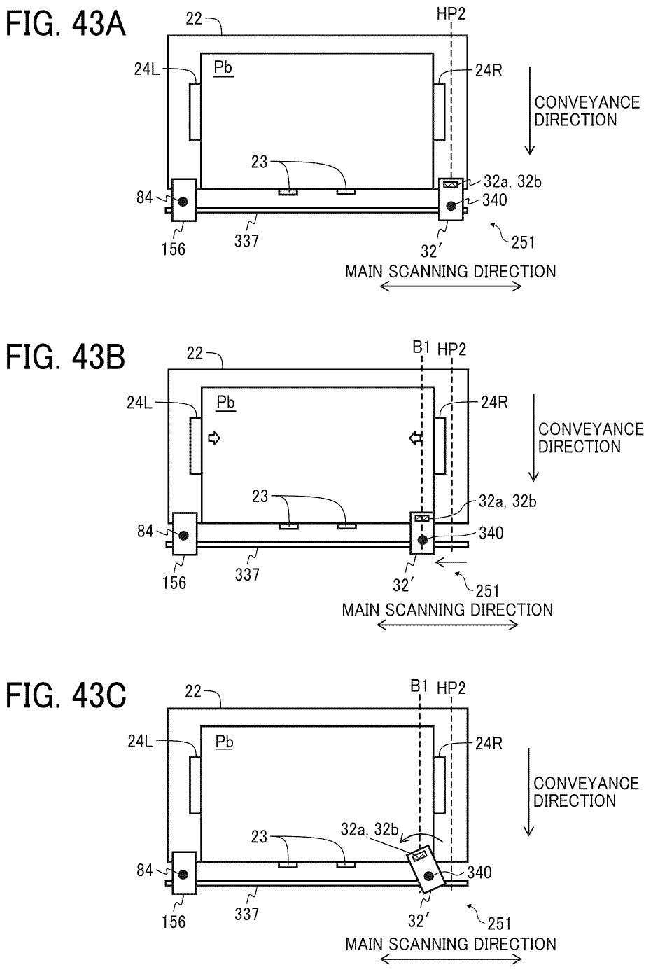

FIG. 42 is a diagram illustrating an internal configuration of the post-processing apparatus 3A according to the second embodiment of the present disclosure. As illustrated in FIGS. 43A, 43B, and 43C, the edge binder 251 includes only the crimper 32′. As illustrated in FIGS. 43A, 43B, and 43C, the crimper 32′ and a staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22 to staple the sheet bundle Pb.

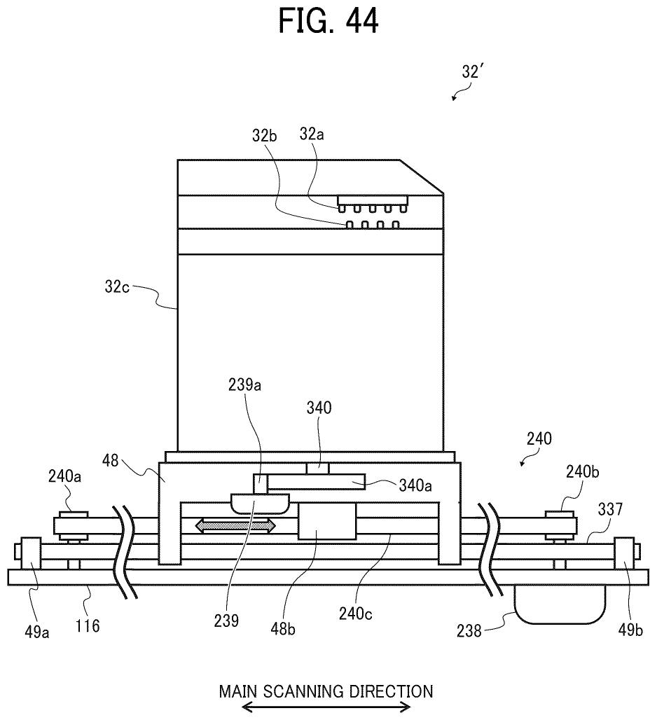

FIGS. 43A, 43B, and 43C are schematic views of the internal tray 22 as viewed from the thickness direction of the sheet bundle Pb. FIG. 44 is a schematic view of the crimper 32′ as viewed from the conveyance direction. As illustrated in FIGS. 43A, 43B, and 43C, the crimper 32′ and a staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about a crimper shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in thickness direction of the sheet bundle Pb. The other components of the staple binder 156 are similar to, even if not the same as, those of the staple binder 155 (see FIG. 6) of the post-processing apparatus 3 according to the first embodiment. For this reason, a detailed description thereof is omitted.

As illustrated in FIG. 44, the crimper 32′ includes a guide rail 337 extending in the main scanning direction at a position downstream from the internal tray 22 in the conveyance direction. The crimper 32′ includes a crimper movement motor 238 as a driving source. The base 48 supporting the crimping frame 32c has a fastening portion 48b for fastening the timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. A crimper shaft 340 including a drive transmission gear 340a is fixed to a bottom face of the crimping frame 32c that holds the components of the crimper 32.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of a driving assembly of the crimper 32′ according to the present embodiment.

The crimper 32′ is movable between a standby position HP2 illustrated in FIG. 43A and a position where the crimper 32′ faces the first binding position B1 illustrated in FIGS. 43B and 43C. The standby position HP2 is away in the main scanning direction from the sheet bundle Pb placed on the internal tray 22. For example, in FIGS. 43A, 43B, and 43C, the standby position HP is distanced to the right of the sheet bundle Pb along the main scanning direction. The first binding position B1 is a position on the sheet bundle Pb placed on the internal tray 22. However, the specific position of the first binding position B1 is not limited to the position illustrated in FIGS. 43B and 43C. The first binding position B1 may be one or more positions along the main scanning direction at the downstream end, in the conveyance direction, of the sheet P.

The posture of the crimper 32′ changes or is pivoted between a parallel binding posture illustrated in FIG. 43B and an oblique binding posture illustrated in FIG. 43C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b (in other words, a rectangular crimp binding trace) is along the main scanning direction. The oblique binding posture is a posture of the crimper 32′ in which the longitudinal direction of the upper crimping teeth 32a and the lower crimping teeth 32b (i.e., the rectangular crimp binding trace) is inclined with respect to the main scanning direction.

The pivot angle, which is an angle of the upper crimping teeth 32a and the lower crimping teeth 32b with respect to the main scanning direction, in the oblique binding posture is not limited to the angle illustrated in FIG. 43C. The pivot angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132 serving as a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19.

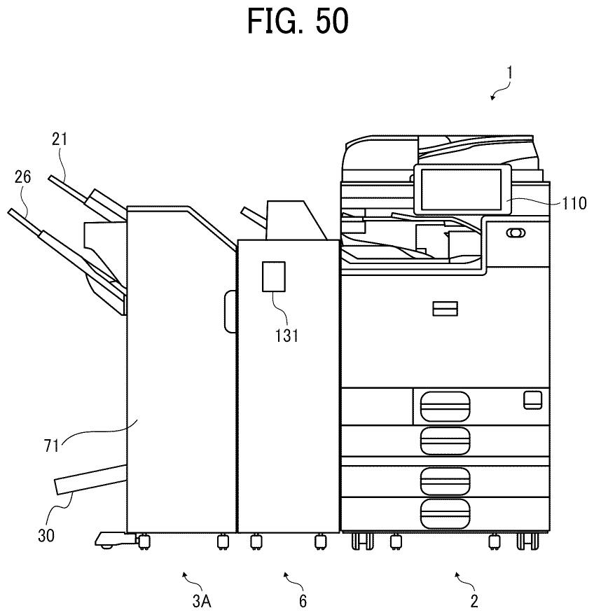

The liquid applier 131 and the hole punch 132 according to the present embodiment are disposed between the conveyance roller pairs 10 and 11. However, the arrangement of the liquid applier 131 is not limited to the example of FIG. 42. For example, in a case where an inserter 6 is disposed between the image forming apparatus 2 and the post-processing apparatus 3A as illustrated in FIG. 50, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

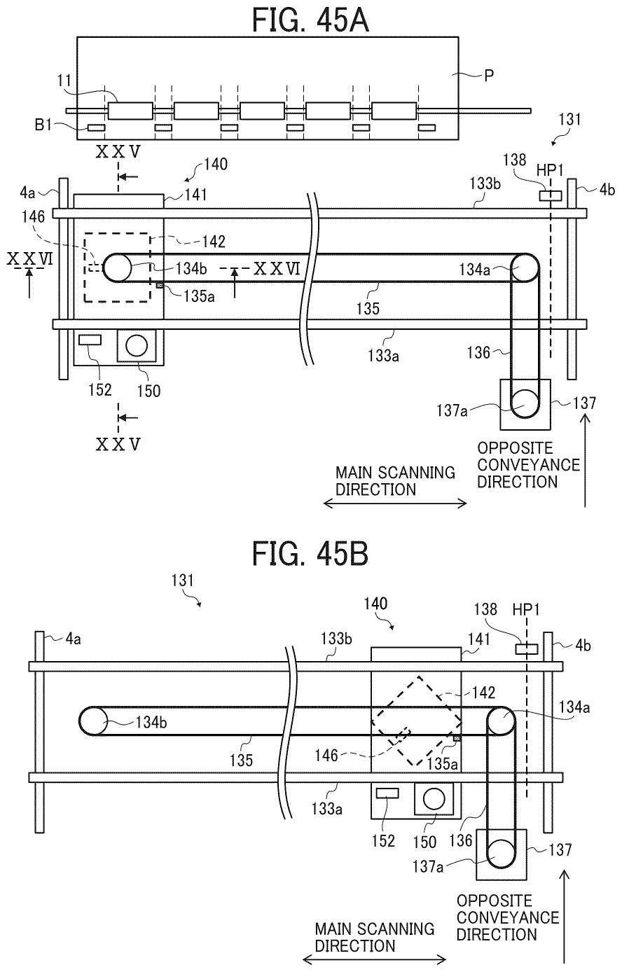

As illustrated in FIG. 45A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, the multiple roller pairs of the conveyance roller pair 11 that is located so as not to overlap the first liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

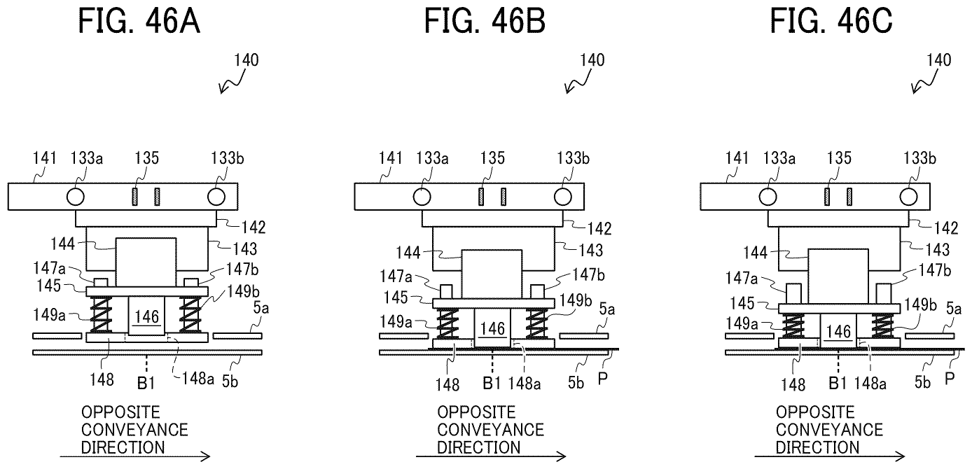

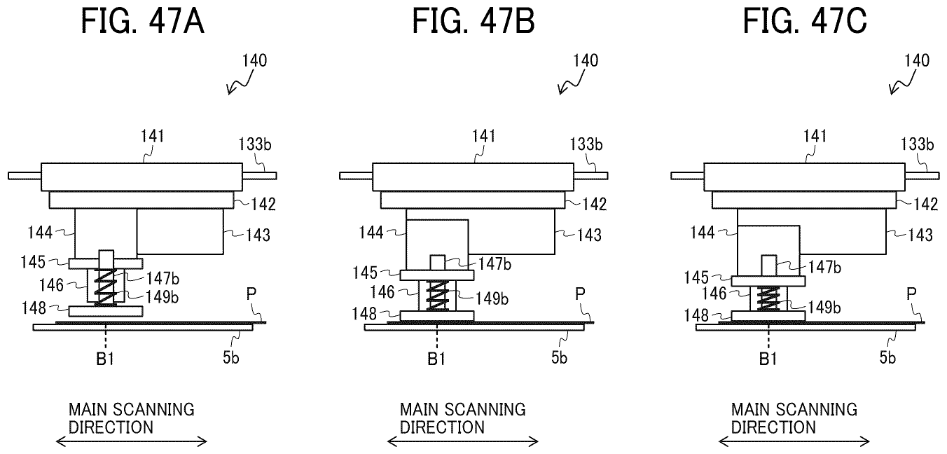

FIGS. 45A and 45B are views of the liquid applier 131 in the thickness direction of the sheet P, according to the second embodiment of the present disclosure. FIGS. 46A, 46B, and 46C are cross-sectional views of the liquid applier 131 taken along line XXV-XXV of FIG. 45A. FIGS. 47A, 47B, and 47C are cross-sectional views of the liquid applier 131 taken along line XXVI-XXVI of FIG. 45A. As illustrated in FIGS. 45A to 47C, the liquid applier 131 includes a pair of guide shafts 133a and 133b, a pair of pulleys 134a and 134b, endless annular belts 135 and 136, a liquid applier movement motor 137, a standby position sensor 138, and a liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is looped around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid applier movement motor 137.

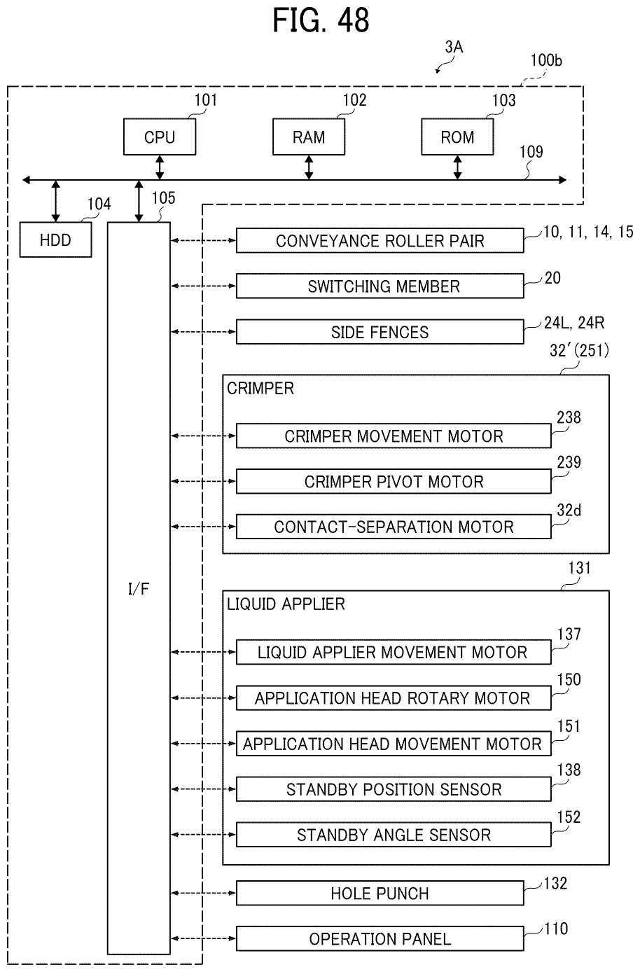

The standby position sensor 138 detects that the liquid application unit 140 has reached a standby position HP1 (see FIGS. 45A and 45B) in the main scanning direction. The standby position sensor 138 then outputs a standby position signal indicating the detection result to the controller 100b, which will be described below with reference to FIG. 48. The standby position sensor 138 is, for example, an optical sensor including a light emitter and a light receiver. The liquid application unit 140 at the standby position blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 46A, 46B, and 46C, the conveyance passage inside the post-processing apparatus 3A is defined by an upper guide plate 5a and a lower guide plate 5b, which are spaced apart from each other in the thickness direction of the sheet P. The liquid application unit 140 is located at a position to face an opening of the upper guide plate 5a. In other words, the liquid application unit 140 is disposed to face the conveyance passage (a position (at which the liquid application unit 140 is to face the sheet P conveyed along the conveyance passage) through the opening of the upper guide plate 5a.

As illustrated in FIGS. 45A to 47C, the liquid application unit 140 includes a base 141, a rotary bracket 142, a liquid storage tank 143, an application head mover 144, a holder 145, the liquid application head 146, columns 147 a and 147 b, a pressure plate 148, coil springs 149 a and 149b, the application head pivot motor 150, the application head movement motor 151 (see FIG. 48), and a standby angle sensor 152 (see FIG. 48).

The base 141 is supported by the pair of guide shafts 133a and 133b so as to be slidable in the main scanning direction. The base 141 is coupled to the endless annular belt 135 by the connection 135a. The base 141 supports the components of the liquid application unit 140 such as the rotary bracket 142, the liquid storage tank 143, the application head mover 144, the holder 145, the liquid application head 146, the columns 147a and 147b, the pressure plate 148, the coil springs 149a and 149b, the application head pivot motor 150, the application head movement motor 151, and the standby angle sensor 152.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application head pivot motor 150. The rotary bracket 142 retains the liquid storage tank 143, the application head mover 144, the holder 145, the liquid application head 146, the columns 147a and 147b, the pressure plate 148, and the coil springs 149a and 149b.

The standby angle sensor 152, which is also illustrated in FIG. 48, detects that the rotary bracket 142 has reached a standby angle. The standby angle sensor 152 then outputs a standby angle signal indicating the detection result to the controller 100b. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 45A illustrates the rotary bracket 142 in a position for the parallel binding that is performed by the crimper 32′ disposed downstream from the liquid applier 131 in a direction in which the sheet P is conveyed. FIG. 45B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The application head mover 144 is attached by the liquid storage tank 143 so as to be movable (e.g., up and down) in the thickness direction of the sheet P. The application head mover 144 is moved with respect to the liquid storage tank 143 by a driving force transmitted from the application head movement motor 151. The holder 145 is attached to a lower end of the application head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIGS. 46A and 47A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application head movement motor 151 is rotated in a first direction. As a result, the application head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 corresponds to the first binding position B1 to be crimped and bound by the edge binder 251, specifically, the crimper 32′.

As the application head movement motor 151 keeps rotating in the first direction after the pressure plate 148 contacts the sheet P, the coil springs 149a and 149b are compressed to further move down the application head mover 144, the holder 145, the liquid application head 146, and the columns 147a and 147b. As a result, as illustrated in FIGS. 46B and 47B, a lower face of the liquid application head 146 contacts the sheet P through the through hole 148a. Then, the liquid contained in the liquid application head 146 is applied to the sheet P.

Further rotation of the application head movement motor 151 in the first direction further strongly presses the liquid application head 146 against the sheet P as illustrated in FIGS. 46C and 47C. Accordingly, the amount of liquid that is applied to the sheet P increases. In short, the liquid applier 131 changes the pressing force of the liquid application head 146 against the sheet P to adjust the amount of liquid that is applied to the sheet P.

On the other hand, the rotation of the application head movement motor 151 in the second direction opposite to the first direction moves up the application head mover 144, the holder 145, the liquid application head 146, the columns 147a and 147b, the pressure plate 148, and the coil springs 149a and 149b together. As a result, as illustrated in FIGS. 46A and 47A, the liquid application head 146 and the pressure plate 148 are separated from the sheet P. In other words, the liquid applier 131 includes the liquid application head 146 that can be separated from the sheet P.

FIG. 48 is a block diagram illustrating a hardware configuration of the post-processing apparatus 3A to control the operation of the post-processing apparatus 3A according to the second embodiment of the present disclosure. As illustrated in FIG. 48, the post-processing apparatus 3A includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of the controller 100b serving as a control device that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid applier movement motor 137, an application head pivot motor 150, an application head movement motor 151, a standby position sensor 138, a standby angle sensor 152, a hole punch 132, and an operation panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 48 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 50, the image forming apparatus 2 includes the operation panel 110. The operation panel 110 includes an operation device that receives instructions input by an operator and a display serving as a notifier that notifies the operator of information. The operation device includes, for example, physical input buttons and a touch screen overlaid on a display. The operation panel 110 acquires information from the user through the operation device and provides information to the user through the display. The post-processing apparatus 3A may include an operation panel 110 similar to the above-described operation panel 110 of the image forming apparatus 2.

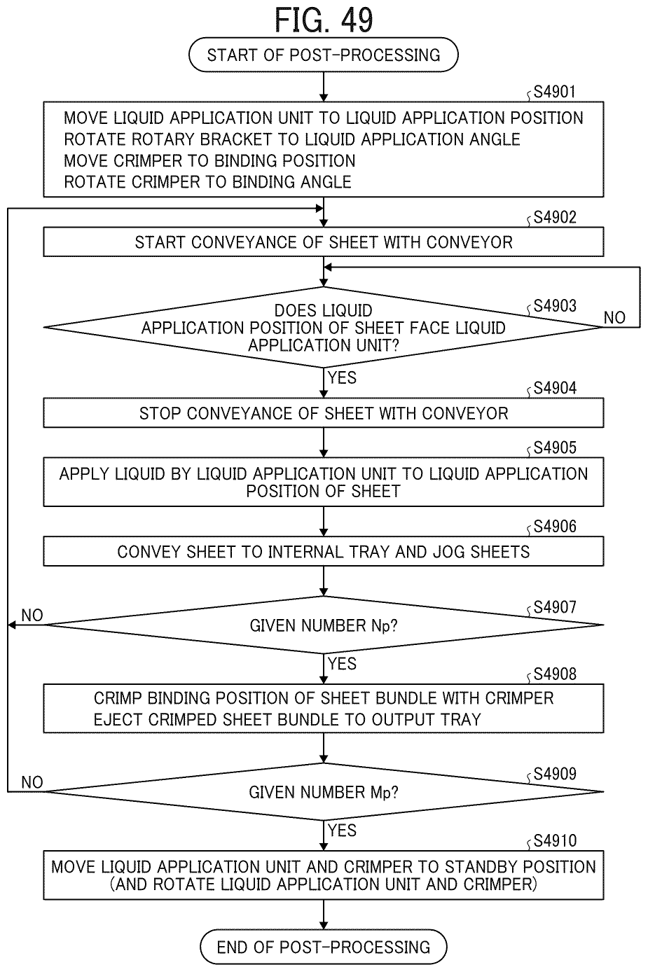

FIG. 49 is a flowchart of post-processing performed by the post-processing apparatus 3A according to the second embodiment. Specifically, FIG. 49 is a flowchart of a process to execute the one-point binding illustrated in FIGS. 43A, 43B, and 43C.

For example, the controller 100b executes the post-processing illustrated in FIG. 49 when the controller 100B acquires an instruction to execute the post-processing from the image forming apparatus 2. In the following description, the instruction to execute the post-processing may be referred to as a “post-processing command.” The post-processing command includes, for example, the number of sheets P of the sheet bundle Pb (referred to as “given number of sheets Np”), the number of sheet bundles Pb to be subjected to binding process, the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (i.e., punching a hole in the present embodiment). In the following description, the number of sheets P of the sheet bundle Pb may be referred to as a “given number of sheets Np,” and the number of sheet bundles Pb to be subjected to binding process may be referred to as “requested number of copies Mp.” At the start of the post-processing, the liquid application unit 140 is at the standby position HP1 illustrated in FIGS. 45A and 45B, and the rotary bracket 142 is held at the standby angle (corresponding to the parallel binding posture) at the standby position HP1.

First, the controller 100b drives the liquid applier movement motor 137 to move the liquid application unit 140 (corresponding to a liquid applier) in the main scanning direction such that a liquid application head 146 moves from the standby position HP1 to a position where the liquid application head 146 can face the first liquid application position B1 (see FIG. 45B) corresponding to the first binding position B1 illustrated in FIG. 43. If the type of the binding process instructed by the post-processing command is “oblique binding process,” in step S4901, the controller 100b drives the application head pivot motor 150 to rotate the rotary bracket 142. Thus, the liquid application head 146 is rotated from the standby angle to the liquid application angle corresponding to the “oblique binding posture.” It is ascertained, based on a pulse signal output from a rotary encoder of the liquid applier movement motor 137, that the liquid application head 146 has reached the position where the liquid application head 146 can face the first liquid application position B1. Similarly, it is ascertained, based on a pulse signal output from a rotary encoder of the application head pivot motor 150, that the liquid application head 146 has reached the liquid application angle. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, the controller 100b drives the crimper movement motor 238 to move the crimper 32′ from the standby position HP2 to the position where the crimper 32′ can face the first binding position B1 as illustrated in FIGS. 43A and 43B (step S4901). Alternatively, if the type of the binding process instructed by the post-processing command is “oblique binding process,” in step S4901, the controller 100b drives the crimper pivot motor 239 to rotate the crimper 32′ from the standby angle to the crimping angle corresponding to the “oblique binding posture.” It is ascertained, based on a pulse signal output from a rotary encoder of the crimper movement motor 238, that the crimper 32′ has reached the position where the crimper 32′ can face the first binding position B1. Similarly, it is ascertained, based on a pulse signal output from a rotary encoder of the crimper pivot motor 239, that the crimper 32′ has reached the crimping angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

Subsequently, in step S4902, the controller 100b drives the conveyance roller pairs 10 and 11 to start conveying the sheet P on which an image is formed by the image forming apparatus 2. The controller 100b determines whether the first liquid application position B1 on the sheet P faces first the liquid application unit 140 (more specifically, the liquid application head 146) (step S4903). In other words, the controller 100b determines whether the liquid application unit 140 has faced the first liquid application position B1 on the sheet P. When the first liquid application position B1 on the sheet P has not faced the liquid application unit 140 (NO in step S4903), the controller 100b repeats the processing in step S4903. In other words, the controller 100b continues driving the conveyance roller pairs 10 and 11 until the first liquid application position B1 on the sheet P faces the liquid application head 146 (YES in step S4903). When the controller 100b determines that the first liquid application position B1 on the sheet P has faced the liquid application head 146 (YES in step S4903), the controller 100b causes the conveyance roller pairs 10 and 11 (step S4904) to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

The controller 100b causes the liquid application unit 140 to execute the process of applying liquid to the first liquid application position B1 on the sheet P (step S4905). More specifically, the controller 100b rotates the application head movement motor 151 in the first direction to bring the liquid application head 146 into contact with the first liquid application position B1 on the sheet P. The controller 100b changes the pressing force of the liquid application head 146 (i.e., the amount of rotation or rotation speed of the application head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application head movement motor 151 may be ascertained based on a pulse signal output from a rotary encoder of the application head movement motor 151.

In step S4906, the controller 100b drives the conveyance roller pairs 10, 11, 14, and 15 to place a sheet P on the internal tray 22. The controller 100b moves the side fences 24L and 24R to align the position of the sheet P or the sheet bundle Pb placed on the internal tray 22 in the main scanning direction (step S4906). In short, the controller 100b performs so-called jogging.

The controller 100b determines whether the number of sheets P placed on the internal tray 22 has reached the given number of sheets Np indicated by the post-processing command (step S4907). When the controller 100b determines that the number of sheets P placed on the internal tray 22 has not reached the given number of sheets Np (NO in step S4907), the controller 100b executes the operations of steps S4902 to S4907 again until the number of sheets P placed on the internal tray 22 reaches the given number of sheets Np (YES in step S4907).

By contrast, when the controller 100b determines that the number of sheets P that are placed on the internal tray 22 has reached the given number of sheets Np (YES in step 4907), the controller 100b causes the crimper 32′ to crimp the binding position B1 (corresponding to the first liquid application position B1) on the sheet bundle Pb to which the liquid has been applied by the liquid application unit 140 (step S4908). In addition, in step S4908, the controller 100b rotates the conveyance roller pair 15 to eject the crimped sheet bundle Pb to the ejection tray 26.

The controller 100b determines whether the number of sheet bundles Pb thus ejected to the ejection tray 26 has reached the requested number of copies Mp indicated by the post-processing command (step S4909). When the controller 100b determines that the number of the sheet bundles Pb ejected to the ejection tray 26 has not reached the requested number of copies Mp (NO in step S4909), the controller 100b repeats the processing of steps S4902 to S4909 until the number of the sheet bundles Pb ejected to the ejection tray 26 reaches the requested number of copies Mp (YES in step S4909).

When the controller 100b determines that the number of sheet bundles Pb ejected to the ejection tray 26 reaches the requested number of copies Mp (YES in step S4909), the controller 100b drives the liquid applier movement motor 137 to move the liquid application unit 140 to the standby position HP1 (see FIG. 45B) and drives the crimper movement motor 238 to move the crimper 32′ to the standby position HP2 (see FIG. 43A) (step S4910). When the posture that is instructed by the post-processing operation is the “oblique binding posture,” the controller 100drives the application head pivot motor 150 and the crimper pivot motor 239 to rotate the liquid application unit 140 and crimper 32′ and the parallel binding posture (standby angle) into the parallel binding posture (step S4910). By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S4901 and S4910, the execution order of the movement in the main scanning direction and the rotation in the forward and reverse directions of the liquid application unit 140 and the crimper 32′ is not limited to the aforementioned order and may be reversed.

The embodiments of the present disclosure are applied to the edge binder 25 that executes the edge stitching as described above. However, the embodiments of the present disclosure may be applied to the saddle binder 28 that executes the saddle stitching.

The controller 100b of the post-processing apparatus 3A according to the second embodiment illustrated in FIG. 42 is provided separately from the controller 100a of the image forming apparatus 2 as in the configuration of FIG. 1. However, embodiments of the present disclosure are not limited to the above-described configuration. For example, as illustrated in FIG. 51A, the controller 100b of the post-processing apparatus 3A may be disposed in the image forming apparatus 2. Further, as in the configuration of FIG. 51B, the controller 100b of the post-processing apparatus 3A may be integrated with the controller 100a of the image forming apparatus 2.

As in the configuration of FIG. 52A, the controller 100b of the post-processing apparatus 3A may be divided into a controller 100b1 (e.g., a driver system such as a motor) and a controller 100b2 (a detector such as a sensor) according to the function, and the controller 100b2 of the post-processing apparatus 3A may be disposed in the image forming apparatus 2. Further, as in the configuration of FIG. 52B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

Embodiments of the present disclosure are not limited to the above-described embodiments, and numerous additional modifications and variations are possible in light of the teachings within the technical scope of the appended claims. It is therefore to be understood that the above-described embodiments of the present disclosure may be practiced otherwise by those skilled in the art than as specifically described herein. Such modifications and variations are included in the technical scope described in the appended claims.

Aspects of the present disclosure are, for example, as follows.

### First Aspect

A medium processing apparatus includes: a liquid applier to apply liquid to a part of at least one medium; a post-processing device to perform processing on a bundle of media including the at least one medium to which the liquid is applied by the liquid applier; a first liquid storage to store the liquid to be applied by the liquid applier; a second liquid storage to store the liquid to be supplied to the first liquid storage; a liquid supplier to perform a liquid supply operation to supply the liquid from the second liquid storage to the first liquid storage; a control pattern holder to hold a liquid supply control pattern including a combination of different types of liquid supply operations; and a controller to control execution of the liquid supply operation based on the liquid supply control pattern and an operation status of the post-processing device.

### Second Aspect

In the medium processing apparatus according to the first aspect, the liquid supply control pattern includes at least two of a constant liquid-application-preparation completion pattern, a wait-time saving pattern, and a liquid-saving pattern.

### Third Aspect

In the medium processing apparatus according to the first or second aspect, the different types of liquid supply operations include at least two of a filling supply operation, an additional supply operation, and a predetermined-amount supply operation.

### Fourth Aspect

In the medium processing apparatus according to any one of the first to third aspects, the controller causes the liquid supplier to perform a filling supply operation that is one of the different types of liquid supply operations at a start of operation of the post-processing device.

### Fifth Aspect

In the medium processing apparatus according to any one of the first to fourth aspects, the post-processing device is a crimper to press and deform the bundle of media to bind the bundle of media.

### Sixth Aspect

The medium processing apparatus according to any one of the first to fifth aspects further includes a liquid detector to detect the liquid stored in the first liquid storage. The controller changes a detection timing of the liquid detector in accordance with the liquid supply control pattern.

### Seventh Aspect

In the medium processing apparatus according to any one of the first to sixth aspects, the controller switches between execution and non-execution of the liquid supply operation in activation of the medium processing apparatus, in accordance with the liquid supply control pattern.

### Eighth Aspect

In the medium processing apparatus according to any one of the first to seventh aspects, the controller switches between execution and non-execution of the liquid supply operation at a start of the processing with application of the liquid, in accordance with the liquid supply control pattern.

### Ninth Aspect

In the medium processing apparatus according to any one of the first to eighth aspects, the controller switches between the different types of liquid supply operations during execution of the processing with application of the liquid, in accordance with the liquid supply control pattern.

### Tenth Aspect

In the medium processing apparatus according to any one of the first to ninth aspects, the controller switches between execution and non-execution of the liquid supply operation at an end of the processing with application of the liquid, in accordance with the liquid supply control pattern.

### Eleventh Aspect

In the medium processing apparatus according to any one of the first to tenth aspects, the controller switches between execution and non-execution of a liquid discharge operation of discharging the liquid from the first liquid storage to the second liquid storage at an end of the processing with application of the liquid, in accordance with the liquid supply control pattern.

### Twelfth Aspect

In the medium processing apparatus according to any one of the first to eleventh aspects, the controller switches between execution and non-execution of the liquid supply operation in accordance with the liquid supply control pattern when application of the liquid is not executed for a certain period of time.

### Thirteenth Aspect

An image forming system includes: an image forming apparatus to form images on a plurality of media; and the medium processing apparatus according to any one of the first to twelfth aspects to perform the processing on the plurality of media on which the images have been formed by the image forming apparatus.

### Fourteenth Aspect

A medium processing apparatus includes: a liquid applier to apply liquid to a part of at least one medium; a post-processing device to perform processing on a bundle of media including the at least one medium to which the liquid is applied by the liquid applier; a first liquid storage to store the liquid to be applied by the liquid applier; a second liquid storage to store the liquid to be supplied to the first liquid storage; a liquid supplier to perform a liquid supply operation to supply the liquid from the second liquid storage to the first liquid storage; a control pattern selector to select a liquid supply control pattern including a combination of different types of liquid supply operations; and a controller to control execution of the liquid supply operation based on the liquid supply control pattern selected by the control pattern selector and an operation status of the post-processing device.

### Fifteenth Aspect

In the medium processing apparatus according to the fourteenth aspect, the control pattern selector is an operation device. The controller causes the liquid supplier to execute a filling supply operation that is one of the different types of liquid supply operations, based on input information from the operation device.

### Sixteenth Aspect

The medium processing apparatus according to the fourteenth or fifteenth aspect includes an information storage device to store information on the processing with application of the liquid. The control pattern selector selects the liquid supply control pattern in accordance with the information on the processing with application of the liquid.

### Seventeenth Aspect

An image forming system includes an image forming apparatus, a medium processing apparatus, a control pattern holder, and a controller. The image forming apparatus forms an image on a medium. The medium processing apparatus includes: a liquid applier to apply liquid to a part of at least one medium on which an image is formed by the image forming apparatus; a post-processing device to perform processing on a bundle of media including the at least one medium to which the liquid is applied by the liquid applier; a first liquid storage to store the liquid to be applied by the liquid applier; a second liquid storage to store the liquid to be supplied to the first liquid storage; and a liquid supplier to perform a liquid supply operation to supply the liquid from the second liquid storage to the first liquid storage. The control pattern holder holds a liquid supply control pattern including a combination of different types of liquid supply operations. The controller controls execution of the liquid supply operation based on the liquid supply control pattern and an operation status of the post-processing device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and circuit components arranged to perform the recited functions.

This patent application is based on and claims priority to Japanese Patent Application Nos. 2023-046080, filed on Mar. 22, 2023, and 2024-019709, filed on Feb. 13, 2024, in the Japan Patent Office, the entire disclosure of each of which is hereby incorporated by reference herein.

### REFERENCE SIGNS LIST

1: Image forming system
2: Image forming apparatus
25: Edge binder
31: Liquid applier
32: Crimper
42: Liquid applier movement motor
43a: First liquid level sensor
44: First liquid storage tank
45: Liquid supply passage
46: Liquid supply pump
47: Second liquid storage tank
50: Liquid supply member
51: Setting detection sensor
71: Cover
72: Housing side plate
100a, 100b: Controller
110: Operation panel
471: Liquid supply valve
501: Liquid application member
611: Liquid drain plug

1. A medium processing apparatus, comprising:
a liquid applier configured to apply liquid to a part of at least one medium;
a post-processing device configured to perform processing on a bundle of media including the at least one medium to which the liquid is applied;
a first liquid storage configured to store the liquid to be applied;
a second liquid storage configured to store the liquid prior to the liquid being supplied to the first liquid storage;
a liquid supplier configured to perform a liquid supply operation to supply the liquid from the second liquid storage to the first liquid storage;
a control pattern holder configured to hold a liquid supply control pattern, the liquid supply control pattern including a combination of different types of liquid supply operations; and
a controller configured to control execution of the liquid supply operation based on the liquid supply control pattern and an operation status of the post-processing device.

2. The medium processing apparatus according to claim 1, wherein the liquid supply control pattern includes at least two of:
a constant liquid-application-preparation completion pattern, a wait-time saving pattern, a liquid-saving pattern, or any combinations thereof.

3. The medium processing apparatus according to claim 1, wherein the different types of liquid supply operations include at least two of:
a filling supply operation, an additional supply operation, a desired amount supply operation, or any combinations thereof.

4. The medium processing apparatus according to claim 1, wherein the controller is further configured to:
cause the liquid supplier to perform a filling supply operation at a start of operation of the post-processing device, the filling supply operation being one of the different types of liquid supply operations.

5. The medium processing apparatus according to claim 1, wherein the post-processing device is a crimper configured to press and deform the bundle of media to bind the bundle of media.

6. The medium processing apparatus according to claim 1, further comprising:
a liquid detector configured to detect the liquid stored in the first liquid storage,
wherein the controller is further configured to change a detection timing of the liquid detector based on the liquid supply control pattern.

7. The medium processing apparatus according to claim 1, wherein the controller is further configured to:
switch between execution and non-execution of the liquid supply operation in response to activation of the medium processing apparatus, based on the liquid supply control pattern.

8. The medium processing apparatus according to claim 1, wherein the controller is further configured to:
switch between execution and non-execution of the liquid supply operation at a start of the processing with application of the liquid, based on the liquid supply control pattern.

9. The medium processing apparatus according to claim 1, wherein the controller is further configured to:
switch between the different types of liquid supply operations during execution of the processing with application of the liquid, based on the liquid supply control pattern.

10. The medium processing apparatus according to claim 1, wherein the controller is further configured to:
switch between execution and non-execution of the liquid supply operation at an end of the processing with application of the liquid, based on the liquid supply control pattern.

11. The medium processing apparatus according to claim 1, wherein the controller is further configured to: switch between execution and non-execution of a liquid discharge operation of discharging the liquid from the first liquid storage to the second liquid storage at an end of the processing with application of the liquid, based on the liquid supply control pattern.

12. The medium processing apparatus according to claim 1, wherein the controller is further configured to:
switch between execution and non-execution of the liquid supply operations based on the liquid supply control pattern in response to application of the liquid not being executed for a desired period of time.

13. An image forming system, comprising:
an image forming apparatus configured to form images on a plurality of media; and
the medium processing apparatus according to claim 1, the medium processing apparatus configured to perform the processing on the plurality of media on which the images have been formed by the image forming apparatus.

14. A medium processing apparatus, comprising:
a liquid applier configured to apply liquid to a part of at least one medium;
a post-processing device configured to perform processing on a bundle of media including the at least one medium to which the liquid is applied;
a first liquid storage configured to store the liquid to be applied;
a second liquid storage configured to store the liquid prior to the liquid being supplied to the first liquid storage;
a liquid supplier configured to perform a liquid supply operation to supply the liquid from the second liquid storage to the first liquid storage;
a control pattern selector configured to select a liquid supply control pattern, the liquid supply control pattern including a combination of different types of liquid supply operations; and
a controller configured to control execution of the liquid supply operation based on the selected liquid supply control patterns and an operation status of the post-processing device.

15. The medium processing apparatus according to claim 14,
wherein the control pattern selector is an operation device, and
the controller is further configured to cause the liquid supplier to execute a filling supply operation that is one of the different types of liquid supply operations, based on input information from the operation device.

16. The medium processing apparatus according to claim 14, further comprising:
an information storage device configured to store information on the processing with application of the liquid,
wherein the control pattern selector is further configured to selects the liquid supply control pattern based on the information on the processing with application of the liquid.

17. An image forming system, comprising:
an image forming apparatus configured to form an image on a medium;
a medium processing apparatus including:
a liquid applier configured to apply liquid to a part of at least one medium on which an image is formed by the image forming apparatus;
a post-processing device configured to perform processing on a bundle of media including the at least one medium to which the liquid is applied by the liquid applier;
a first liquid storage configured to store the liquid to be applied by the liquid applier;
a second liquid storage configured to store the liquid prior to the liquid being supplied to the first liquid storage;
a liquid supplier configured to perform a liquid supply operation to supply the liquid from the second liquid storage to the first liquid storage;
a control pattern holder configured to hold a liquid supply control pattern, the liquid supply control pattern including a combination of different types of liquid supply operations; and
a controller configured to control execution of the liquid supply operation based on the liquid supply control pattern and an operation status of the post-processing device.
